(19) United States
(12) Patent Application Publication
(10) Pub. No.: US 2025/0158057 A1
(43) Pub. Date: May 15, 2025

(54) CATHODE HAVING DOPED METAL FLUORIDE CORE-SHELL PARTICLE AND BATTERIES COMPRISING THE SAME

(71) Applicant: Sila Nanotechnologies, Inc., Alameda, CA (US)

(72) Inventors: Sung Hyun LIM, Mountain View, CA (US); Thomas Robert PORTER, Alameda, CA (US); Gennadiy BELOMOIN, San Carlos, CA (US); Marchell MITCHELL, Oakland, CA (US); Sebastian Miguel GOMEZ, Alameda, CA (US); Alessandro GALLO, Oakland, CA (US); Gleb Nikolayevich YUSHIN, Atlanta, GA (US)

(21) Appl. No.: 18/946,601

(22) Filed: Nov. 13, 2024

Related U.S. Application Data
(60) Provisional application No. 63/598,845, filed on Nov. 14, 2023.

(51) Int. Cl. H01M 4/58; H01M 4/02; H01M 4/62

(52) U.S. Cl. CPC H01M 4/582; H01M 4/625; H01M 4/628; H01M 2004/021; H01M 2004/028

(57) ABSTRACT

An embodiment is directed to a Li metal or Li-ion battery cell. In an aspect, the Li metal or Li-ion battery cell includes a cathode capable of storing and releasing Li ions during battery cell operation, a conversion-type or Li metal-type anode capable of storing and releasing the Li-ions during the battery cell operation, and an electrolyte capable of conducting the Li-ions during the battery cell operation. In an aspect, the cathode comprises composite core-shell particle(s) comprising a conversion-type metal fluoride and at least one cation dopant, the at least one cation dopant is present in a range from around 0.1 at. % to around 30 at. % of all metals in the core-shell particles, and the cathode has an areal capacity loading that ranges from around 2 mAh/cm² to around 12 mAh/cm².

### CROSS-REFERENCE TO RELATED APPLICATIONS

The present application for patent claims the benefit of U.S. Provisional Application No. 63/598,845, entitled “CATHODE HAVING DOPED METAL FLUORIDE CORE-SHELL PARTICLE AND BATTERIES COMPRISING THE SAME,” filed Nov. 14, 2023, assigned to the assignee hereof, and expressly incorporated herein by reference in its entirety.

### GOVERNMENT LICENSE RIGHTS

This invention was made with government support under Award ID DE-AR0001054 awarded by the Advanced Research Projects Agency-Energy (“ARPA-E”) within the United States Department of Energy (DOE). The government has certain rights in the invention.

### BACKGROUND

### Field

The present disclosure relates generally to energy storage devices, and more particularly to metal and metal-ion battery technology and the like.

### Background

Owing in part to their relatively high energy densities, relatively high specific energy, light weight, and potential for long lifetimes, advanced rechargeable metal batteries and rechargeable metal-ion batteries such as lithium-ion (Li-ion) batteries are desirable for a wide range of consumer electronics, electric vehicle, grid storage and other important applications. Similarly, primary metal and metal-ion batteries, such as primary Li batteries, are desired for a range of applications, where high energy density and/or high specific energy of batteries is needed, even if the batteries may be disposed of after a single use.

However, despite the increasing commercial prevalence of Li-ion batteries and some of the Li primary batteries, further development of these batteries is needed, particularly for potential applications in low- or zero-emission, hybrid-electric or fully-electric vehicles, consumer electronics, energy-efficient cargo ships and locomotives, drones, flying cars, electric aviation, aerospace applications, and power grids.

Conversion-type electrodes, such as metal fluorides, metal oxy-fluorides, metal chlorides, metal iodides, metal sulfides, sulfur, metal oxides, metal nitrides, metal phosphides, metal hydrides and others for Li-ion batteries offer high gravimetric and volumetric capacities. In these electrodes, so-called conversion reactions take place when metal ions such as Li are inserted or extracted during battery operation. For example, an iron (III) fluoride (e.g., FeF₃) may be fully or partially converted to 3LiF and Fe during an electrochemical reaction of FeF₃ with Li ions during Li-ion or Li cell discharge.

Many metal fluorides offer a combination of relatively high average voltage and high capacities but suffer from several limitations for various metal-ion (such as Li-ion) battery chemistries. For example, only select metal fluoride particles have been reported to offer some reasonable (although still poor) cycle stability in Li-ion battery cells (specifically AgF₂, FeF₂, FeF₃, CoF₂, and NiF₂). Many other metal fluorides are generally believed not to be practical for applications in Li-ion batteries due to the irreversible changes that occur in such cathodes during battery operation. For example, during Li-ion insertion into some of the other fluorides (such as CuF₂, for example) and the subsequent formation of LiF during the conversion reaction, the original fluoride-forming element (such as Cu in the case of CuF₂) produces electrically isolated (Cu) nanoparticles. Being electrically isolated, such nanoparticles cannot electrochemically react with LiF to transform back into CuF₂ during subsequent Li extraction, thereby preventing reversibility of the conversion reaction. As a result, after a discharge, the cell cannot be charged back to the initial capacity. In addition to formation of electrically isolated nanoparticles, the irreversible growth of LiF and metal (M) clusters during cycling and the resulting growth of resistance may be yet another serious limitation. This additionally limits the rate performance of such chemistries. Moreover, many attractive (in terms of high theoretical energy density) metal fluorides (such as CuF₂) suffer from another degradation mechanism: during Li (or Li-ion) battery operation, the cathode is often exposed to a potential level where a metal (of the corresponding metal fluoride, such as Cu metal) is oxidized and dissolves into the electrolyte at the potential below the potential required for charging the cell. The dissolved metal ions migrate to the anode and get irreversibly reduced. This process leads to rapid irreversible capacity losses and cell degradation, and may be particularly serious for some of the most otherwise-attractive metal fluoride cathode materials (such as CuF₂-based cathodes). Metal chlorides suffer from similar limitations. In addition, their dissolution during cycling induces formation of Cl-containing ions that may corrode cathode current collectors.

Even the cathodes based on those metal fluorides that are believed to be most practical due to their relatively reversible operation and reasonably low cost (such as FeF₂, FeF₃, NiF₂ and others), suffer from multiple limitations including: (i) relatively low electrical conductivity of fluorides, which limits their utilization and both energy and power characteristics in batteries; (ii) relatively low ionic conductivity, which limits their utilization and both energy and power characteristics in batteries; (iii) volume expansion during Li-ion insertion, which may cause mechanical and electrical degradation in the electrodes during battery operation; (iv) gradual segregation of metal and LiF clusters, which significantly reduce energy efficiency and increase cell resistance; and (v) accelerated decomposition of the electrolyte and irreversible consumption of cyclable Li, which leads to capacity fading, particularly at elevated temperatures.

As a result, despite multiple theoretical advantages of fluoride-based cathodes (and some of the chloride-based cathodes), for example, their high specific capacity and practical application in metal-ion batteries are difficult to achieve because cells produced with fluoride-based cathodes currently suffer from poor stability, volume changes, slow charging, and high impedance.

Several approaches have been developed to overcome some of the above-described difficulties, but none have been fully successful in overcoming a sufficient number of them so as to make their application practical.

For example, decreasing particle size decreases the ion diffusion distance, and offers one approach to addressing the low ionic conductivity limitation. However, nanopowders suffer from high electrical resistance caused by the multiple, highly resistive point contacts formed between the individual particles. In addition, small particle size increases the specific surface area available for undesirable electrochemical (or chemical) side reactions. Furthermore, simply decreasing the particle size does not address, and may in some cases exacerbate, other limitations of such materials, such as volume changes as well as weakening of the particle-binder interfaces. Moreover, in contrast to using micron-scale particles for cathode formulations, handling nanoparticles and using them to prepare dense electrodes is technologically difficult. Nanoparticles are difficult to disperse uniformly within conductive carbon additives and the binder of the cathode, and an undesirable formation of agglomerates of nanoparticles tends to take place. Formation of such agglomerates reduces the electrode density (thus reducing volume-normalized capacity and energy density of the cells), reduces electrode stability (since the binder and conductive additives do not connect individual particles within such agglomerates) and reduces capacity utilization (since some of the nanoparticles become electrically insulated and thus do not participate in Li-ion storage).

In another approach, select metal fluoride particles which offer some reasonable cycle stability in Li-ion battery cells (specifically FeF₂, FeF₃, CoF₂, and NiF₂) may be mechanically mixed with or deposited onto the surface of conductive substrates, such as carbon black, graphite, multi-walled carbon nanotubes, or carbon fibers. In this case, the high electrical conductivity of the carbon enhances electrical conductivity of the electrodes. However, many degradation mechanisms (including those discussed above) are not addressed by this approach. In addition, the phase transformations during battery operation and the volume changes discussed above may induce a separation of the active material from the conductive additives, leading to resistance growth and battery degradation.

In yet another approach, select metal fluoride particles (specifically, FeF₂ particles) may be coated with a solid multi-walled graphitic carbon shell layer. In this case, the electrical conductivity of a metal fluoride cathode may be improved. However, the above-described volume changes during metal-ion insertion may break the graphitic carbon coating and induce irreversible capacity losses. Similarly, the phase transformation during subsequent charging and discharging cycles may induce a separation of the active material from the graphitic carbon shell, leading to resistance growth and battery degradation. Furthermore, some of the carbon shells are incredibly difficult to deposit on selected metal fluorides (such as CuF₂) and chlorides due to the simultaneous metal fluoride reduction (for example, reduction of Cu²⁺ in CuF₂ to metallic Cu⁰) and catalytic growth of carbon nanofibers or carbon nanotubes.

Accordingly, there remains a need for improved metal and metal-ion batteries, components, and other related materials and manufacturing processes.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a Li metal or Li-ion battery cell includes a cathode capable of storing and releasing Li ions during battery cell operation; a conversion-type or Li metal-type anode capable of storing and releasing the Li-ions during the battery cell operation; and an electrolyte capable of conducting the Li-ions during the battery cell operation; wherein: the cathode comprises a composite core-shell particle comprising a conversion-type metal fluoride and at least one cation dopant; the at least one cation dopant is present in a range from around 0.1 at. % to around 30 at. % of all metals in the composite core-shell particle; and the cathode has an areal capacity loading that ranges around 2 mAh/cm² to around 12 mAh/cm².

In some aspects, a separator membrane ionically coupling and electronically insulating the cathode and the anode.

In some aspects, the composite core-shell particle is a nanocomposite that comprises: (i) LiF, (ii) metal nanoparticles comprising one, two or more metals selected from: Cu, Fe, and Bi or their alloys, (iii) at least one, two or more of the following cation dopants selected from: Mo, W, Zr, Y, Nb, Ti, Zn, Cr, Ni, Co, Bi, Pb, Sb, Sn, Cd, Mo, Hf, Ta, Si, La, and/or Ce, (iv) a scaffolding matrix material composition, and (v) a metal oxide or metal oxyfluoride protective layer comprising one, two or more of the following metals or semi-metals selected from: W, Y, Nb, La, Al and/or Si, wherein the scaffolding matrix material composition is configured to confine the LiF and the metal nanoparticles during the battery cell operation and to reduce volume changes in the composite core-shell particle during the battery cell operation.

In some aspects, the metal oxide or metal oxyfluoride protective layer protects a cathode active material from interactions with the electrolyte during the battery cell operation.

In some aspects, the one, two or more metals or semimetals of the metal oxide or metal oxyfluoride protective layer includes the W.

In some aspects, the composite core-shell particle is one of a plurality of composite core-shell particles in the cathode, and the metal of the metal oxide or metal oxyfluoride protective layer is distributed uniformly within a bulk of the plurality of composite core-shell particles to an interior of the metal oxide or metal oxyfluoride protective layer, as measured using energy dispersive spectroscopy (EDS).

In some aspects, the scaffolding matrix material composition is electrically conductive.

In some aspects, the scaffolding matrix material composition comprises about 70-100 at. % carbon.

In some aspects, the composite core-shell particles show D and G bands in the Raman spectra, as recorded using a wavelength of 488 nm, wherein a ratio of an intensity of the D band (ID) to an intensity of the G band (IG) ranges from about 0.5 to about 1.2.

In some aspects, the composite core-shell particle comprises at least about 10 at. % Fe.

In some aspects, the composite core-shell particle is one of a plurality of composite core-shell particles in the cathode, and the at least one cation dopant is distributed uniformly within the plurality of composite core-shell particles, as measured using energy dispersive spectroscopy (EDS).

In some aspects, the at least one cation dopant comprises zirconium (Zr).

In some aspects, the anode comprises silicon (Si) or carbon (C) or both.

Other objects and advantages associated with the aspects disclosed herein will be apparent to those skilled in the art based on the accompanying drawings and detailed description.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings are presented to aid in the description of embodiments of the invention and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example metal-ion (e.g., Li-ion) battery in which the components, materials, methods, and other techniques described herein, or combinations thereof, may be applied according to various embodiments.

FIG. 2 cross-sections of composite particles arranged at a cathode in accordance embodiments of the present disclosure.

FIG. 3 and FIG. 4 illustrate examples of suitable architectures for composite particles comprising intermixed dopant (D), metal (M) and LiF materials in accordance embodiments of the present disclosure.

FIG. 5 illustrate examples of an architecture for cell components and a cell that comprises conversion-type electrode(s) in accordance embodiments of the present disclosure.

FIG. 6 illustrates examples of processes involved in constructing a cell comprising conversion-type electrodes, such as composite cathode particles comprising mixed dopant (D), metal (M) and LiF materials, in accordance embodiments of the present disclosure.

FIG. 7 is a flowchart illustrating an example method of fabricating a conversion cathode active materials according to various example embodiments.

FIG. 8A provides a cross sectional energy-dispersive X-ray spectroscopy-scanning transmission electron microscopy (EDS-STEM) of Nb doped FeF₃ carbon composite materials. FIG. 8B provides a high-angle annular dark-field scanning transmission electron microscopy (HAADF-STEM) image. FIG. 8C provides a STEM-EDS line scan across the composite materials. The five different lines show the distribution of each element along the line traversing a spherical particle shown in FIG. 8B.

FIGS. 9A, 9B show an illustrative example of near-spherical electrode particles at least partially being sealed with a sealing layer deposited by means of metal organic chemical vapor deposition (MOCVD), according to different aspects of the present disclosure. FIG. 9A provides an EDS-STEM image of WO₃ sealed Matrix-FeF₃ material; an inner circle designates the Fe cores, while the outer shell indicates the WO₃ sealing layer. FIG. 9B provides an HAADF-STEM image. FIG. 9C provides a STEM-EDS line scan across the composite materials. The five different lines show the distribution of each element along the line traversing a spherical particle shown in FIG. 9B.

FIG. 10 is x-ray diffraction patterns of non-spherical Zr doped FeF₃ carbon composite materials synthesized in accordance embodiments of the present disclosure.

FIGS. 11A and 11B are SEM images of Nb doped FeF₃ carbon composite materials before and after WO₃ sealing, which have been synthesized in accordance embodiments of the present disclosure.

FIG. 12A provides EDS of Nb doped FeF₃ carbon composite materials and FIG. 12B provides EDS of WO₃ sealed Nb doped FeF₃ carbon composite materials.

FIG. 13A provides EDS of Zr doped FeF₃ carbon composite materials and FIG. 13B provides EDS of WO₃ sealed Zr doped FeF₃ carbon composite materials.

FIGS. 14A through 14E provide transmission electron microscope (TEM) images obtained at different magnifications for a composite material in accordance with some embodiment. FIG. 14F provides scanning electron microscopy-EDS mapping for a composite material in accordance with some embodiment.

FIG. 15 illustrates Raman spectra taken from the electrode prepared with a WO₃ sealed, Zr doped FeF₃ composite in accordance with an embodiment of the present disclosure.

FIGS. 16A through 16D illustrate X-ray photoelectron spectroscopy (XPS) analysis of W 4f spectrum (FIG. 16A), F 1s spectrum (FIG. 16B), Zr 3d spectrum (FIG. 16C), and O 1s spectrum (FIG. 16D) at the surface.

FIGS. 17A through 17D illustrate XPS depth profile analysis of W 4f spectrum (FIG. 17A), F 1s spectrum (FIG. 17B), Zr 3d spectrum (FIG. 17C), and O 1s spectrum (FIG. 17D).

FIG. 18 provides a top view SEM image of cathode electrode prepared using near-spherical electrode particles composed of WO₃ sealed, Matrix-Nb doped FeF₃ materials.

FIG. 19A provides a low resolution SEM image of the coated electrode prepared using non-spherical electrode particles and FIG. 19B provides a cross sectional high resolution SEM image of WO₃ sealed, Matrix-Zr doped FeF₃ materials. FIG. 19C provides EDS of the active material particle.

FIG. 20 provides a powder x-ray diffraction pattern of a matrix-M-F composite material that was chemically lithiated with an excess of lithium naphthalenide.

FIG. 21 provides the first and second cycles of chemically lithiated matrix-M-F composite coatings in coin cells vs Li.

FIG. 22 shows example electrochemical performance data of various electrodes produced using different Matrix-cation doped FeF₃ composite materials.

FIG. 23 shows example electrochemical performance data of an electrode produced according to an example embodiment as compared to performance of an unsealed material.

FIG. 24 shows example electrochemical performance data of an electrode prepared in accordance with an illustrative embodiment, which includes a cation doped metal, a skeleton matrix material, and a Li-ion permeable shell, employing either Nb or Zr as the dopant and WO₃ as the sealant.

FIGS. 25A through 25D show illustrative examples of selected performance characteristics of WO₃ sealed Zr-doped FeF₃ composite materials. The cells were cycled in the potential range from 1.0 to 4.25V. FIG. 23A shows typical charge-discharge curves for the formation cycle. FIGS. 25B through 25D shows electrochemical performance of the example cell. The cell was cycled at room temperature at 0.1 C for the formation cycle followed by 0.3 C.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details. Further, the terminology of “at least partially” is intended for interpretation as “partially, substantially or completely”.

While the description below may describe certain examples in the context of Li metal and Li-ion batteries (for brevity and convenience, and because of the current popularity of Li technology), it will be appreciated that various aspects may be applicable to other rechargeable and primary, metal and metal-ion batteries (such as Na metal and Na-ion, Mg metal and Mg-ion, K metal and K-ion, Ca metal and Ca-ion, Al metal and Al-ion, and others).

While the description below may also describe certain examples of the cathode material formulations either in a Li-free (e.g., charged) state or in a fully lithiated (e.g., discharged) state (e.g., as LiF-metal composites), it will be appreciated that various aspects may be applicable to various Li-containing electrodes (e.g., in either a partially or fully discharged state) or to essentially Li-free electrodes (e.g., in either a partially or fully charged state).

While the description below may also describe certain examples of Li presence in the form of the LiF, it will be appreciated that various aspects may be applicable when Li may be contained in the oxides, oxyfluorides, polymers (including conductive polymers) and other components of the cathode material formulations.

While the description below may describe certain examples of Li-ion batteries with LiF-comprising cathodes and Si-comprising anodes, it will be appreciated that various aspects may be applicable to battery cells comprising no Si in the anodes or no LiF in the cathodes.

While the description below may describe certain examples in the context of LiF chemistry, it will be appreciated that various aspects may be applicable to other lithium halide chemistries (such as LiCl, for example) or other alkali halide chemistries (such as NaF or KF or NaCl, for example) or alkaline earth halide chemistries (such as CaF₂ or CaCl₂), for example).

While the description below may describe certain examples in the context of “pure” fluoride-based chemistry of active conversion-type cathode materials (e.g., LiF and Cu, LiF and Fe, LiF and Fe—Cu, FeF₃, CuF₂, NiF₂, BiF₃, MnF₃, Cu—Fe—F₂₋₃, Cu—Fe—Mn—F₂₋₃, Cu—Fe—Ni—F₂₋₃, Cu—Bi—F₂₋₃, Cu—Fe—Bi—F₂₋₃ and many other “pure” metal fluoride-based chemistries and their mixtures), it will be appreciated that various aspects may be applicable to metal oxyfluorides/oxy-fluorides (e.g., Cu—O—F, Fe—O—F, Fe—Cu—O—F, Cu—Li—O—F, Fe—Li—O—F, Fe—Cu—Li—O—F, Fe—Cu—Mn—Li—O—F, Fe—Cu—Ni—Li—O—F, Fe—Cu—Bi—Li—O—F, and other compositions comprising mixed F and O anions), metal chloro-fluorides (e.g., Cu—Cl—F, Fe—Cl—F, Fe—Cu—Cl—F, Cu—Li—Cl—F, Fe—Li—Cl—F, Fe—Cu—Li—Cl—F, Fe—Cu—Mn—Li—Cl—F, Fe—Cu—Ni—Li—Cl—F, Fe—Cu—Bi—Li—Cl—F, and various other compositions comprising mixed F and Cl anions), metal bromo-fluorides (various compositions comprising mixed F and Br anions), metal oxy-chloro-fluorides (various compositions comprising mixed F, Cl and O anions), metal oxy-bromo-fluorides (various compositions comprising mixed F, Br and O anions), metal sulfo-fluorides (various compositions comprising mixed F and S anions), metal sulfo-oxy-fluorides (various compositions comprising mixed F, O and S anions), their various mixtures, alloys and other combinations and other mixed anions' comprising conversion-type cathode compositions where the atomic ratio of all the present nonmetals (e.g., O, S, Cl, Se and/or others) to F in the cathode material composition (e.g., the atomic ratio of O:F or the atomic ratio of (O and Cl and S and Se):F, etc.) may range from around 10-20 to around 7·10⁻¹.

While the description below may describe certain examples in the context of Li storage in the cathodes based on the transition metal (such as Cu, Fe, Mn, Ni, Bi, etc.) reduction-oxidation (redox) reactions, it will be appreciated that various aspects may be applicable to materials where a portion of Li storage relies on the anion (such as oxygen, O, etc.) redox reactions in the cathodes. Examples of such materials may include various conversion-type or intercalation-type or mixed-type cathode active materials that comprise both fluorine and at least one non-fluorine electronegative element that may exhibit multiple oxidation states, such as oxygen. In some designs, other (more rare) illustrative examples of such materials include those that in addition to metal(s) and fluorine also comprise sulfur or chlorine or other multivalent anions and their various combinations, etc.

While the description below may describe certain examples in the context of Li storage in the cathodes in the potential range from around 1.5 V to around 4-4.2V vs. Li/Li⁺, it will be appreciated that various aspects may be applicable to reversible Li storage in the potentials above around 4V vs. Li/Li⁺ (e.g., up to around 5.4 V vs. Li/Li⁺) or to reversible Li storage in the potentials below around 1.5V vs. Li/Li⁺ (e.g., down to around 0.5V vs. Li/Li⁺) or both. Also, it will be appreciated that the lower range of the potentials may be higher than around 1.5 V vs. Li/Li⁺ and the higher range of potentials may be lower than around 4.0 V vs. Li/Li⁺.

While the description below may describe certain examples in the context of “pure” conversion-type chemistry of active cathode materials, it will be appreciated that various aspects may be applicable to mixed intercalation/conversion type active materials where both intercalation and conversion mechanisms of Li ion storage may take place during battery cell operation. Furthermore, in some designs, primarily (e.g., between about 50-100%) intercalation-type mechanism(s) of Li ion storage may take place during some range of the cell charge or discharge (as an illustrative but not limited example, from around 0.0% to around 40.0% of the full discharge capacity). Similarly, in some designs, primarily (e.g., between about 50-100%) conversion-type mechanism(s) of Li ion storage may take place during some range of the cell charge or discharge (as an illustrative but not limited example, from around 0.5% to around 100.0% of the full discharge capacity).

While the description below may describe certain examples in the context of fluoride-based chemistry of active conversion-type cathode materials (e.g., LiF and Cu, LiF and Fe, LiF and Fe—Cu, FeF₃, CuF₂, BiF₃, NiF₂, Cu—Fe—F₂₋₃ and other fluoride-based chemistries), it will be appreciated that various aspects may be applicable to lithium chalcogenide (e.g., Li₂S or Li₂Se or Li₂—S—Se, etc.) based, metal oxyfluoride-based and other types of chemistries of conversion-type (including a displacement-type and a chemical transformation-type) active cathode (or anode, including Si-comprising or Si-based) materials.

While the description below may describe certain examples of polymer-comprising cathode (or anode) compositions in the context of specific polymer chemistries, it will be appreciated that various aspects may be applicable to cathodes (or anodes) and batteries (e.g., Li or Li-ion batteries) comprising other polymers, such as those that exhibit sufficiently high ionic conductivity and other suitable performance characteristics or compositional or structural or mechanical or physical or chemical features, as described herein.

While the description below may describe certain examples of Li metal and Li-ion batteries with a combination of conversion-type metal fluoride cathode materials and specific liquid electrolytes, it will be appreciated that various aspects may be applicable to battery cells comprising various solid and/or semisolid electrolytes, including but not limited to various gel polymer electrolytes, various solid polymer electrolytes (including those where anions are chemically linked to the polymer backbone), various ceramic electrolytes, various glass-ceramic electrolytes, various glass-liquid composite electrolytes, various ceramic-liquid composite electrolytes, various glass electrolytes, various other composite and nanocomposite solid electrolytes (e.g., those that comprise both polymer and inorganic (nano) materials), among others.

While the description below may describe certain examples in the context of particular electrode or electrode particle chemistry, composition, architecture and morphology, certain examples in the context of particular or electrode particle synthesis stages, certain examples in the context of particular electrolyte composition, certain examples in the context of particular electrolyte incorporation into an electrode or a battery cell, it will be appreciated that various aspects may be applicable to battery cells that advantageously incorporate a combination of some of the described electrode chemistries, composition, architecture as well as electrolyte composition and electrode or cell manufacturing methods.

While the description below may describe certain examples in the context of metal fluoride-based electrode chemistry, it will be appreciated that various aspects may be applicable to other types of cathodes as well as various types of anodes (e.g., silicon (Si)-comprising anodes), including various alloying-type anodes (including Li metal anode), conversion-type cathodes and anodes, intercalation-type and mixed type cathodes and anodes. Furthermore, various electrolyte-related aspects of the description may be related to full cells, where electrolyte may be incorporated into the anode, cathode and/or the separator. In various aspects of the disclosure, alloying-type electrodes (e.g., anodes or cathodes) are considered to be a sub-class of conversion-type electrodes.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| Material | | Measurement | |
|---|---|---|---|
| Type | Property Type | Instrumentation | Measurement Technique |
| Active | Coulombic | Potentiostat | Charge (current) is passed to |
| Material | Efficiency | | an electrode containing the |
| | | | active material of interest until |
| | | | a given voltage limit is |
| | | | reached. Then, the current is |
| | | | reversed (discharge current) |
| | | | until a second voltage limit is |
| | | | reached. The ratio of the two |
| | | | charges passed determines the |
| | | | Coulombic Efficiency (CE). In |
| | | | the simplest case, the charge |
| | | | and discharge currents may be |
| | | | constant and often have |
| | | | absolute values that are the |
| | | | same or close to each other. It |
| | | | should be understood though |
| | | | that in some experiments, |
| | | | either charge current or |
| | | | discharge current or both may |
| | | | be changing during such |
| | | | experiments (e.g., be initially |
| | | | constant and when the voltage |
| | | | limit is reached, diminishing to |
| | | | a predetermined value). In |
| | | | addition, the absolute value of |
| | | | the charge and discharge |
| | | | currents may differ. |
| Active | Partial Vapor | Manometer | The partial vapor pressure of |
| Material | Pressure (e.g., | | an active material in a mixture |
| | Torr.) at a | | (e.g., composite particle) at a |
| | Temperature | | particular temperature is given |
| | (e.g., K) | | by the known vapor pressure |
| | | | of the active material |
| | | | multiplied by its mole fraction |
| | | | in the mixture. |
| Active | Volume | Gas pycnometer | Gas pycnometer measures the |
| Material | | | skeletal volume of a material |
| Particle | | | by gas displacement using the |
| | | | volume-pressure relationship |
| | | | of Boyle's Law. A sample of |
| | | | known mass is placed into the |
| | | | sample chamber and |
| | | | maintained at a constant |
| | | | temperature. An inert gas, |
| | | | typically helium, is used as the |
| | | | displacement medium. |
| | | | Note: A vol. % change may be |
| | | | calculated from two volume |
| | | | measurements of the active |
| | | | material particle. |
| Active | Open Internal | nitrogen | Nitrogen sorption/desorption |
| Material | Pore Volume | sorption/desorption | isotherm (typically at 77 K) is |
| Particle | (e.g., cc/g or | isotherm | collected and analyzed to |
| | cm³/g) | | estimate the total amount of |
| | | | gas adsorbed/desorbed and |
| | | | internal pore volume of the |
| | | | sample with known mass is |
| | | | estimated from such |
| | | | measurements. Pore size |
| | | | distribution (PSD) may be |
| | | | further estimated from the |
| | | | sorption/desorption isotherm |
| | | | using various analyses, such as |
| | | | Non-Local Density Functional |
| | | | Theory (NLDFT) |
| Active | Volume- | PSA, scanning | PSA using laser scattering, |
| Material | Average Pore | electron microscope | electron microscopy (SEM, |
| Particle | Size and Pore | (SEM), transmission | TEM, STEM) in combination |
| | Size | electron microscope | with image analyses, laser |
| | Distributions | (TEM), scanning | microscopy (for larger |
| | (e.g., nm) | transmission | particles and larger pores) in |
| | | microscope (STEM), | combination with image |
| | | laser microscope, | analyses, optical microscopy |
| | | Synchrotron X-ray, | (for larger particles and larger |
| | | X-ray microscope | pores), neutron scattering, X- |
| | | | ray scattering, X-ray |
| | | | microscopy imaging may be |
| | | | employed to measure pore |
| | | | sizes (average pore size or |
| | | | pore size distribution) in |
| | | | different size ranges (in |
| | | | addition to the analysis of the |
| | | | sorption/desorption isotherms). |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas pycnometer |
| | | | (or a nitrogen gas pycnometer) |
| | | | and comparing them to the |
| | | | theoretical density of the |
| | | | individual material |
| | | | components present in Si- |
| | | | comprising particles. In |
| | | | addition, closed internal pore |
| | | | volume may be estimated by |
| | | | comparing the total pore |
| | | | volume estimated from |
| | | | neutron scattering and the |
| | | | nitrogen-accessible pore |
| | | | volume estimated from |
| | | | nitrogen sorption isotherms. |
| Active | Closed | Gas pycnometer | With a pycnometer, the |
| Material | Internal | | amount of a certain medium |
| Particle | Volume- | | (liquid or Helium or other |
| | Average Size | | analytical gases) displaced by |
| | (e.g., nm) | | a solid can be determined. |
| Active | Size | TEM, STEM, SEM, | Laser particle size distribution |
| Material | (e.g., nm, μm, | X-Ray, PSA, etc. | analysis (LPSA), laser image |
| Particle | etc.) | | analysis, electron microscopy, |
| | | | optical microscopy or other |
| | | | suitable techniques |
| | | | transmission electron |
| | | | microscopy (TEM), scanning |
| | | | transmission electron |
| | | | microscopy (STEM), scanning |
| | | | electron microscopy (SEM)), |
| | | | X-ray microscopy, X-ray |
| | | | diffraction, neutron scattering |
| | | | and other suitable techniques |
| Active | Composition | Balance | Note #1: A wt. % change may |
| Material | (e.g., mass | | be calculated by comparing the |
| Particle | fraction or wt. | | mass fraction of a material in |
| | %, mg, | | the particle relative to the total |
| | number of | | particle mass. |
| | atoms, etc.) | | Note #2: The capacity |
| | | | attributable to particular active |
| | | | material(s) in the particle may |
| | | | be derived from the |
| | | | composition, based on the |
| | | | known (e.g., theoretical or |
| | | | practically attainable) |
| | | | capacity(ies) of each active |
| | | | material. |
| | | | Note #3: The composition of |
| | | | the particle may be |
| | | | characterized in terms of |
| | | | weight (e.g., mg). The |
| | | | composition may alternatively |
| | | | be characterized by a number |
| | | | of atoms of a particular |
| | | | element (e.g., Si, C, etc.). In |
| | | | case of atoms, the number of |
| | | | atoms may be estimated from |
| | | | the weight of that atom in the |
| | | | particle (e.g., based on gas |
| | | | chromatography) |
| Active | Composition | X-ray Fluorescence | |
| Material | (e.g., mass | (XRF), Inductively | |
| Particle | fraction or wt. | Coupled Plasma | |
| | % of various | Optical Emission | |
| | atomic | Spectroscopy (ICP- | |
| | elements or | OES); Energy | |
| | molecules, | Dispersive | |
| | atomic | Spectroscopy (EDS), | |
| | fraction or at. | Wavelength | |
| | % of various | Dispersive | |
| | elements, etc.) | Spectroscopy (WDS), | |
| | | Electron Energy Loss | |
| | | Spectroscopy (EELS), | |
| | | Nuclear Magnetic | |
| | | Resonance (NMR); | |
| | | Secondary Ion Mass | |
| | | Spectrometry (SIMS); | |
| | | X-Ray Photoelectron | |
| | | Spectroscopy (XPS); | |
| | | Fourier Transform | |
| | | Infrared Spectroscopy | |
| | | (FTIR) and Raman | |
| | | Spectroscopy | |
| | | (Raman) | |
| Active | Specific | Potentiostat | An electrode containing an |
| Material | Capacity | | active anode or cathode |
| Particle, | | | material of interest is charged |
| Battery Half- | | | or discharged (by passing |
| Cell | | | electrical current to the |
| | | | electrode) within certain |
| | | | potential limits using an |
| | | | electrochemical cell with a |
| | | | suitable reference electrode, |
| | | | typically lithium metal. The |
| | | | total charge passed (e.g., in |
| | | | mAh) divided by the active |
| | | | material mass (e.g., in g) gives |
| | | | this quantity (e.g., in mAh/g). |
| | | | The active mass is computed |
| | | | by multiplying the total mass |
| | | | of the electrode by the active |
| | | | material mass fraction. Both |
| | | | reversible and irreversible |
| | | | capacity during charge or |
| | | | discharge may be calculated in |
| | | | this way. |
| Active | BET-SSA | BET instrument | A sample is placed into a |
| Material | (Brunauer- | | sealed chamber at 77 K, where |
| Particle | Emmett-Teller | | nitrogen is introduced at |
| | specific | | increasing pressure. The |
| | surface area) | | change in pressure of the |
| | (e.g., m²/g) | | nitrogen is used to calculate |
| | | | the surface area of the sample. |
| Active | Aspect Ratio | SEM, TEM | The dimensions and shape of |
| Material | | | the particles are typically |
| Particle | | | measured by using SEM or |
| | | | TEM or (for large particles) by |
| | | | using optical microscopy. |
| Active | True Density | Argon Gas | True density values may be |
| Material | of Particle | Pycnometer or | measured by using an argon |
| Particle | (e.g., g/cc or | nitrogen gas | gas pycnometer (or a nitrogen |
| | g/cm³) | pycnometer | gas pycnometer) and |
| | | | comparing to the theoretical |
| | | | density of the individual |
| | | | material components present |
| | | | in the particle. |
| Active | Particle Size | Dynamic light | laser particle size distribution |
| Material | Distribution | scattering particle size | analysis (LPSA) on well- |
| Particle | (e.g., nm or | analyzer, scanning | dispersed particle suspensions |
| Population | μm) | electron microscope | in one example or by image |
| | | | analysis of electron |
| | | | microscopy images, or by |
| | | | other suitable techniques. |
| | | | While there are diverse |
| | | | processes of measuring PSDs, |
| | | | laser particle size distribution |
| | | | analysis (LPSA) is quite |
| | | | efficient for some applications. |
| | | | Note that other types of |
| | | | particle size distribution (e.g., |
| | | | by SEM image analysis) could |
| | | | also be utilized (and may even |
| | | | lead to more precise |
| | | | measurements, in some |
| | | | experiments). Using LPSA, |
| | | | particle size parameters of a |
| | | | population's PSD may be |
| | | | measured, such as: a tenth- |
| | | | percentile volume-weighted |
| | | | particle size parameter (e.g., |
| | | | abbreviated as D₁₀), a fiftieth- |
| | | | percentile volume-weighted |
| | | | particle size parameter (e.g., |
| | | | abbreviated as D₅₀), a |
| | | | ninetieth-percentile volume- |
| | | | weighted particle size |
| | | | parameter (e.g., abbreviated as |
| | | | D₉₀), and a ninety-ninth- |
| | | | percentile volume-weighted |
| | | | particle size parameter (e.g., |
| | | | abbreviated as D₉₉). |
| Active | Width (e.g., | PSA | Parameters relating to |
| Material | nm) | | characteristic widths of the |
| Particle | | | PSD may be derived from |
| Population | | | these particle size parameters, |
| | | | such as D₅₀-D₁₀ (sometimes |
| | | | referred to herein as a left |
| | | | width), D₉₀-D₅₀ (sometimes |
| | | | referred to herein as a right |
| | | | width), and D₉₀-D₁₀ |
| | | | (sometimes referred to herein |
| | | | as a full width). |
| Active | Cumulative | Computed via LPSA | A cumulative volume fraction, |
| Material | Volume | data | defined as a cumulative |
| Particle | Fraction | | volume of the composite |
| Population | | | particles with particle sizes of |
| | | | a threshold particle size or |
| | | | less, divided by a total volume |
| | | | of all of the composite |
| | | | particles, may be estimated by |
| | | | LPSA. |
| Active | Composition | Balance | The mass of active materials |
| Material | (e.g., wt. %) | | added to the electrode divided |
| Particle | | | by the total mass of the |
| Population | | | electrode. |
| Active | BET-SSA | BET Isotherm | obtained from the data of |
| Material | (e.g., m²/g) | | nitrogen sorption-desorption at |
| Particle | | | cryogenic temperatures, such |
| Population | | | as about 77 K |
| Electrolyte | Salt | balance, volumetric | Total volume of the solution is |
| | Concentration | pipette | computed either via the sum of |
| | (e.g., M or | | the volume of the constituents |
| | mol. %) | | (measured by a volumetric |
| | | | pipette), or by the mass of the |
| | | | constituents divided by the |
| | | | density. The molar mass of the |
| | | | salt is then used to calculate |
| | | | the total number of moles of |
| | | | salt in the solution. The moles |
| | | | of salt is then divided by the |
| | | | total volume to obtain the |
| | | | solvent concentration in M |
| | | | (mol/L). |
| Electrolyte | Solvent | balance, volumetric | Total volume of the solution is |
| | Concentration | pipette | computed either via the sum of |
| | (e.g., M or | | the volume of the constituents |
| | mol. %) | | (measured by a volumetric |
| | | | pipette), or by the mass of the |
| | | | constituents divided by the |
| | | | density. The molar volume of |
| | | | each solvent is then used to |
| | | | calculate the total number of |
| | | | moles of solvent in the |
| | | | solution. The moles of solvent |
| | | | is then divided by the total |
| | | | volume to obtain the solvent |
| | | | concentration in M (mol/L). |
| Electrode | Composition | Balance | The mass fraction of a material |
| | (e.g., mass | | (e.g., active material, active |
| | fraction or wt. | | material particle, binder, etc.) |
| | %) | | in the electrode is calculated |
| | | | based on a measured or |
| | | | estimated mass of the material |
| | | | and a measured or estimated |
| | | | mass of the electrode, |
| | | | excluding the electrode current |
| | | | collector. |
| | | | Note: The mass of individual |
| | | | components (e.g., composite |
| | | | active material particles, |
| | | | graphite particles, binder, |
| | | | function additive(s), etc.) of |
| | | | the battery electrode |
| | | | composition may be measured |
| | | | before being mixed into a |
| | | | slurry to estimate their mass in |
| | | | a casted electrode. The mass of |
| | | | materials deposited onto the |
| | | | casted electrode may be |
| | | | measured by comparing the |
| | | | weight of the casted electrode |
| | | | before/after the material |
| | | | deposition. |
| Electrode | Areal Binder | balance | A mass fraction of the binder |
| | Loading (e.g., | | in the battery electrode, |
| | mg/m²) | | divided by a product of (1) a |
| | | | mass fraction of the active |
| | | | material (e.g., Si—C |
| | | | nanocomposite, etc.) particles |
| | | | in the battery electrode, and |
| | | | (2) a Brunauer-Emmett-Teller |
| | | | (BET) specific surface area of |
| | | | the active material particle |
| | | | population. |
| Electrode | Capacity | Calculated | Measure the mass (wt.) of |
| | Attributable to | | active material in the |
| | Active | | electrode, and calculate |
| | Material | | electrode capacity based on the |
| | (active | | known theoretical capacity of |
| | material | | the active material. For |
| | capacity | | example, the average wt. % of |
| | fraction) | | active material in each active |
| | | | material particle may be |
| | | | measured and used to calculate |
| | | | the mass of the active material |
| | | | based on the mass of the active |
| | | | material particles before being |
| | | | mixed in the slurry. This |
| | | | process may be repeated if the |
| | | | electrode includes two or more |
| | | | active materials to calculate |
| | | | the relative capacity attribution |
| | | | for each active material in the |
| | | | electrode. |
| Electrode | Capacity | Potentiostat and | Determine the average specific |
| | Attributable to | balance | capacity (mAh/g) of active |
| | Active | | material particles. For |
| | Material | | example, the average specific |
| | Particles | | capacity may be estimated |
| | (active | | from the average wt. % of |
| | material | | active material(s) in each |
| | particle | | particle and its associated |
| | capacity | | known theoretical |
| | fraction) | | capacity(ies). Then, measure |
| | | | the mass (wt.) of active |
| | | | material particles in the |
| | | | electrode before being mixed |
| | | | in slurry, which may be used |
| | | | to calculate the capacity |
| | | | attributable to that active |
| | | | material. This process may be |
| | | | repeated if the electrode |
| | | | includes two or more active |
| | | | material particle types to |
| | | | calculate the relative capacity |
| | | | attribution for each active |
| | | | material particle type in the |
| | | | electrode. |
| Electrode | Mass of | balance | The average wt. % of active |
| | Active | | material in each active |
| | Material in | | material particle may be |
| | Electrode | | measured, and used to |
| | | | calculate the mass of the active |
| | | | material based on the mass of |
| | | | the active material particles |
| | | | before being mixed in slurry. |
| Electrode | Mass of | balance | Measure the active material |
| | Active | | particle before the active |
| | Material | | material particle type is mixed |
| | Particle in | | in the slurry. |
| | Electrode | | |
| Electrode | Areal | Potentiostat and | Areal capacity loading is the |
| | Capacity | balance | weight of the coated active |
| | Loading (e.g., | | material per unit area (g/cm²) |
| | mAh/cm²) | | multiplied by the gravimetric |
| | | | capacity of the active material |
| | | | (not the electrode, but the |
| | | | active material itself with zero |
| | | | binder and zero electrolyte; |
| | | | mAh/g). |
| Electrode | Coulombic | Potentiostat | The change in charge inserted |
| | Efficiency | | (or extracted) to an electrode |
| | | | divided by the charge |
| | | | extracted (or inserted) from the |
| | | | electrode during a complete |
| | | | electrochemical cycle within |
| | | | given voltage limits. Because |
| | | | the direction of charge flow is |
| | | | opposite for cathodes and |
| | | | anodes, the definition is |
| | | | dependent on the electrode. |
| | | | Coulombic Efficiency is |
| | | | measured for both materials by |
| | | | constructing a so-called half- |
| | | | cell, which is an |
| | | | electrochemical cell consisting |
| | | | of a cathode or anode material |
| | | | of interest as the working |
| | | | electrode and a lithium metal |
| | | | foil which functions as both |
| | | | the counter and reference |
| | | | electrode. Then, charge is |
| | | | either inserted or removed |
| | | | from the material of interest |
| | | | until the cell voltage reaches |
| | | | an appropriate limit. Then, the |
| | | | process is reversed until a |
| | | | second voltage limit is |
| | | | reached, and the charge passed |
| | | | in both steps is used to |
| | | | calculate the Coulombic |
| | | | Efficiency, as described above. |
| Battery Cell | Rate | Potentiostat | This is the time it takes to |
| | Performance | | charge or discharge a battery |
| | | | between a given state of |
| | | | charge. It is measured by |
| | | | charging or discharging a |
| | | | battery and measuring the time |
| | | | until a specified amount of |
| | | | charge is passed, or until the |
| | | | battery operating voltage |
| | | | reaches a specified value. |
| Battery Cell | Cell | Potentiostat | A battery consisting of a |
| | Discharge | | relevant anode and cathode is |
| | Voltage (e.g., | | charged and discharged within |
| | V) | | certain voltage limits and the |
| | | | charge-weighted cell voltage |
| | | | during discharge is computed. |
| Battery Cell | Operating | Potentiostat and | Average temperature of |
| | Temperature | thermocouples | battery cell as measured at the |
| | | | positive/negative terminal/ |
| | | | cell shaft/etc. while |
| | | | charging/discharging, or at a |
| | | | certain voltage level, or while |
| | | | a load is applied, etc. |
| Battery Half- | Anode | Potentiostat | An electrode containing an |
| Cell | Discharge (de- | | active anode material (or a |
| | lithiation) | | mixture of active materials) of |
| | Potential | | interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell potential |
| | | | upon discharge (corresponding |
| | | | to de-lithiation of the anode) is |
| | | | computed. |
| Battery Half- | Cathode | Potentiostat | An electrode containing an |
| Cell | Discharge | | active cathode material (or a |
| | (lithiation) | | mixture of active materials) of |
| | Potential | | interest is charged and |
| | (e.g., V) | | discharged (by passing |
| | | | electrical current to the |
| | | | electrode) within certain |
| | | | potential limits using an |
| | | | electrochemical cell with a |
| | | | suitable reference electrode, |
| | | | typically lithium metal. The |
| | | | charge-averaged cell potential |
| | | | upon discharge (corresponding |
| | | | to lithiation of the cathode) is |
| | | | computed. |
| Battery Cell | Volumetric | Potentiostat | The VED is calculated by first |
| | Energy | | calculating the energy per unit |
| | Density | | area of the battery, and then |
| | (VED) | | dividing the energy per unit |
| | | | area by the sum of the |
| | | | illustrative anode, cathode, |
| | | | separator, and current collector |
| | | | thicknesses |
| Battery Cell | Internal | Potentiostat | The internal resistance (also |
| | Resistance | | known as impedance in many |
| | (impedance) | | contexts) is measured by |
| | | | applying small pulses of |
| | | | current to the battery cell and |
| | | | recording the instantaneous |
| | | | change in cell voltage. |

While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, alkaline batteries, flow batteries, etc.) as well as electrochemical capacitors and hybrid energy storage devices.

While the description below may describe certain examples in the context of composites comprising alloying-type active anode materials (such as Si, among others), it will be appreciated that various aspects may be applicable to conversion-type active anode and cathode materials, intercalation-type anode and cathode materials, pseudocapacitive anode and cathode materials, and materials that may exhibit mixed electrochemical energy storage mechanisms.

While the description below may also describe certain examples of the material formulations in a Li-free state (for example, as in silicon-comprising nanocomposite anodes or metal fluoride cathodes), it will be appreciated that various aspects may be applicable to Li-containing electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Se/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector. Moreover, as used here, an Li-free state is used to refer to a material that is free of electrochemically active Li, and other types of Li such as in electrochemically inactive compounds may (optionally) be part of such an Li-free material.

In certain aspects, the disclosure relates to batteries. While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline ion batteries, flow batteries, etc.).

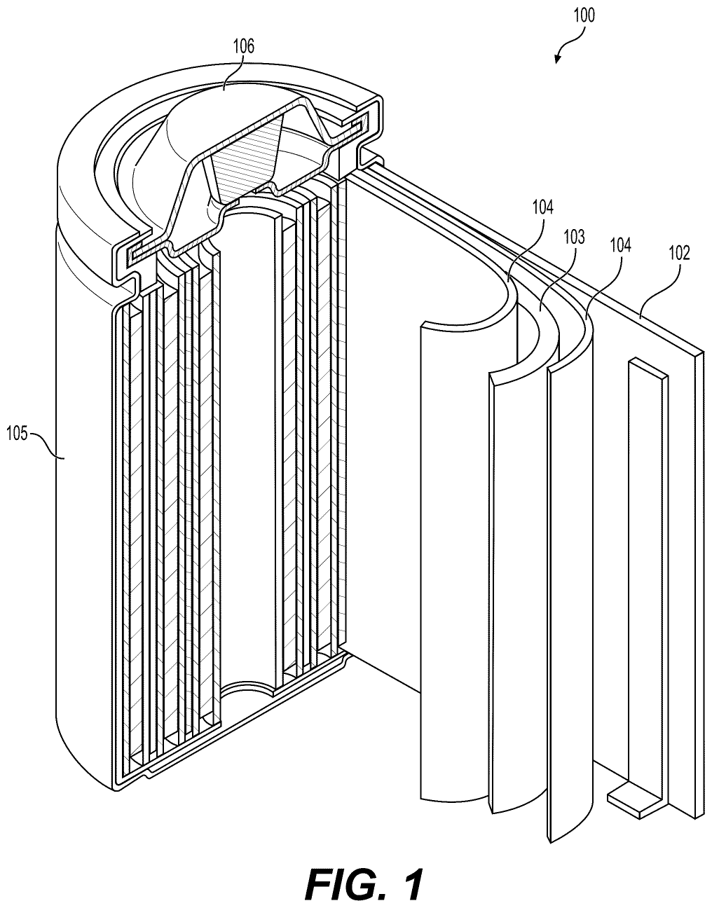

FIG. 1 illustrates an example metal (e.g., Li or Li alloy) or metal-ion (e.g., Li-ion) battery in which the components, materials, methods, and other techniques described herein, or combinations thereof, may be applied according to various embodiments. A cylindrical battery is shown here for illustration purposes, but other types of arrangements, including prismatic, coin or pouch (laminate-type) batteries, may also be used as desired. The example battery 100 includes a negative anode 102, a positive cathode 103, a separator 104 interposed between the anode 102 and the cathode 103, an electrolyte (not shown) impregnating the separator 104 (and typically the anode 102 and the cathode 103 as well), a battery case 105, and a sealing member 106 sealing the battery case 105.

In some designs, electrolyte (e.g., in the form of a solid electrolyte) may be used as the separator (or separator membrane) 104, while in other designs the electrolyte (e.g., in the form of a liquid electrolyte) may interface with one or more other separator components (e.g., a polymeric material, a ceramic material, etc.) to form the separator 104.

Conventional cathode materials utilized in metal-ion batteries are of an intercalation-type. Metal ions are intercalated into and occupy the interstitial positions of such materials during the discharge of a battery. However, such cathodes exhibit small gravimetric and more importantly small volumetric capacities: e.g., typically less than around 220 mAh/g active material and less than around 700 mAh/cm³ at the electrode level, respectively. This low capacity of intercalation-type cathodes limits the energy density and specific energy of metal and metal-ion batteries for some applications.

Fluoride-based cathodes may offer outstanding technological potential due to their very high capacities, in some cases exceeding around 300 mAh/g (and greater than around 1200 mAh/cm³ at the electrode level). For example, FeF₃ offers a theoretical specific capacity of 712 mAh/g; FeF₂ offers a theoretical specific capacity of 571 mAh/g; MnF₃ offers a theoretical specific capacity of 719 mAh/g; CuF₂ offers a theoretical specific capacity of 528 mAh/g; NiF₂ offers a theoretical specific capacity of 554 mAh/g; PbF₂ offers a theoretical specific capacity of 219 mAh/g; BiF₃ offers a theoretical specific capacity of 302 mAh/g; BiF₅ offers a theoretical specific capacity of 441 mAh/g; SnF₂ offers a theoretical specific capacity of 342 mAh/g; SnF₄ offers a theoretical specific capacity of 551 mAh/g; SbF₃ offers a theoretical specific capacity of 450 mAh/g; SbF₅ offers a theoretical specific capacity of 618 mAh/g; CdF₂ offers a theoretical specific capacity of 356 mAh/g; and ZnF₂ offers a theoretical specific capacity of 519 mAh/g.

In addition, in cases where the fluoride-forming element is inexpensive, fluoride-based cathodes offer a low-cost potential as well. The 5-year averaged wholesale commodity cost of many fluoride-forming elements is reasonably low. For example, in 2023, the 5-year averaged wholesale commodity cost of Fe was only around $0.15/kg; the cost of Cu was only around $7.4/kg; the cost of Zn was only around $2-3/kg; the cost of Cd was only around $3/kg; the cost of Pb was only around $2/kg; and the cost of Sb was only around $11/kg.

However, many fluorides with high theoretical capacity and high theoretical energy density (such as CuF₂, NiF₂, MnF₃, PbF₂, BiF₃, BiF₅, SnF₂, SnF₄, SbF₃, CdF₂, ZnF₂, and others) have been believed not to be practical for use in rechargeable Li-ion batteries due to the previously observed lack of stability and very large polarizations experimentally observed when they were used in conventional cathode configurations, where metal fluorides were mechanically mixed with carbon additives or deposited on the outer surface of carbon particles. One advantage of some of these so-called “impractical” fluorides (such as CuF₂, PbF₂, SnF₂, CdF₂, ZnF₂, and others) over more generally used (and still not very practical yet) FeF₃ is an experimentally observed flatter discharge curve and often (e.g., in case of CuF₂) higher energy density and higher specific energy at the battery cell level.

In contrast to the small structural, chemical, and volumetric differences observed during insertion/extraction of Li ions into/out of so-called intercalation cathode compounds (where Li is inserted/intercalated into the interstitials of the intercalation crystals), conversion-type fluorides exhibit dramatic structural changes and significant volume changes accompanying cell cycling. During electrochemical Li insertion into a metal fluoride-based cathode, a displacement/conversion process takes place, where Li displaces solid fluoride-forming element(s) (such as metals or semimetals, or in some cases semiconductors), leading to the formation of solid LiF and clusters of the fluoride-forming element(s), e.g., typically only around 2-10 nanometers in size. Theoretically, the Li capacity of fluorides is determined by their stoichiometry and the density of the fluoride-forming metal according to the following reaction (which assumes fully reversible electrochemical transformation during charge and discharge, which does not always takes place):

$$x {Li}^{+} + x {e}^{-} + M {F}_{x} ↔ x LiF + M \qquad ( Eq . 1 )$$

where M is a fluoride-forming element (e.g., a transition metal).

Mechanistically, initial insertion of Li into some of the metal fluorides with metals possessing a higher oxidation state (such as FeF₃) may take place as intercalation or displacement. For example, during electrochemical reaction of Li with FeF₃, at least some Li is believed to be able to first intercalate into the structure forming:

$${Li}^{+} + {e}^{-} + {FeF}_{3} \to {LiFeF}_{3} \qquad ( Eq . 2 )$$

Only after additional Li insertion, a full conversion reaction (which may not always take place) is believed to be able to transform the reaction products to LiF and (in an ideal case) interconnected Fe nanoparticles according to:

$$2 {Li}^{+} + 2 {e}^{-} + {LiFe}_{3} \to 3 LiF + Fe \qquad ( Eq . 3 )$$

As discussed in the background above, conventional fluoride cathodes may suffer from limitations, such as (i) low electrical conductivity; (ii) low ionic conductivity, and (iii) volume expansion during electrochemical lithiation and formation of LiF and metal clusters. Other limitations may include (iv) gas generation during fluoride reactions with electrolytes (particularly at high potentials), which may cause battery degradation; (v) formation of surface species during surface reactions with the electrolyte, which may increase resistance and reduce reversibility of electrochemical reactions; (vi) irreversible oxidation of metals and dissolution of the metal fluorides during cycling, which may increase resistance, damage the solid electrolyte interphase (SEI) layer on the anode, and reduce both the power performance and cycle stability of battery cells; (vii) irreversible changes within their structure during battery operation (such as irreversible growth of the LiF and metal clusters/nanoparticles), which may also lead to irreversible resistance growth capacity losses; (viii) continuous electrolyte decomposition on the cathode and associated large irreversible Li losses typically leading to cell degradation via the undesirable increase in cell resistance and irreversible capacity losses; (ix) high energy losses during charge-discharge cycles and large overpotential during charge and/or discharge, especially at moderately high rates (e.g., about 0.2-1C rates) and even more so at fast rates (e.g., about 1C-6C), especially at room or lower temperatures; (x) high resistance (e.g., high Direct Current Resistance (DCR)), especially at low temperatures; (xi) slow rate of desirable electrochemical reactions; (xii) fast rate of undesirable electrochemical reactions; (xiii) excessive resistance growth during cycling; (xiv) average voltage decay during cycling and (xv) the need to couple a Li-free metal fluoride-comprising cathode with a reactive and difficult to handle Li-comprising anode to form a functional cell. Aspects of the present disclosure overcome some or all of the above-discussed above challenges to facilitate production of stable, high capacity, high energy density fluoride-based cathodes.

The performance of cells comprising conversion-type fluoride cathodes often becomes particularly poor for certain applications when the electrode capacity loading becomes moderate (e.g., about 2-4 mAh/cm²-on each side in case of double-sided electrodes) or even more so when it becomes high (e.g., about 4-12 mAh/cm²-on each side in case of double-sided electrodes). Higher capacity loading, however, is advantageous for increasing cell energy density and reducing cell manufacturing costs. Aspects of the present disclosure overcome this challenge to facilitate production of stable, high capacity, high energy density fluoride-based cathodes with moderate or high capacity loadings.

The performance of cells comprising conversion-type fluoride cathodes often becomes particularly poor for certain applications when volumetric electrode capacity becomes moderate (e.g., in the range from around 600 to around 1000 mAh/cm³) and even more so when it becomes high (e.g., in the range from around 1000 to around 1800 mAh/cm³). Higher volumetric capacity, however, is highly beneficial for maximizing cell-level volumetric energy (and often cell-level specific energy). Aspects of the present disclosure overcome this challenge to facilitate production of stable metal fluoride-based conversion-type cathodes with moderate or high volumetric capacities at the electrode level.

The performance of cells comprising conversion-type fluoride cathodes often becomes particularly poor when the cell anodes also comprise conversion-type anodes (e.g., silicon-comprising or aluminum-comprising or tin-comprising or lithium metal or lithium metal alloy-comprising anodes, among other known types of conversion type anodes that also include alloying-type anodes). Aspects of the present disclosure overcome this challenge to facilitate production of cells that comprise conversion-type materials in both electrodes in order to attain higher energy density and better overall cell performance.

The performance of cells comprising conversion-type fluoride cathodes often becomes particularly poor for certain applications when relatively thin (e.g., in the range from around 2.0 μm to around 15.0 μm) current collector foils are used (particularly when moderate and even more so when high areal capacity electrodes are utilized in cell designs and when electrodes exhibit moderate and even more so when they exhibit high volumetric capacities). The use of thinner current collector foils, however, is beneficial for maximizing cell-level energy density and specific energy and, in some cases, for reducing battery manufacturing cost (on a $/Wh basis). Aspects of the present disclosure overcome this challenge to facilitate production of stable metal fluoride-based conversion-type cathodes coated on relatively thin current collector foils (e.g., in the range from around 2.0 μm to around 15.0 μm; in some designs from around 6.0 μm to around 12.0 μm).

The performance of cells comprising conversion-type fluoride cathodes often becomes particularly poor for certain applications when cells are exposed to moderately elevated temperatures (e.g., temperatures in the range from around +25.0° C. to around +60.0° C.) and even more so when cells are exposed to highly elevated temperatures (e.g., temperature in the range from around +60.0° C. to around +200.0° C.). However, some applications may require occasional cell exposure to temperatures above about +25° C. or higher temperatures during at least some operational time for at least some customers. In some designs, keeping the cell temperature sufficiently low (e.g., below about 25.0° C. or below about 60.0° C.) may undesirably increase battery or battery pack weight and volume and costs (e.g., by utilizing relatively bulky and expensive thermal management system(s)). Aspects of the present disclosure overcome this challenge to facilitate production of stable cells with metal fluoride-based conversion-type cathodes that may be exposed to moderately elevated temperatures or highly elevated temperatures while keeping sufficiently high (for a given application) cycle stability or operational life stability.

The performance of cells comprising conversion-type fluoride cathodes often becomes particularly poor for certain applications when cells need to be charged moderately quickly (e.g., from around 2 h to around 6 h from less than around 20% state of charge to over around 80% state of charge) or quickly (e.g., from around 0.5 h to around 2 h from less than around 20% state of charge to over around 80% state of charge) or very quickly (e.g., from around 3 min to around 30 min from less than around 20% state of charge to over around 80% state of charge). Faster charging, however, may be highly desired or advantageous in some applications (e.g., for some electronic devices or for some ground or marine or mixed-use electric vehicles or some unmanned electric vehicles or drones or battery-powered robots). Aspects of the present disclosure overcome this challenge to facilitate production of stable cells with metal fluoride-based conversion-type cathodes that may be charged moderately quickly, quickly or very quickly.

The performance of cells comprising conversion-type fluoride cathodes often becomes particularly poor for certain applications when the volume fraction of electrolyte within the cathodes becomes relatively small or moderate (e.g., from around 8.0 vol. % to around 40.0 vol. %). However, reducing (e.g., minimizing) the volume fraction of electrolyte in the cathodes (while keeping the rate performance and stability sufficiently good for specific applications) may be advantageous for increasing (e.g., maximizing) volumetric capacity of the electrodes and cell-level energy density and specific energy values. Aspects of the present disclosure overcome this challenge to facilitate production of stable cells with sufficiently high rate performance and energy density with electrolyte occupying relatively small or moderate fraction of the total cathode volume (e.g., from around 8.0 vol. % to around 40.0 vol. %; in some designs from around 20 vol. % to around 35 vol. %). Similarly, the performance of cells comprising conversion-type anodes (or a combination of conversion type anodes and conversion type cathodes) may become poor when the volume fraction of electrolyte within the anode becomes relatively small or moderate (e.g., from around 108.0 vol. % to around 40.0 vol. %). Aspects of the present disclosure overcome this challenge as well.

The performance of cells comprising conversion-type fluoride cathodes often becomes particularly poor for certain applications when the volume fraction of electrolyte within the cells become relatively small or moderate (e.g., from around 8.0 vol. % to around 40.0 vol. %). However, reducing (e.g., minimizing) the volume fraction of electrolyte in the cells (while keeping the rate performance and stability sufficiently good for specific applications) may be advantageous for increasing (e.g., maximizing) volumetric capacity of the cells and cell-level energy density and specific energy values. Aspects of the present disclosure overcome this challenge to facilitate production of stable cells with sufficiently high rate performance and energy density with electrolyte occupying relatively small or moderate fraction of the total cell volume (e.g., from around 10.0 vol. % to around 40.0 vol. %; in some designs from around 20 vol. % to around 35 vol. %).

The performance of cells comprising conversion-type fluoride cathodes often becomes particularly poor for certain applications when the cell size or cell capacity becomes medium (e.g., from around 10 mAh to around 200 mAh in terms of the total cell capacity), large (e.g., from around 200 mAh to around 10,000 mAh), or extra-large (e.g., above around 10,000 mAh). Such cells, however, may be particularly useful in certain applications (e.g., in electronic devices or in transportation, etc.). Aspects of the present disclosure allow one to overcome this challenge to facilitate production of stable cells (comprising conversion-type fluoride cathodes) of medium size (e.g., from around 10 mAh to around 200 mAh), large size (e.g., from around 200 mAh to around 10,000 mAh), or extra-large size (e.g., above around 10,000 mAh).

Liquid electrolytes (with or without organic solvent molecules, including ionic liquid or molten salt electrolytes), solid electrolytes (including solid polymer electrolytes and solid ceramic or glass electrolytes), gel electrolytes, composite electrolytes (including liquid-solid composite electrolytes, polymer-polymer and polymer-ceramic composite electrolytes) and mixed electrolytes may be effectively used for the designs herein. Note that in some designs, it may be advantageous to use more than one electrolyte in a single cell (e.g., to optimize performance of the anode and cathode separately or to achieve performance that is difficult to attain when using a single electrolyte). Furthermore, in some designs, it may be advantageous for more than one electrolyte to exhibit more than one form (e.g., one being liquid and another (or others) being solid or one being one type of solid (e.g., polymer gel or ceramic or glass) and another (or others) being another type of solid (e.g., a polymer), etc.).

In some designs, it may further be advantageous for such cathodes (or cathode particles) to additionally comprise a mechanically, thermally and electrochemically stable (during cell operation at typical cell operation conditions) so-called “scaffolding” or “matrix” material(s), thus forming LiF-comprising and metal-comprising (and/or metal fluoride-comprising) composites. As used herein, a primary function of such a stable “scaffolding” or “matrix” material is to enhance electrical, ionic, chemical, electrochemical, morphological (dimensional) and/or mechanical stability of the metal fluoride-based cathodes during cell operation. Such a matrix material may also help in preventing or reducing side reactions, such as metal dissolution, during cycling or help in preventing or reducing other undesirable interactions between the metal fluorides (or metals) and electrolyte during cell manufacturing or cell cycling. In some designs, such a matrix material (or combination of two or more distinct matrix materials) may exhibit significantly smaller capacity or energy density (in full cells) or alternatively not even contribute to capacity storage in cathodes at all, but importantly may help to significantly reduce volume changes at the composite particle level during battery change and discharge. At least some portion of such matrix materials may also be advantageously electrically conductive (e.g., exhibit electrical conductivity in the range from around 0.001 S/m to around 60,000,000 S/m at the cell operating temperatures).

In some designs, it may further be advantageous for such a matrix material (or at least a component of the matrix material and/or an associated active material embedded inside the matrix material, any combination of which may be broader referred to herein as a core component or a core material) to exhibit relatively high Li⁺ conductivity (e.g., from around 10⁻⁸ S cm⁻¹ to around 10⁻³ S cm⁻¹) at cell operational temperature (e.g., at around a room temperature, in some designs). In some designs, the matrix material may be highly nanostructured and may advantageously exhibit noticeably higher (e.g., by around 10-1000 times or more) surface (or interface) mobility of Li⁺ compared to the mobility of Li⁺ in the bulk.

In some designs, the core material (or a meaningful (e.g., about 1 vol. % or above) portion of the core material composition) may exhibit mixed cationic and anionic conductivity. In some designs, the conductivity of F-anions in such a core material may range from around 0.0000001% to around 500% of the Li⁺ ion conductivity in the same core material (in some designs, from around 0.1% to around 500%). In some designs, the core material may comprise LaF₃, BiF₃, MgNiF4, Ba_{1-y}SbyF_{2+y}, La_{1-y}BayF_{3-y} and/or other known F-anion conductors. In some designs, the total volume fraction of such conductors may range from around 0.1 vol. % to around 30 vol. % (in some designs, from around 0.1-10 vol. %) of the total volume of the composite cathode particles. Note that in some designs, F-anion conductors that exhibit relatively high reversible capacity (e.g., around 100-300 mAh/g) may be considered to be a part of the active material rather than a part of the matrix material (e.g., either of which may be broadly referred to as a core component or a core material). In some designs, the wt. fraction of either Bi or Ba or La or Sb or their combination in the cathode may exceed around 0.1 wt. % (as the portion of the total weight of the cathode layer on the current collector). In some designs, at least one core component (e.g., the matrix material, an active material embedded in the matrix material, etc.) ionically conducts both Li⁺ cations and F-anions. In a further example, the at least one core component (e.g., the matrix material, an active material embedded in the matrix material, etc.) may exhibit F-conductivity in the range from around 0.1% to around 500% of Li⁺ conductivity in the ionically conducting material.

In some designs, it may be advantageous for such fluoride-based cathodes (or cathode particles) to exhibit a core-shell morphology, where the shell essentially encloses all or the majority of the particle core. In some designs, the core of such particles may comprise a composite (e.g., comprising LiF, metal clusters and matrix material). In some designs, it may be advantageous for the shell in such particles to exhibit significantly lower (e.g., around 10-1000,000,000 times lower) F anion conductivity compared to the core of such particles. In some designs, the shell may comprise metal oxides. In some designs, the shell may exhibit a gradient in composition or be composed of two or more distinct layers. In some designs, the shell may exhibit significantly lower (e.g., around 50-50,000,000,000 times lower) Cu²⁺ or Fe²⁺ conductivity compared to that of Li⁺.

In some designs, it may be advantageous (e.g., for enhanced stability) for the fluoride-comprising (e.g., conversion-type) cathodes (in particular, composite cathodes that comprise matrix materials in addition to active materials) to comprise one or more ionically conductive polymers with Li ion conductivity in the range from about 10⁻⁸ S/m to about 10 S/m (that is about 10⁻¹⁰ to about 0.1 S/cm in “S/cm” units). In some designs, it may be advantageous for the ionically conductive polymers to cover from around 5.0% to around 100.0% of the exterior surface area of the composite particles in the cathodes. In some designs, smaller than about 5% contact area may lead to undesirably low rate performance or undesirably low stability or overall reduced benefits of using ionically conductive polymers. In some designs, it may be advantageous for the ionically conductive polymers in the cathodes to constitute from around 2.0 vol. % to around 35 vol. % of the cathode volume. In some designs, smaller than around 2 vol. % volume fractions of the ionically conductive polymers may not provide enough improvements, while larger than around 35 vol. % fraction may undesirably reduce volumetric cathode capacity and cell-level energy density and specific energy.

In some designs, one or more ionically conductive polymers may be incorporated into different parts of the metal fluoride-based cathodes, such as within the fluoride-containing composite particles, around the fluoride-containing composite particles, between the composite fluoride-containing particles, on the surface of the electrode, and/or within the separator membrane layer, among others.

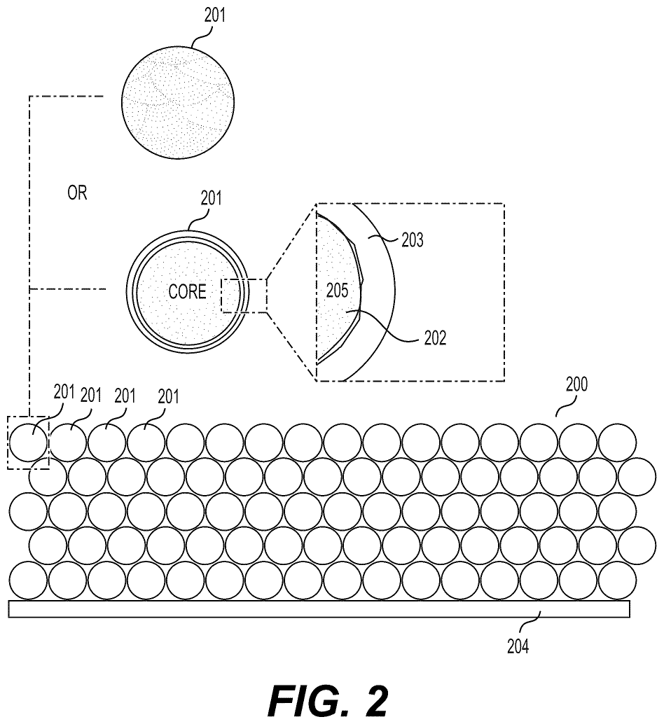

FIG. 2 schematically illustrates some examples of the incorporation of one or more cation dopants into a metal fluoride-based composite cathode 200 in accordance with aspects of the present disclosure. In FIG. 2, composite particles 201 (i.e., metal fluoride-based composite cathode particles) are shown as spheres densely packed on a current collector 204, for illustrative purposes. Conductive additives and binder(s) are not shown for simplicity. FIG. 2 depicts a cross-section of the metal fluoride-based composite cathode 200 so that some of the morphological features (e.g., core-shell structures, etc.) may be distinguished. FIG. 2 schematically illustrates example designs, where the one or more cation dopants 202 are incorporated into the bulk of the composite particles 201. In some designs, the one or more cation dopants 202 may be incorporated into the bulk of the composite particles 201 uniformly, while in other designs there may be some gradient in the dopant distribution within the composite particles 201. In some designs, incorporation of the one or more cation dopants 202 in the bulk of the composite particles 201 may be accomplished with simultaneous incorporation of a cation dopant in shells 203 and in cores 205 of the composite particles 201 (in case of core-shell particle designs).

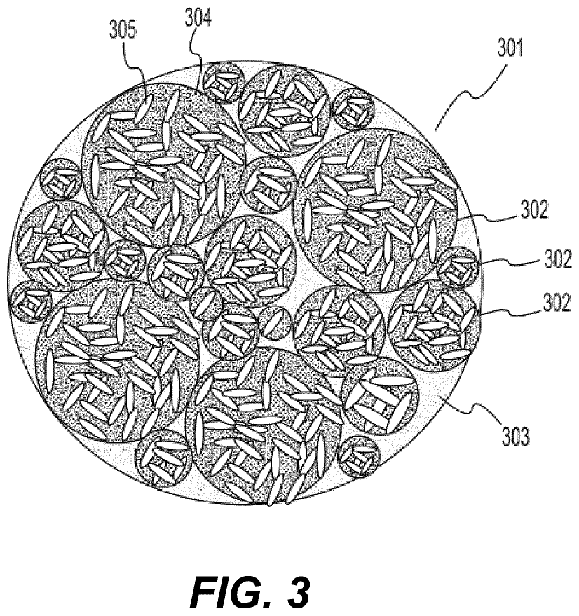

FIG. 3 illustrates an example of a suitable architecture for an LiF-M (or, more broadly, LiF-M-MFx-LiMFx) (where M is a metal or doped metal alloy) nanocomposite particle 301, whereby the LiF-M nanocomposite particle 301 comprises LiF-M (or LiF-M-MFx or MFx or LiF-M-LiMFx or LiMFx) composite nanoparticles 302 surrounded by a conductive skeleton (scaffolding) matrix material 303, wherein one or more (e.g., each) of the composite nanoparticles 302, in turn, comprises LiF 304 and doped metal material 305. In some designs, the composite nanoparticles 302 may exhibit average dimensions in the range from around 1 nm to around 200 nm (in some designs, from around 2 nm to around 20 nm). In some designs, the metal material 302 may be in the form of one or more nanoparticles of various shapes (in some designs in the form of interconnected nanoparticles) with average linear dimensions in the range from around 0.5 nm to around 40 nm (in some designs, from around 1 nm to around 10 nm). The composite nanoparticles 302 may be electrically connected with other composite nanoparticles 302 via the conductive skeleton matrix material 303. In some designs, the composite nanoparticles 302 may be at least partially interconnected with other neighboring composite nanoparticles 302. In other designs, a majority (e.g., about 50% or more) of the composite nanoparticles 302 are physically separated (e.g., by around 0.3 nm to around 10 nm) from their respective nearest neighboring composite nanoparticles 302.

In some designs, several material compositions may be suitable for use in a skeleton (scaffolding) matrix of the type described herein, including but not limited to: metals and semimetals, polymers (including polymers that are electrically conductive within the cathode operational potential range), metal organic frameworks (MOFs), oxides, carbides (including ternary and other mixed carbides), oxy-carbides (including partially fluorinated ones), oxy-fluorides, various intercalation-type cathode materials, metal sulfides, metal oxy-sulfides, metal nitrides, metal oxy-nitrides, conductive carbons (including partially or fully fluorinated ones, such as carbon fluorides; in some designs with high content (e.g., about 50-100%) of sp²-bonded carbon), carbon oxy-fluorides, their various mixtures and combinations and others. In some designs, it may be advantageous for the skeleton matrix material to be in the form of individual, monolithic (single-bodied) particles. In some designs, the skeleton (scaffolding) matrix material may comprise from about 0.05 at. % to about 50 at. % fluorine (F) (e.g., about 0.05-5 at. % F). In some designs, the skeleton (scaffolding) matrix material may comprise from about 0.009 at. % to about 99.99 at. % carbon (C). In some designs, a scaffolding matrix may comprise curved (e.g., defective) graphene segments with a radius of curvature in a range of about 0.5 nm to about 500 nm. In some designs, curved (e.g., defective) graphene segments may comprise oxygen-containing and/or fluorine-containing functional groups. In some designs, it may be further advantageous (e.g., for maximizing energy density of the cathodes) for the volume fraction of the skeleton (scaffolding) matrix material in the individual “skeleton matrix material-lithium fluoride-metal composite” particles not to exceed about 35-40 vol. %, more preferably not to exceed about 25-30 vol. %, and even more preferably not to exceed about 10-20 vol. %. However, when its volume fraction becomes too small (e.g., smaller than about 1-5 vol. %) the functionality of the skeleton (scaffolding) matrix material may be undesirably reduced. In some designs, it may be further advantageous for the skeleton matrix material particles to exhibit characteristic dimensions in the range of about 20 nm to about 20 μm. In some designs, larger particles are easier to handle during the slurry preparation, but too large particles (e.g., the size of which depends on the cell chemistry and operating conditions, but in some designs may be about 10-50 μm) may reduce rate performance below the minimum (for a given application) value. In some designs, if porous skeleton (scaffolding) matrix particles are used, the characteristic dimensions of the majority (e.g., above about 70 vol. %) of the skeleton (scaffolding) matrix material pores (which may be completely or partially filled with active materials, such as a mixture of LiF and metals, metal fluorides, etc.) may preferably be in the range of about 1 nm to about 100 nm. In some designs, if porous skeleton (scaffolding) matrix particles are used (e.g., for filling such pores with active material), the volume of pores within such particles may preferably be in the range of about 60 vol. % to about 95 vol. %. In some designs, at least some of the pores within the skeleton (scaffolding) matrix material may be produced using sacrificial template materials (e.g., a sacrificial polymer, sacrificial metal, or sacrificial salt particles). In some designs, the pores within the skeleton matrix material may be straight or curved and may be of various shapes (e.g., mostly slit shape, cylindrical shape, spherical shape, or have some other shape, including irregularly-shaped curved pores). In some designs, if the pores are elongated or slit-shaped, the orientation of such pores may in some designs depend on the skeleton particle preparation and may vary within a single particle. For example, in the center of the particles the pores may be oriented randomly or along the radius, while closer to the surface the pores may be oriented parallel to the surface of the particles. In this case, the porous skeleton (scaffolding) matrix material particles may achieve superior mechanical properties and, in some cases, may simplify formation of the protective coatings or shells, which may serve to stabilize the metal or metal fluorides against irreversible changes and undesirable interactions with electrolyte. In some designs, porous skeleton (scaffolding) matrix material particles may have smaller pores closer to the particle surface. In this case, the porous skeleton matrix material particles may achieve superior mechanical properties and, in some cases, may simplify formation of the protective coatings or shells. In some designs, porous skeleton (scaffolding) matrix material particles may exhibit a smaller pore volume closer to the particle surface. In this case, the porous skeleton matrix material particles may achieve superior mechanical properties and, in some cases, may simplify formation of the protective coatings or shells. In some designs, when metal fluorides infiltrated in the pores of the porous skeleton matrix material undergo chemical lithiation, the skeleton matrix material may become irreversibly (e.g., inelastically or plastically) deformed without substantial changes in the mechanical integrity of the composite particles. In some designs (e.g., when either metal fluorides or a mixture of metal and LiF are infiltrated in the pores of the porous skeleton matrix material), the volume changes upon repeated electrochemical cycling of such composites may be accommodated mostly by reversible elastic deformations (e.g., by over about 50% elastic deformation after cycle 5 and by over about 90% elastic deformation after cycle 50); in this case high stability of cells may be achieved.

In some designs, skeleton matrix material particles may comprise one or more conductive additives (e.g., carbon black particles, carbon nanotubes, graphene, exfoliated graphite, carbon fibers, metal particles, metal carbide particles, metal nitride particles, etc.) strongly (e.g., chemically) bonded to its outer surface in order to enhance stability of the electrode during electrochemical cycling.

As discussed above, in one example, porous carbon may serve as an electrically conductive skeleton matrix material. In some designs, porous carbons having most of the pore walls being a monolayer-thick may work particularly well, providing both high pore volume and sufficiently high conductivity, while reducing or minimizing the volume that “inactive” carbon atoms occupy. In some designs, porous carbons with experimentally measured Brunauer, Emmett and Teller (BET) specific surface area (before shell deposition) above about 50 m²/g (more preferably above about 500 m²/g, even more preferably above about 1500 m²/g) may work well as a skeleton matrix material. Examples of suitable porous carbon may include, but are not limited to carbide-derived carbon and other types of carbons produced from inorganic precursors, various templated carbons, polymer-derived carbons (e.g., carbons produced by polymer carbonization, including carbonization of naturally produced polymers), hydrochars (hydrothermally produced carbons), exfoliated graphites, exfoliated disordered carbons, activated carbon, among others. In some designs, carbon used as part of the electrically conductive skeleton matrix material may be produced by pyrolysis of carbon-containing organic precursors. In some designs, pores in carbon or carbon precursors may be enhanced by using chemical or physical activation (e.g., partial oxidation of the resulting carbon to enhance its pore volume and specific surface area).

In some designs, metal clusters, metal nanoparticles, or porous metal particles used as part of the electrically conductive skeleton matrix material may be produced by vapor deposition routes, such as chemical vapor deposition (CVD) or atomic layer deposition (ALD) processes or, in some cases (for example, when a high metal vapor pressure may be achieved and utilized) by condensation of metal vapors. In some designs, the metal (or metal alloy) clusters or nanoparticles may be produced from various metal precursors (e.g., metal-organic compounds or metal salts), which are decomposed (e.g., upon heating) or reduced.

In some designs, when the skeleton (scaffolding) matrix material is utilized for cathode composite construction, the metal clusters/nanoparticles may be infiltrated into the pores of the skeleton matrix material or deposited onto the surface of the skeleton matrix material (such as skeleton matrix material particles). In some designs, the infiltration temperature may be sufficiently low to prevent excessive growth of metal particles (e.g., their minimum characteristic dimensions may preferably stay within about 50 nm, or more preferably within about 10 nm). In some designs, the metal clusters or metal nanoparticles in the electrically conductive skeleton matrix material may be interconnected. In some designs, these interconnected metal nanoparticles in the electrically conductive skeleton matrix material may be in the form of a metal foam or a porous metal powder.

In some designs, the LiF clusters, LiF layers, LiF nanoparticles, or LiF porous particles in the electrically conductive skeleton matrix material may be produced or deposited (e.g., on to the surface of the matrix material or matrix material precursor) by using various vapor deposition routes, such as CVD or ALD processes. In some designs, LiF in the electrically conductive skeleton matrix material may be deposited from the solution either in the course of a chemical reaction or by solvent evaporation from the LiF solution. In some designs, LiF in the electrically conductive skeleton matrix material may be produced by lithiation of another fluoride. In some designs, LiF in the electrically conductive skeleton matrix material may be produced by fluorination of another Li salt or Li oxide. In some designs, when a skeleton matrix material is utilized for the cathode composite construction, LiF may be infiltrated into the pores or deposited onto the surface of the skeleton matrix material before or after the metal infiltration. In some designs, when a porous metal is used as the electrically conductive skeleton matrix material, LiF may be infiltrated into a porous metal powder to form intermixed LiF-M nanocomposite(s).

In some designs, it may be advantageous to deposit or infiltrate LiF onto and/or into a cathode composite composition during one or more of the synthesis stages. For example, LiF may be used as an active (Li storing, when used in combination with the metal nanoparticles) material or may be used as inactive material serving for another purpose (e.g., protect the metal nanoparticles from undesirable interactions with electrolyte or ambient environment during the cathode fabrication or battery assembling or cycling, etc.) or both. In some designs, LiF may be deposited into the composite already comprising metal nanoparticles or metal oxide nanoparticles. In some designs, metal oxide nanoparticles may be at least partially reduced to metal nanoparticles after LiF deposition (since LiF material may be harder to reduce), thus forming a matrix-M-LiF composite. In some designs, metal nanoparticles may be deposited into the composite already comprising LiF. In some designs, LiF may be produced from another precursor (e.g., Li₂O) by using a fluorination reaction (in some designs, at or near room temperatures). In some designs, LiF may be deposited/infiltrated onto the matrix material (with or without metal or metal oxide particles) in a gaseous phase (e.g., by a CVD or ALD process). In some designs, NF₃ may be advantageously utilized as a precursor for F in a LiF composition (e.g., for the CVD or ALD of LiF). NF₃ may also be effectively used for various other fluorination reactions. Illustrative examples of other suitable F sources for LiF formation or various fluorination reactions may include, but are not limited to, F₂, HF, SiF₄, SF₆, CF₄, CFₓH₍₄₋ₓ₎ (x=1-4), tetrafluoroethylene, other fluoroethylenes (C₂FₓH₍₄₋ₓ₎ where x=1-4), fluoroethanes (C₂FₓH₍₆₋ₓ₎ where x=1-6), or other gaseous fluorocarbons. In some designs, various Li precursors may be effectively utilized for LiF deposition (and, more generally, for the lithiation reactions). In some designs, for example, such lithium precursors may contain Li—O bonds (for examples, as in (2,2,6,6-Tetramethyl-3,5-heptanedionato) lithium (Li(TMHD)) or lithium acetylacetonate (Li(acac)) or others). In other designs, for example, such lithium precursors may contain Li—C bonds (for example, as in n-butyllithium (n-BuLi) or tert-butyllithium (t-BuLi), among others).

In some designs, it may be advantageous to deposit or infiltrate metal (M) or metal oxide (MOₓ) onto and/or into the cathode composite composition during one or more of the synthesis stages. Suitable techniques for metal or metal oxide deposition include, but are not limited to, various vapor deposition techniques (e.g., ALD, CVD, etc.), electrodeposition, electroless deposition, solution-based infiltration of the metal or metal precursor salts, followed by their conversion to metal or metal oxide during subsequent thermal treatment or chemical reaction, among others.

In some designs, metal fluoride-matrix (nano) composite particles may be produced by conversion (including chemical transformation reaction) (e.g., by heat-treatment under controlled environment) or, more generally, a chemical reaction (e.g., in a gaseous or liquid phase), of the (nano) composite precursor particles that comprise both the precursor for the final matrix material (e.g., organic or metal organic or inorganic material precursor) and the precursor for the final active fluoride material (e.g., metal salt or metal oxide precursor).

In some designs, the above discussed precursor (nano) composite particles may be produced by co-precipitation from a solution (or, more generally, a liquid phase), co-precipitation/nucleation from a gas phase, spray-drying from a solution, spray-drying from a melt, electro-spraying, milling or mixing of the components, and various other suitable means. In some designs, one or more hydrothermal or solvothermal reactions may be used in at least one of the stages of the (nano) composite synthesis of the metal fluoride-matrix (nano) composite particles. In some designs, mechanical milling may be used in at least one of the stages of the (nano) composite synthesis of the metal fluoride-matrix (nano) composite particles. In some designs, the (nano) composite precursor particles may comprise a final or near-final composition of the active metal fluoride material and the precursor for the matrix material or a final or near-final composition of the matrix material and the precursor for the active metal fluoride material.

In some designs, a {skeleton (scaffolding) matrix-M-LiF} or {skeleton (scaffolding) matrix-M-LiF-MFx} or {skeleton (scaffolding) matrix-M-LiF-LiMFx} composite (that is the composite comprising three or more of: matrix, metal M, lithium fluoride LiF, metal fluoride MFx, lithium metal fluoride LiMFx) is doped with cationic materials, which is selected from Mo, W, Zr, Nb, Ti, Zn, Cr, Ni, Co, Bi, Pb, Sb, Sn, Cd, Mo, Hf, Ta, Si, La, Ce or combinations thereof. In certain examples, the M is Fe, Ni, Co, Cu and Bi or their alloys. According to certain embodiments, the resulting cation doped composite materials demonstrated to significantly increase energy density, power density, energy efficiency, and cycle life, while reducing various resistance contributions. This improvement may be attributed to the beneficial alterations that doping may introduce to the electronic conductivity of the cathode material or ionic conductivity of the cathode material or the reducing of energy barrier for favorable atomic re-arrangements or reducing degree of unfavorable reactions, to name a few. For example, by effectively decreasing the bandgap of the cathode material through cationic dopants, the movement of electrons within the material becomes more efficient, thereby facilitating an improved charge and discharge process. Furthermore, when dopant atoms with distinctly different diameters from those of the main metal (e.g., Fe) atoms are introduced, they induce a deliberate distortion in the crystal lattice to enhance ionic conductivity within the composite material.

Some of the key benefits of doping the {matrix-M-LiF} or, more broadly {skeleton (scaffolding) matrix-M-LiF-MFx-LiMFx} composite may include but are not limited to improved electrochemical performance, such as enhanced capacity, voltage, and/or overall energy density. Further, doping may enhance the rate capacity by improving charge and discharge kinetics. Also, extended cycle life could be observed with doping that can mitigate degradation mechanisms by stabilizing crystal structures. Previously reported cation dopants for FeF₃ cathode materials are Co, Ti, Cr, Mn, Ni, Nb, and Co/Ni. Depending on the dopant elements, the electrochemical performance and structural stability of cathode materials have been improved with a varying degree of success. However, all prior cation dopant strategies do not leverage sealing of the matrix-M-F composite materials that can lead to strong synergistic effects.

In some designs, the introduction of cationic dopants into the {matrix-M-F} or {matrix-M-LiF} or, more broadly {matrix-M-LiF-MFx-LiMFx} composite may be initiated during the synthesis of the {matrix-M} or {matrix-metal oxide} materials. Alternatively, in other designs, the dopant precursor may be introduced subsequent after the synthesis of the matrix-M intermediate. Following this dopant introduction step, the resultant composite materials may undergo a fluorination process, resulting in the production of the matrix-doped-MFx material in its unsealed form. Among the preferable cationic dopants are transition metals, including one, two, three or more of the following: Mo, W, Zr, Nb, Ti, Zn, Cr, Ni, Co, Bi, Pb, Sb, Sn, Cd, Mo, Hf, Ta, Si, La, or Ce, wherein the dopant concentration ranges from about 0.05% to about 30 at. % (in some designs, between about 0.1-10.0 at. %; in some other designs, between about 0.1 to about 30 at. %) as a fraction of all metals within the composite materials.

In specific embodiments, the cationic dopant precursor (e.g., a precursor for Co-comprising or Cr-comprising or Mn-comprising or Nb-comprising or Ni-comprising or Zn-comprising or Zr-comprising or Ti-comprising or other metal comprising dopants) may comprise one or more of the following substances or their derivatives: Co(acac)₂ Co(acac)₃ Co(thd)₃, Co(i-Pr₂-amd)₂, Co(tBuEt-amd)₂, Cr(Et₂-amd)₃, Cr(acac)₃, Cr(Et₂-amd)₃, Mn(thd)₃, Mn(i-Pr₂-pemd)₂, Mn(tBu₂-amd)₂, Nb(OEt)₅, NbCl₅, Ni(dmamp)₂, Ni(acac)₂, Ni(thd)₂, Ni(tBu₂-amd)₂, Zn[N(SiMe₃)_{2]2}, Ti(OMe)₄, Ti(OEt)₄, Ti(OiPr)₄, Ti(NMe₂)₄, Ti(NEtMe)₄, Ti(i-Pr₂-amd)₃, Zn(i-Pr₂-amd)₂, ZrCl₄, Zr(acac)₄, Zr(EtMeN)₄, Zr(Me₂N)₄, Zr(NEt₂)₄, Zr(i-PrO)₄, ZrF₄, Zr(i-PrO)₂ (dmae)₂, ZrCp₂Me₂, Zr(CpMe)₂Me₂, ZrCp₂Cl₂, ZrCp (NMe₂)₃, Zr(CpMe) (NMe₂)₃, Zr(CpMe) CHT, Zr(MesCp)(TEA), Zr(EtMeN)₂(guanNEtMe)₂, Zr(Me₂-fmd)₄, Zr(Me₂-pmd)₄, Zr(Me₂-bmd)₄ or combinations thereof. Note that acac=acetylacetonate; amd=acetamidinate; bmd=butyramidinate; Cp=cyclopentadienyl; dmae=dimethylaminoethoxy; dmamp=1-dimethylamino-2-methyl-2-propanolate; fmd=formamidinate; guan=guanidinate; pemd=pentylamidinate; pmd=propionamidiate; and thd=2,2,6,6-tetramethyl-heptane-3,5-dionate. These precursor materials may encompass metal salts or metal-organic complexes, each serving as a potential source for introducing cationic dopants into the matrix-M-LiF structure.

In some designs, the skeleton (scaffolding) matrix material formed in the presence of metal and dopant precursors to make the matrix-M composite materials (M is metal or doped metal alloy). In some designs, carbonization may also chemically reduce metal salt nanoparticles to metal nanoparticles. In some designs, heat-treatment in a controlled environment (e.g., in some designs containing oxygen in some temperature range) may convert metal salt nanoparticles to metal oxide nanoparticles. In some designs, the metal in the metal/carbon composite may also oxidize upon exposure to an oxygen-containing environment (e.g., air or oxygen or water-containing gas). Note that almost any polymer may fundamentally be used to synthesize the carbon matrix material via the carbonization approach. However, in some designs, preferred polymers to make the matrix may contain unsaturated bonds and heteroatoms that are thermally susceptible to react and produce a carbon. Some polymers have a propensity to decompose into gaseous byproducts, while other polymers decompose into carbon. For instance, polyolefins, such as polyethylene (PE), mostly decompose into gaseous compounds as polyolefins lack reaction pathways to crosslink and form aromatic rings. In some designs, preferred polymers may include polyacrylonitrile (PAN), polyvinylpyrrolidone (PVP). Other polymers that may be used to make the skeleton (scaffolding) matrix include, but are not limited to: phenolic resins, polyacetylene (PAC), polyimides (PI), polyurethane (PU), polyfurfuryl alcohol (PFA), polybenzoxazine (PBz), cellulose, poly(p-phenylene-2,6-benzobisoxazole) (PBO), polyvinyl alcohol (PVA), polythiophene (PTs), polypyrrole (PPy), polybenzimidazole (PBI), polyphenylene sulfide (PPS), poly(vinylidene fluoride) (PVDF), poly(ether ether ketone) (PEEK), and polyesters (PES).

The carbonization process is highly dependent on many factors, including pyrolysis temperature, time, and the specific polymer's structure. These factors may greatly influence the resulting properties of the carbon matrix. The polymer and metal salt mixtures may be pyrolyzed together to make cation doped metal carbon composite (or nanocomposite) materials (matrix-M). The resulting carbon skeleton encapsulates the cation doped metal, after which a fluorinating agent (e.g., NF₃) may be utilized as a precursor to fluorinate the matrix-M composite materials (e.g., for the CVD or ALD of LiF), and then lithiated (in some designs, first lithiated and then fluorinated) to produce a doped metal-LiF-carbon nanocomposite. NF₃ may also be effectively used for various other fluorination reactions. Illustrative examples of other suitable F sources for fluorination reactions may include, but are not limited to: F₂, HF, SiF₄, SF₆, CF₄, CFₓH₍₄₋ₓ₎ (x=1-4), tetrafluoroethylene, other fluoroethylenes (C₂FₓH₍₄₋ₓ₎ where x=1-4), fluoroethanes (C₂FₓH₍₆₋ₓ₎ where x=1-6), or other gaseous fluorocarbons. In some designs, (nano) composite particles may be enclosed in a Li-ion permeable (at room temperature) but substantially H₂O or O₂ or electrolyte impermeable (at room temperature) air-tight shell at one or more stages of particle synthesis. In some designs, such shells may be deposited before and in some designs after the lithiation. In some designs, such shells may be deposited before and in some designs after the fluorination.

In one illustrative example, a matrix material precursor may be a polymer solution and metal fluoride precursor (e.g., a metal salt or a metal-organic compound that is soluble in the same solvent as the polymer). Illustrative examples of some of the suitable solvents include, but are not limited to: water, ethanol, methanol, dimethylformamide (DMF), NMP, among many others, and mixtures thereof. In some designs, the polymer-precursor solution may be spray-dried to produce (nano) composite particles comprising the nano-sized (e.g., from around 1 nm to around 100 nm) structures of the precursor (e.g., metal salt or metal-organic compound) and the polymer. If needed, such particles may be milled to produce finer particles (e.g., D50 below about 10-50 μm in size; D90 below about 20-60 μm in size; D99 below about 30-70 μm in size). In some process designs, bonds may form between the precursor (e.g., metal salt or metal-organic compound) and the polymer or the precursor (e.g., metal salt or metal-organic compound) may promote cross-linking of the particles. In an example, the heat-treatment during or after the spray drying may cause cross-linking of the polymer. If needed, particles may be milled to produce finer particles after the additional heat-treatment (e.g., D50 below about 10-50 μm in size; D90 below about 20-60 μm in size; D99 below about 30-70 μm in size). In some designs, the polymer may be carbonized at a temperature lower than a polymer melting point or precursor (e.g., metal salt or metal-organic compound) melting point. If needed, particles may be milled to produce finer particles after the carbonization (e.g., D50 below about 10-50 μm in size; D90 below about 20-60 μm in size; D99 below about 30-70 μm in size). In some designs, (nano) composite particles may be enclosed in a Li-ion permeable (at room temperature) but substantially H₂O or O₂ or electrolyte impermeable (at room temperature) air-tight shell at one or more stages of particle synthesis. In some designs, such shells may be deposited before and in some designs after the lithiation. In some designs, such shells may be deposited before and in some designs after the fluorination.

In some applications, direct contact between active material (e.g., of the conversion-type metal fluoride-based cathodes) and liquid electrolyte may induce dissolution of active materials. In some cases, such direct contact may also lead to undesirable and excessive liquid electrolyte decomposition within the potential window of cathode operation. For example, when Cu metal is exposed to electrolyte, the Cu metal may oxidize and dissolve as Cu¹⁺ and Cu²⁺ species at around 3.56V versus Li/Li⁺ and around 3.38V vs. Li/Li⁺, respectively (e.g., based on the standard oxidation potentials with 1M Cu⁺ or Cu²⁺ in solution). Unfortunately, these Cu oxidation potentials are very close to the redox potential for the conversion reaction of LiF and Cu metal to CuF₂ of around 3.55V vs. Li/Li⁺. Thus, the formation of Cu⁺ and Cu²⁺ may occur alongside the desired redox reaction, unless one or more precautions are taken to prevent Cu metal dissolution. Besides causing the loss of Cu in the electrode, the formation of Cu⁺ and Cu²⁺ in solution may also encourage the dissolution of LiF through the formation of [Cu(I)F₄]³⁻ or [Cu(II)F₆]⁴⁻ species and also damage the SEI on the anode. Other metal fluoride (MFₓ)-comprising particles may similarly suffer from such limitations.

Furthermore, in some applications, many solid electrolytes (e.g., many solid ceramic or glass or glass-ceramic electrolytes or some polymer electrolytes or various mixed electrolytes) as well as many hybrid electrolytes may unfavorably react (e.g., chemically or electrochemically) with fluoride-based conversion-type cathodes in some state of cathode charge or discharge (in some examples, nano-sized metal particles produced upon discharge of metal fluorides may be particularly reactive in contact with OH or S or Se or Cl or Br or Te-comprising electrolytes). One or more aspects of the present disclosure overcome one or more of these and/or other limitations via formation of suitable microstructure and composition of the composite electrode particles comprising conversion-type active materials and/or suitable electrode designs and compositions, among others. In some designs, in order to reduce or prevent metal dissolution and/or various other undesirable interactions between metal fluoride-containing active material and various electrolytes, formation of composite (e.g., matrix-comprising) materials including those that comprise suitable protective Li⁺ permeable shells (e.g., comprising an oxide or nitride or oxynitride or phosphate or an oxyfluoride of one or more metals, such as Al, Mg, Li, Nb, Co, Fe, Mn, Ni, W, Zn, Zr, among other suitable materials) around the metal fluoride electrode or around the individual particles comprising metal fluoride material may be effectively used. In some designs, a primary function of the “protective” shell may be to effectively seal active material and reduce, avoid or minimize the direct interaction(s) between the active material (e.g., at least, the conversion-type active material) and the electrolyte during electrochemical (battery) cycling. In addition, in some designs, such shells may advantageously protect active material from unfavorable interactions with air or moisture during electrode or cell preparation. As such, low permeability of the shelling material by water (H₂O) or oxygen (O₂) may be highly advantageous, in some designs. While in some designs the shelling material may be primarily located near the perimeter of the composite particles (within the outer surface layer), in other designs it may be distributed within the bulk (or core) of the composite particles in order to enhance “robustness” of the composite against undesirable fractures during mixing, casting, calendaring and use. In some designs, the same or different shelling materials may form an outer surface layer while also being distributed at least in part within the bulk (or core) of the composite particles. In some designs, it may be advantageous for the shelling material to form a gradient with higher volume fraction of the shelling material closer to the external surface of the composite particles and smaller volume fraction of the shelling material near the center of the composite particles.

In some designs, such “protective” Li-ion permeable shells may serve multiple purposes. For example, the Li-ion permeable shells may enhance wetting of the electrolyte on an external surface of active material-comprising composite particles. In another example, the Li-ion permeable shells may reduce or prevent migration of active material from the composite during synthesis or post-synthesis treatment or cell operation. In yet another example, the Li-ion permeable shells may enhance electrical conductivity of the electrode particles.

In some designs (e.g., when solid electrolyte is used), the Li-ion permeable shells may also serve to reduce interfacial stresses at the electrode/electrolyte interphase. In such and other designs, it may be advantageous (e.g., for improved stability or rate performance) for the shell to comprise pores. In some designs, at least a portion of such pores may be closed (internal). In some designs, at least a portion of such pores may be interconnected (open). In some designs, the size of such pores may advantageously range from around 0.2 nm to around 20 nm.

Formation of properly functioning shells is often challenging, expensive, insufficiently reliable (e.g., for achieving stability during cycling or storage, particularly at a partially or fully discharged state when repeated cycling may cause shells to delaminate or crack) and potentially dangerous. For example, formation of various shells around CuF₂-comprising material (particularly at temperatures above around 60° C. in an HF-free or F-free environment) may result in undesirable reactions, such as conversion of CuF₂ into a Cu metal, HF vapors, F₂ gas, or various other fluorinated compounds (e.g., depending on the particular chemical synthesis route utilized for the shell deposition). The use of an HF- or F-gaseous environment may help to reduce or prevent CuF₂ decomposition or conversion reactions in some cases, but it may significantly increase the fabrication cost and potential hazard during this operation. Even once formed, the produced protective shells may become broken during cell operation if the expansion (e.g., induced by electrochemical lithiation of the electrodes) induces stresses sufficiently large to initiate cracks and fractures in the shell during the initial or the subsequent cycles (fatigue). Once broken, the shells may not provide the required stabilization against side reactions in some applications, particularly if cathodes are immersed into a liquid electrolyte in a battery cell. One or more aspects of the present disclosure relate to synthesis routes to overcome one or more of such challenges and deposit suitable coatings that may better withstand stresses during battery cycling. In some designs, for example, formation of shells onto (at least partially) lithiated cathodes or cathode particles may offer an advantage of enhanced thermal stability of such cathodes and also their expanded (in some designs, fully expanded) state.

The combination of using core-shell particle architecture and embedding cation doped metal fluoride materials in a suitable matrix material may be particularly effective in some designs. In some designs, this particle architecture may significantly reduce irreversible changes in the electrode during cycling (for example, by preventing irreversible growth of metal clusters) and reduce cell degradation and resistance growth. In some designs, this particle architecture may significantly reduce ionic and/or electrical resistance of the cathode particles.

In some designs, the shell in the core-shell particle architecture may advantageously comprise a gradient in composition (e.g., two, three or more distinct layers in terms of composition). In some designs, it may be advantageous to deposit at least a portion of the shell prior to particle assembling into electrodes (e.g., prior to casting a slurry onto a current collector). In some designs, it may be advantageous to deposit at least a portion of the shell after the particles' assembling into electrodes (that may comprise a conductive additive and a binder in addition to active particles). A deposition of such a shell may be done, for example, by ALD or other suitable deposition techniques.

In some designs (e.g., due to sensitivity of the fluoride cathode particles to some solvents (e.g., water) or other design considerations (e.g., not using toxic solvents), etc.), it may be advantageous to cast an electrode onto a current collector (e.g., metal foil, porous metal foil, metal mesh, etc.) in a dry state (without using a solvent in a slurry). Various suitable dry (solvent-free) film deposition techniques may be utilized, including but not limited to electro-spraying.

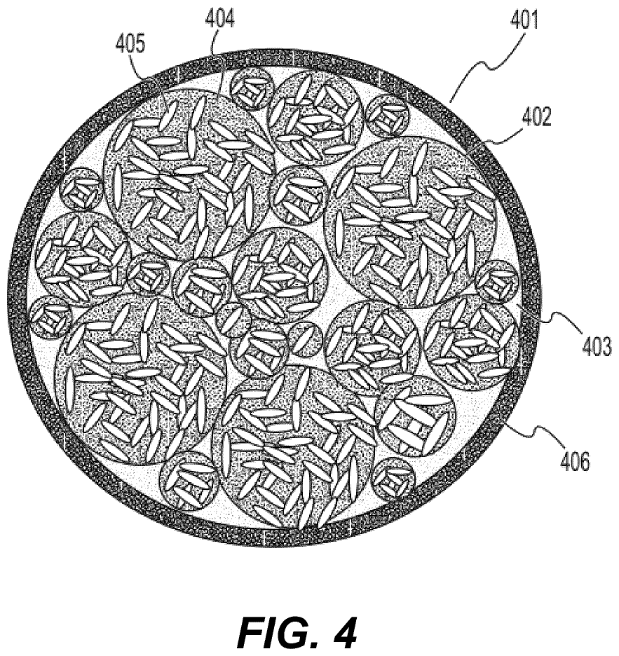

FIG. 4 illustrates an example of a LiF-M (where M is a metal or cation doped metal alloy) (or, more broadly, LiF-M-MFx-LiMFy) nanocomposite particle 401 in accordance with another aspect of the prevent disclosure. The LiF-M (or, more broadly, LiF-M-MFx-LiMFy) nanocomposite particle 401 is similar to the LiF-M (or, more broadly, LiF-M-MFx-LiMFy) nanocomposite particle 301 of FIG. 3, except that the LiF-M (or, more broadly, LiF-M-MFx-LiMFy) nanocomposite particle 401 of FIG. 4 is further coated with a functional shell 406. In an example, one function of the functional shell 406 may be to reduce or prevent undesirable reactions between the electrolyte and M or between the electrolyte and LiF (in other words, the functional shell 406 may be substantially impermeable to an electrolyte that contacts at least part of the functional shell 406). In an example, another function of the functional shell 406 may be to improve electrical conductivity (since LiF is electrically insulative). In an example, another function of the functional shell 406 may be to improve the properties of the active material/electrolyte interface (or interphase)—e.g., by reducing charge transfer resistance or stability, or providing other suitable and useful functions. In this illustrating example (similar to FIG. 3), the nanocomposite particle 401 comprises LiF-M composite nanoparticles 402 surrounded by a skeleton matrix material 403, wherein one or more (e.g., each) of the composite nanoparticles 402, in turn, comprises LiF 404 and a metal material 405. In an example, the nanocomposite particle 401 may be representative of one or more of the composite particles 201 described above with respect to FIG. 2.

In some designs, material composition of the shell (e.g., functional shell 406) may comprise a (nano) composite. In some designs, the shell material may advantageously comprise two or more distinct layers of different microstructures or compositions. In some designs, each layer may serve a different purpose (e.g., an outer layer may, for example, enhance electrolyte wetting or charge-transfer resistance or improve electrical contact between the individual particles or other useful functions, while an inner layer may, for example, prevent undesirable direct contact between the active metal fluoride composition and the outer layer or electrolyte or other useful functions). In some designs, the thickness of each individual layer of the (nano) composite shell material may range from around 0.2 nm to around 50 nm (in some designs, from around 0.3 nm to around 20 nm).

In some designs (e.g., when a shell material comprises a (nano) composite with two or more distinct components), at least some of the components of the shell material may form interpenetrative networks. In some designs, one component of the shell material may be arranged as a porous material with either open or closed pores or both, where at least some of such pores are filled with the other (e.g., second) component(s) of the (nano) composite. Such an interpenetrating design may be beneficial when the two or more components offer complementary properties (e.g., one component providing higher electrical conductivity and another component higher Li⁺ ion conductivity, or one component providing higher Li⁺ mobility and another component providing higher Li⁺ solubility at the cycling potentials, or component providing improved dispersion during slurry preparation and another component providing improved mechanical stability, or one component providing improved wetting by electrolyte and another component providing improved compatibility/interface with the core of the composite particles, etc.). In some designs, the interface between such interpenetrating materials may offer enhanced ionic mobility or other useful properties unavailable in each of the individual components. In some designs, the shell material may comprise active (Li storing) material compositions. In some designs, the shell material may comprise pores that are not filled with another liquid or solid material (e.g., voids that comprise a gaseous composition or a vacuum).

In some designs, the shell material may penetrate deep into the particles (e.g., about 20-100% of the distance from the surface of the composite particles (counting the thickness of the outer shell layer) to the center of the composite particles). In this case, the shell material may facilitate more robust sealing of a respective particle. In addition, in some designs, such a particle architecture makes the particles more resilient to stresses during cycling or electrode mixing and calendaring. In an aspect, the shell material may penetrate deep into the particles via interconnected open internal pores (potentially through circuitous routes) or via deep surface pores or both.

In some designs, it may be advantageous for the shell material to occupy from around 0.5 vol. % to around 30 vol. % (in some designs, from around 1 vol. % to around 15 vol. %) of the volume of the composite metal fluoride-comprising particles. In some designs, the optimum volume fraction may depend on the composition of the composite, fabrication and/or operational conditions of the electrodes and cells. In some designs, too little volume fraction may undesirably fail to achieve the needed protection, while too large volume fraction may undesirably reduce energy and power performance of the cathodes and may additionally lead to premature cell failure under some operating conditions.

In some designs, the shell material may be deposited onto a composite comprising matrix material and a metal (M) fluoride (e.g., CuF₂, FeF₃, Cu—Fe—F, among others), thereby at least partially sealing the composite. In some designs, subsequent (e.g., chemical) lithiation may induce formation of M-LiF. In some designs, the lithiation may also introduce Li into the shell material (e.g., depending on the shell material composition and lithiation conditions), which, in turn, may enhance the composite's ionic conductivity or reduce first cycle losses or improve sealing properties or improve dispersion in slurries or improve adhesion to the binders or reduce charge transfer resistance or provide other benefits, in some designs.

In some designs, the shell material may be deposited onto a composite comprising matrix material and a suitable metal (M). In some designs, subsequent (e.g., chemical) fluorination may induce formation of metal fluoride material in the composite. The fluorination may also introduce F into the shell material, in some designs (e.g., depending on the shell material composition and fluorination conditions). In some designs, the fluorination reaction may induce volume expansion of the shell material. Such an expansion may help to create a better seal, in some designs. In some designs, subsequent (e.g., chemical) lithiation may induce formation of M-LiF in the composite. In some designs, the lithiation may also introduce Li into the shell material (e.g., depending on the shell material composition and lithiation conditions), which, in turn, may enhance the composite's ionic conductivity or reduce first cycle losses or improve sealing properties or improve dispersion in slurries or improve adhesion to the binders or reduce charge transfer resistance or provide other benefits, in some designs.

In some designs, the shell material may be deposited onto a composite comprising matrix material and a suitable metal oxide. In some designs, the metal oxide may be (at least partially) chemically reduced before or after the shell material deposition (e.g., using a hydrogen gas or hydrocarbon gas or matrix material or other means and their combinations, often at elevated temperatures). In some designs (e.g., when undesirable amount of oxygen is left in the composite after the shell material deposition using described here or another synthesis method process flow), it may be advantageous to utilize shell material chemistry with lower reduction potential so that upon exposing the produced composites into a reduced environment the active material precursor (e.g., oxygen-comprising metal or metal oxide) may be selectively reduced without inducing substantial or undesired reduction of the shell material under the same conditions (e.g., due to much slower kinetics or due to different thermodynamics for such a reduction reaction). In some designs, subsequent (e.g., chemical) fluorination may induce formation of metal fluoride material in the composite. In some designs, the oxygen (from the metal oxide) may be removed from the composite during the fluorination reaction. In some designs, at least a portion of the oxygen may be intentionally left in the composite in order to introduce oxygen doping or formation of metal oxyfluoride. The fluorination reaction may also introduce F into the shell material, in some designs. In some designs, subsequent (e.g., chemical) lithiation may induce formation of M-LiF in the composite. In some designs, the lithiation may also introduce Li into the shell material.

In some designs, the shell material may be deposited onto a composite comprising matrix material, LiF and a suitable metal (M). In some designs, both the LiF and the metal M may comprise some amount of oxygen or nitrogen. In some designs (e.g., when a shell material comprises oxygen, as in a metal oxide), it may be important to prevent or minimize the oxidation of the metal M in the composite. As such, in some designs when the shell material precursor (e.g., in a gaseous or liquid form) comprises oxygen atoms, such oxygen atoms may be chemically bonded to the metal atoms of the shell material precursor.

Various fluorine-comprising gasses may be used for the fluorination reaction in some designs. In some process designs, NF₃ may be advantageously used as an F source for the fluorination reaction. In other designs, fluorine gas (F₂) or hydrofluoric acid (HF) (e.g., in either gaseous or liquid/solution form) may be used for the fluorination. In yet other designs, SiF₄ or SF₆ or CF₄ or CFₓH₍₄₋ₓ₎ (x=1-4) or tetrafluoroethylene or other fluoroethylenes (C₂FₓH₍₄₋ₓ₎ where x=1-4), fluoroethanes (C₂FₓH₍₆₋ₓ₎ where x=1-6) or other gaseous fluoro-carbons and hydro-fluoro-carbons and other fluorine-containing and their combinations may be used for the fluorination reaction.

In some designs, it may be advantageous (e.g., for more precise microstructure, morphology or composition control) for the fluoride precursor material (e.g., a metal salt) to be first at least partially converted into an oxide (e.g., by heating in an inert or oxygen-containing environment, depending on the precursor composition) prior to fluorination.

In some designs, it may be advantageous for the shell to comprise a polymeric material. In some designs, it may be advantageous for the shell to comprise a metallic material (e.g., a metal such as Cu or Fe or Mn or Ni or Bi or Co or Zr or Zn or Cr or Al or W or Ti or Ta or Y or La or In or HF or other suitable metals or a semimetal such as Si or Sb or Sn, among others). In some designs, it may be advantageous for the shell to comprise the same metallic material as an active fluoride cathode (e.g., Cu, Fe, Ni, Mn, Bi, etc.). In some designs, it may be advantageous for the shell to comprise two or more metals in its composition. In some applications, it is important to prevent dissolution of such metallic material during electrochemical cycling in a battery. In some designs, such metals (e.g., like Al) may be used in combination with solid electrolytes or exhibit passivation reactions during oxidation in liquid electrolytes. In some designs, it may be advantageous for the shell to comprise a ceramic material comprising discussed above or other (e.g., Li, Mg, Cs, Na, etc.) metals or semimetals or their combinations (e.g., an oxide material or a fluoride material or an oxyfluoride material or a sulfide material or a nitride material or a carbide material or another suitable ceramic material, the optimal chemistry may depend on various factors). In some examples, the metal of the corresponding ceramic material (e.g., a metal fluoride, metal oxyfluoride, etc.) may be Li, other Group 1 metals, Group 2 metals, transition metal, p-block metal or a rare-earth metal or combination of two or more metals. In some designs, it may be advantageous for the shell to comprise carbon (such as conductive graphitic, mostly sp²-bonded carbon, among others). In some designs, it may be advantageous for the shell to comprise more than one type of material, including any of those discussed above. In some designs, it may be preferred for the shell material (or at least a portion of the shell material) not to exhibit conversion reaction(s) in the electrochemical potential window of the cathode operation (charging and discharging) in a (Li or Li-ion) battery cell. In some designs, the shell material (or at least to a portion of the shell material) may preferably not exhibit conversion reaction(s) when exposed to a low electrochemical potential (e.g., in some designs to around 1.5 V vs. Li/Li⁺; in some designs—to around 1.0 V vs. Li/Li⁺). In some designs, the shell material (or at least a portion of the shell material) may preferably stay in its highest common oxidation state at the electrochemical potentials down to around 1.5 V vs. Li/Li⁺.

In some designs, at least a portion of the shell material may be deposited in a gaseous phase. In some designs, precursor molecules for the shell material deposition in a gaseous phase may comprise volatile solids (e.g., solids with sufficiently high vapor pressure at deposition conditions). In some designs, precursor molecules for the shell material deposition in a gaseous phase may be volatile liquids (e.g., liquids with sufficiently high vapor pressure at deposition conditions). In some designs (e.g., when a shell material comprises metal atoms in its composition), precursor molecules for the shell material deposition in a gaseous phase may be organometallics. In some designs (e.g., when the shell material comprises oxygen) the organometallic precursors may comprise metal-oxygen bonds (M-O). In some designs, precursor molecules for the shell material in a gaseous phase may be organometallics that comprise metal-nitrogen bonds (M-N). In some designs, precursor molecules for the shell material in a gaseous phase may be organometallics that comprise metal-carbon bonds (M-C). In some designs, oxygen or oxygen containing gas may be used during the deposition of the oxygen-containing shell material in a gaseous phase.

In some designs, at least a portion of the shell material may be deposited in a liquid phase. In some designs, a sol-gel technique may be used for the shell material deposition. In some designs, an electrodeposition technique may be used for the shell material deposition. In some designs, a layer-by-layer deposition technique may be used for the shell material deposition. In some designs, an electroless deposition technique may be used for the shell material deposition. In some designs, an electrophoretic deposition technique may be used for the shell material deposition.

In some designs, at least a portion of the shell material may comprise carbon (e.g., in the form of graphitic or turbostratic or amorphous conductive carbon), as previously mentioned. In some designs, such a carbon-based shell material may be deposited in a gaseous phase (e.g., via a CVD reaction). In some designs, ethylene, propylene, acetylene, butene, butadiene, benzene, toluene, naphthalene, anthracene, and other known hydrocarbons may be utilized as precursor(s) for carbon deposition in a gaseous phase (e.g., by thermal decomposition or CVD). In some designs, hydrogen gas may be used together with hydrocarbon gas for carbon deposition in order to control the carbon microstructure and the type of the affluent formed during the deposition reaction. In some designs, a precursor of carbon material may first be deposited (e.g., either from a solution phase or a vapor phase via CVD or other suitable methods) and then at least partially converted to carbon by thermal annealing at elevated temperatures (e.g., from around 300° C. to around 750° C., depending on the precursor and composite composition). In some designs, more than one type of carbon may be utilized (e.g., a portion of the carbon produced by decomposition of the organic or inorganic precursor and another portion deposited from a gaseous phase). In some designs, spray-type CVD may be utilized for carbon deposition or carbon precursor deposition. In some designs, alcohols or carbon precursor(s) or other suitable solvents may be effectively utilized for the spray-type CVD process.

In some designs, at least a portion of the shell material may comprise (at battery operation temperatures) a solid state electrolyte (e.g., of the previously described or other suitable compositions and properties).

In some designs, it may be advantageous for the shell to comprise both organic and inorganic constituents and thus be a (nano) composite. In some designs, an organic component of the shell may comprise an organic polymer or an organic polymer-derived product. In some designs, an inorganic component of the shell may comprise conductive carbon or a ceramic (e.g., fluoride, oxide, nitride, carbide, their various mixtures and alloys, etc.) or an inorganic polymer. In some designs, the shell may comprise lithium (Li). In some designs, the atomic fraction of Li in the shell material composition may range from around 0.01 at. % to around 75 at. %. In some designs, organic and inorganic components of the shell may be intimately (i.e., directly) connected. In some designs, there may be little (e.g., about 0.001-10 areal %) or no voids (or gaps) at the interfaces between the organic or inorganic components. In some designs, the organic and inorganic components of the shell material may be arranged as different layers of a layered structure. In some designs, the organic and inorganic components of the shell material may interpenetrate each other.

In some designs, it may be beneficial that the protective or multifunctional shell comprises a polymeric material. In some designs, the polymeric material may be ionically conductive for Li⁺ ions. In some designs (e.g., when the polymeric material exhibits a low ionic conductivity) the polymeric material may comprise only a portion of the shell so that the majority of the Li⁺ transport takes place through other portion(s) of the shell or through the interface between the polymeric and non-polymeric material. In some designs, polymeric material in the shell may comprise more than one distinct phase or more than one polymer, where each phase (polymer) may offer some complementary properties (e.g., one being more ionically conductive and another being more electronically conductive, etc.). In some designs, polymeric material in the shell may comprise one or more small molecule plasticizers. In some designs (e.g., when two or more distinct phases or polymers are present in the polymeric material), the polymeric material in the shell may be a physical blend of some of these components. In some other designs, two or more of these components might be covalently attached. In some other designs, the polymeric shell material might be a physical blend of covalently and non-covalently attached components. In some examples, the polymeric shell material may be covalently attached to the particle containing the active materials while in some other examples, the polymeric shell material may only exhibit non-covalent interactions with the particle containing the active ingredient.

In some designs, it may be advantageous for the polymer shell material to comprise nitrogen (N). In some designs, N may be a part of the polymer backbone of the polymer shell material. In some designs, N may be a part of polymer functional group(s) of the polymer shell material. In some designs, N may form double bonds with neighboring atoms in the polymer shell material. In some designs, N may form single bonds with neighboring atoms in the polymer shell material. In some designs, the same N may form a double bond with one of the neighboring atoms and single bond with another one of the neighboring atoms in the polymer shell material. In some designs, N may be bonded to phosphorous (P) in the polymer shell material. In some designs, N may be bonded to hydrogen (H) in the polymer shell material. In some designs, N may be bonded to sulfur(S) in the polymer shell material. In some designs, N may be bonded to selenium (Se) in the polymer shell material. In some designs, N may be bonded to carbon (C) in the polymer shell material.

In some designs, it may be advantageous for the polymer shell material to comprise oxygen (O). In some designs, O may be a part of the polymer backbone of the polymer shell material. In some designs, O may be a part of polymer functional group(s) of the polymer shell material. In some designs, O may form double bonds with neighboring atoms in the polymer shell material. In some designs, O may form single bonds with neighboring atoms in the polymer shell material.

In some designs, it may be advantageous for the polymer shell material to comprise fluorine (F). In some designs, F may be a part of polymer functional group(s) or (poly) anion(s) attached to the polymer backbone of the polymer shell material. In some designs, F may be bonded to carbon (C) in the polymer shell material. In some designs, F may be bonded to O in the polymer shell material. In some designs, F may be bonded to phosphorus (P) in the polymer shell material. In some designs, F may be bonded to boron (B) in the polymer shell material.

In some designs, it may be advantageous for the polymer shell material to comprise chlorine (Cl). In some designs, Cl may be a part of polymer functional group(s) or (poly) anion(s) attached to the polymer backbone of the polymer shell material. In some designs, Cl may be bonded to carbon (C) in the polymer shell material. In some designs, Cl may be bonded to O in the polymer shell material. In some designs, Cl may be bonded to P in the polymer shell material. In some designs, Cl may be bonded to F in the polymer shell material. In some designs, Cl may be bonded to B in the polymer shell material.

In some designs, it may be advantageous for the polymer shell material to comprise phosphorous (P). In some designs, P may be a part of the polymer backbone of the polymer shell material. In some designs, P may be a part of polymer functional group(s) of the polymer shell material. In some designs, P may form double bonds with neighboring atoms in the polymer shell material. In some designs, P may form single bonds with neighboring atoms in the polymer shell material. In some designs, the same P atoms may form a double bond with at least one of the neighboring atoms and single bond(s) with other neighboring atom(s) in the polymer shell material. In some designs, P may form bonds with N in the polymer shell material. In some designs, P may form bonds with more than one neighboring N in the polymer shell material. In some designs, P may form bonds with O in the polymer shell material. In some designs, P may form bonds with both N and O in the polymer shell material. In some designs, P may form bonds with F in the polymer shell material.

In some designs, it may be advantageous for the polymer shell material to comprise sulfur(S). In some designs, S may be a part of the polymer backbone of the polymer shell material. In some designs, S may be a part of polymer functional group(s) or anion(s) attached to the polymer backbone of the polymer shell material. In some designs, S may form double bonds with neighboring atoms in the polymer shell material. In some designs, S may form single bonds with neighboring atoms in the polymer shell material. In some designs, the same S may form a double bond with one of the neighboring atoms and single bond with other neighboring atoms in the polymer shell material. In some designs, S may form bonds with O in the polymer shell material. In some designs, S may form bonds with N in the polymer shell material. In some designs, S may form bonds with carbon (C) in the polymer shell material.

In some designs, it may be advantageous for the polymer shell material to comprise selenium (Se). In some designs, Se may be a part of the polymer backbone of the polymer shell material. In some designs, Se may be a part of polymer functional group(s) or anion(s) attached to the polymer backbone of the polymer shell material. In some designs, Se may form double bonds with neighboring atoms in the polymer shell material. In some designs, Se may form single bonds with neighboring atoms in the polymer shell material. In some designs, the same Se may form a double bond with one of the neighboring atoms and single bond with other neighboring atoms in the polymer shell material. In some designs, Se may form bonds with O in the polymer shell material.

In some designs, Se may form bonds with N in the polymer shell material. In some designs, Se may form bonds with C in the polymer shell material. In some designs, Se may form bonds with S in the polymer shell material.

In some designs, it may be advantageous for the polymer shell material to comprise boron (B). In some designs, B may be a part of polymer functional group(s) or (poly) anion(s) attached to the polymer backbone of the polymer shell material. In some designs, B may be bonded to F in the polymer shell material. In some designs, B may be bonded to O in the polymer shell material.

In some designs, it may be advantageous for the polymer shell material to comprise one or more hybrid inorganic-organic polymers.

In some designs, it may be advantageous for the polymer shell material to comprise one or more conjugated bonds.

In some designs, it may be advantageous for the polymer shell material to comprise five-corner or six-corner ring-shaped compounds (including, but not limited to boroxine ring, aromatic/benzene ring, and their various derivatives, etc.). In some designs, the ring-shaped compounds in the polymer shell material may comprise B. In some designs, the ring-shaped compounds in the polymer shell material may comprise N (e.g., either within the ring backbone or in a side group or both). In some designs, the ring-shaped compounds in the polymer shell material may comprise O (e.g., either within the ring backbone or in a side group or both). In some designs, the ring-shaped compounds in the polymer shell material may comprise S (e.g., either within the ring backbone or in a side group or both). In some designs, the ring-shaped compounds in the polymer shell material may comprise F (e.g., in a side group).

In some designs, it may be advantageous for the polymer material in the protective or multifunctional shell to comprise one or more linear polymers (or copolymers). In some designs, it may be advantageous for the polymer material in the protective or multifunctional shell to comprise one or more branched polymers (or copolymers). In some designs, it may be advantageous for the polymer material in the shell to comprise one or more star-shaped or dendritic or comb-type polymers (or copolymers). In some designs, it may be advantageous for the polymer material in the shell to comprise polymers (or copolymers) of more than one shape/architecture (e.g., comprise both linear and branched polymers or both branched and dendritic polymers or linear, branched and dendritic polymers, etc.). In this way, properties of the polymer-comprising shell may be favorably tuned to particular applications.

Illustrative examples of suitable polymers that may be used in a polymeric shell material include, but are not limited to: poly(acrylics) and poly(methacrylics) (such as poly(methyl methacrylate), poly(ethyl acrylate), poly(n-butyl acrylate), poly(t-butyl acrylate), poly(n-butyl methacrylate), poly(t-butyl methacrylate), poly(hexyl acrylate), poly(hexyl methacrylate), poly(cyclohexyl acrylate), poly(cyclohexyl methacrylate), poly(benzyl acrylate), poly(benzyl methacrylate), poly(perfluorobenzyl acrylate), poly(perfluorobenzyl methacrylate), poly((1H,1H,2H,2H-perfluorodecyl) acrylate), poly((1H,1H,2H,2H-perfluorodecyl) methacrylate), poly(phosphazene), poly(methacrylic acid), poly(acrylic acid), poly(2-hydroxyethyl acrylate), poly(2-hydroxyethyl methacrylate), poly(glycidyl acrylate), poly(glycidyl methacrylate), poly(ethylene glycol acrylate), poly(ethylene glycol methacrylate), poly(acrylamido-) and poly(methacrylamido-) (such as poly(N-isopropylacrylamide),), poly(acrylonitrile), poly(l-vinyl-2-pyrrolidone), styrenics (such as poly(styrene), poly(dimethylaminomethyl styrene)), or any of the electron-conducting or Li⁺-conducting polymers described in the polymer electrolyte section or other sections of this disclosure.

In some designs, one or more multifunctional monomers such as ethylene glycol dimethacrylate, ethylene glycol diacrylate, divinylbenzene, 1,3,5-trivinyl,trimethyl trisiloxane, N,N′-methylenebisacrylamide, may be used in combination with one or more linear (or, in some designs, branched, star-shaped, dendritic, etc.) polymers describe in this embodiment or by themselves to produce a cross-linked polymeric shell material. In some designs, resin forming monomers or prepolymers may be used by themselves or in combination with the polymers described in this embodiment. Illustrative examples of suitable resins include, but are not limited to: urea-formaldehyde resins, maleimide resins, epoxy resins, polybenzoxazine resins, polyurethane resins, phenol resins or any combination thereof.

In some designs, the electronic conductivity of the polymer shell material may be increased by chemically or physically incorporating one or more electron-conducting polymer or one or more electron-conducting additive or any mixture thereof. In some of these examples, one or more electron-conducting polymers may be n-doped or p-doped. Suitable examples of such polymers include but are not limited to: poly(3,4-ethylenedioxythiophene) (PEDOT), poly(thiophene), poly((3-alkyl)thiophene), poly((3-hexyl)thiophene) (P3HT), poly(acetylene), poly(paraphenylene), poly(paraphenylene vinylene), poly((2,5-dialkoxy) paraphenylene vinylene), poly(heptadiyne), poly(paraphenylene sulfide), poly(aniline) (PANI) or poly(pyrrole) (PPy).

In some designs, two or more polymers used in the polymeric shell material may be mixed to form a physical blend or covalently attached to form a gradient, statistical, alternating, graft or block copolymer. For example, it might be beneficial in some instances to copolymerize a synthon which has high electronic conductivity or high affinity with conductive additives with a synthon that has high affinity with the solvent used to prepare the slurry or to copolymerize a synthon which has a low Tg with a synthon which can be cross-linked to finely tune the properties of the polymeric shell material.

In some designs, the polymers, copolymers or cross-linked networks of the polymeric shell material may be prepared by various suitable types of polymerization techniques, including, but not limited to, polycondensation, polyaddition, coordination-insertion polymerization, oxidative polymerization, anionic polymerization, ring opening polymerization, ring-opening metathesis polymerization (ROMP) or radical initiated polymerization such as free-radical polymerization, atomic transfer radical polymerization (ATRP), reversible addition-fragmentation chain transfer (RAFT), nitroxide-mediated radical polymerization (NMP) and other suitable polymerization techniques. In some designs, the particular polymerization technique may be selected based on the chemical nature of the polymer or copolymer.

Illustrative examples of suitable deposition techniques for the polymeric shell material include, but are not limited to: electrodeposition (including self-limited electrodeposition), electroless deposition (including self-limited deposition), spray-drying, various dispersed media polymerization methods such as precipitation polymerization or emulsion polymerization, electrospray, microfluidics, dry blending, self-assembly of one or more preformed polymer at the surface of the particle favored by chemical interactions or initiated chemical vapor deposition (iCVD) or ALD.

In some designs, one or more prepolymers exhibiting reactive moieties, with a molar mass between about 300 g/mol and about 1,000,000 g/mol, may be deposited as part of the polymeric shell material on and/or inside the particle containing the active metal fluoride material. In some of these examples, the reactive moieties may be used at a later stage, in combination with one or more other molecules, to either install some other chemical functionalities at the surface of the particle containing the active ingredient or to increase the crosslinking density of the shell. In some of these designs, intermolecular and/or intramolecular cross-linking reactions involving one or more prepolymers may be used to increase the cross-linking density of the polymeric shell material. Suitable deposition techniques for the one or more prepolymers include, but are not limited to: spray-drying, any dispersed media polymerization such as precipitation polymerization or emulsion polymerization, dry blending or self-assembly of one or more preformed polymer at the surface of the particle favored by chemical interactions. Suitable techniques to induce the reaction of the reactive moieties include, but are not limited to: one or more chemical triggers such as the addition of an acid or a base or an oxidizer or a reducer or a radical and/or physical triggers such as temperature or exposure to UV light or a combination thereof such as the release of radicals triggered by temperature or the release of radicals, or one or more bases or acids triggered by UV-light. In some examples, the reaction of the reactive moieties may be triggered before the electrode has been coated, for instance, using a solvent as a dispersing media or in an agitated or fluidized bed while in some other examples, the reaction of the reactive moieties may be triggered after the electrode has been coated.

In some designs, the polymeric shell material may be deposited, cured, or modified or any combination thereof, using a hydrothermal or a solvothermal process.

In some designs, the polymeric shell material may be deposited, cured, or modified or any combination thereof, using a polymeric or molecular stabilizer or surfactant. In some of these designs, the stabilizer or surfactant may be chemically incorporated in the polymer shell material.

In some designs, it may be beneficial for a polymer or mixture of polymers used in the polymeric shell material deposited inside and/or at the surface of the individual particles containing the active metal fluoride material to exhibit a Tg low enough so that after the electrode coating has been prepared, the electrode can be heated and/or calendered above that Tg to allow for the re-localization of the polymer shell material. In some of these examples, the packing density of the electrode may be improved and the distance between the particles containing the active ingredient and/or the conductive additive may be tuned.

In some designs, a polymeric shell material may be coated on the electrode after drying the electrode (e.g., in addition to or in place of the particle-specific shells). In some of these examples, it may be beneficial to heat and/or calendar the polymeric shell coating on the electrode to allow for the polymer shell material coated at the surface of the electrode coating to more deeply impregnate the electrode coating.

In some designs, chemical lithiation may be effectively used during one or more stages of the fluoride-comprising composite synthesis. For example, as an alternative to the subsequent formation or deposition of metal (M) and LiF clusters/nanoparticles/porous particles, metal fluoride (MFx) (nano) particles may be first formed (or deposited or infiltrated into a skeleton matrix material) and then converted into a LiF/M nanocomposite by using one of the chemical lithiation procedures (e.g., preferably in an anhydrous environment or other environments free from those solvents that may induce undesirable interactions either with LiF or with M). In some designs, these chemical lithiation processes may reduce a metal (M) from the MFx into its metallic state and simultaneously form LiF.

In some designs, the size of such MFx-comprising particles may range from about 1 nm to about 50 μm (in some designs, from about 50 nm to about 10 μm). In some designs, such particles may comprise from around 25 wt. % to around 100 wt. % metal fluoride(s). In some designs, the rest of the particle composition (i.e., other than the metal fluoride part) may be comprised substantially of (i) electrochemically inactive material, (ii) electrochemically active material, (iii) a precursor for excess LiF or excess M (if desired), or (iv) another useful material (e.g., a dopant, a surfactant, a sacrificial template material, or a precursor for the skeleton matrix material). As used herein, an “electrochemically active material” generally refers to a material capable of electrochemically accepting and releasing Li or other metal ions in excess of around 50 mA/g (Li capacity). In some designs, higher content of metal fluoride(s) may be preferable to achieve higher capacity in the cathode.

In some designs, the MFx-comprising compositions may be placed in a temperature-controlled environment of a lithiation reactor. In this case, controlling the temperature to which the MFx-comprising compositions are exposed may be used to control the size and/or morphology of structural features in the obtained M/LiF composites. At some temperatures (and compositions), M and LiF may form interpenetrating networks during lithiation of MFx particles. At other temperatures (and compositions), M and LiF may form porous M with LiF filling its pores during lithiation of MFx. At yet other temperatures (and compositions), M and LiF may form porous LiF with M filling its pores. In some conditions, the obtained M/LiF composite particles may largely retain the initial shape of the MFx particles. Such a situation may be preferable for some applications (e.g., when control of the composite morphology is important). At too high temperatures of the lithiation reactions, the size of M clusters or LiF clusters may be undesirably large for some applications and morphology of the M/LiF composite may deviate significantly from the morphology and size of the initial MFx particle. Unfortunately, chemical lithiation may be a highly exothermic process, where heat is released upon the chemical lithiation reaction. If such a reaction proceeds too fast and the heat extraction from the reactor is too slow, the control of the reaction temperature may be lost and the desired M/LiF composite morphology may not be obtained. The third stage may involve lithiation of the MFx compositions. In some designs, excess metal (M) may be introduced into the M/LiF composite by, for example, post-deposition (e.g., by CVD, ALD, or wet chemistry routes-such as precipitation from the solution with subsequent reduction). Alternatively, in other designs, a metal precursor may be added to the MFx particles prior to chemical lithiation. In this case, the lithiation procedure may simultaneously reduce the metal precursor to form an additional metal component of the composite. Excess LiF may be introduced into the M/LiF composite by, for example, post-deposition (e.g., by CVD, ALD, or wet chemistry routes). Alternatively, in some designs, fluorinating a composite matrix material may provide extra fluorine needed for the additional LiF formation during the chemical lithiation. In some designs, by-products of the chemical reactions may be removed after synthesis.

In some designs, lithiation may proceed in a gaseous environment, where lithiation or reducing agents are delivered as vapor or gas molecules. In some designs, one advantage of this approach is its high precision and control, but there may be disadvantages in terms of high cost, slow rates, and limited (often expensive) chemistries of the suitable lithiation/reducing agents available. In other designs, lithiation may proceed in a solid phase (e.g., by mixing the powders). For example, lithium hydride (LiH) may be mixed with metal fluoride-containing compositions to produce LiF and metal-comprising compositions. In some designs, H₂ gas produced during this process may be evacuated. In some designs, such a mixing may be produced in a dry environment (in some designs, upon heating) or in solvent-comprising slurries. In yet other designs, the lithiation stage takes place in one or more solutions. A possible advantage of this approach (e.g., over lithiation by mixing powders in a dry state) in some designs is more precise control over the reaction rate (e.g., controlled by the choice of the lithiating or reducing agents, their concentration, and by the temperature of the reactor since liquids have higher conductivities than gasses).

In some designs (e.g., depending on the chemical potential of different lithiation reagents and temperature of the lithiation process), one may preferably select lithiation conditions that may convert MFx to M-LiF compositions without having the shell or matrix material(s) undergo a conversion or substitution reaction.

In some designs, it may be advantageous to lithiate cathode material in a powder form (e.g., before being added to a slurry and cast onto an electrode). Yet in other designs, the cathode material may be lithiated only after being cast onto electrodes (e.g., cathodes). In some designs, if binder is utilized in such electrodes and if the lithiation proceeds in a solvent, it may be important to reduce or prevent binder dissolution by selecting a compatible binder/lithiation solvent combination. In some designs, a lithiation byproduct may either be dissolved in the same solvent or evacuated in a gaseous form. In some designs, electrodes and compressed powders or dense slurries (e.g., where particles are linked to each other using conductive additives) may be lithiated electrochemically. In some designs, it may be advantageous to use redox-active polymers to lithiate cathode materials in their reduced state. In some designs, such polymers may then be used as binders or polymer electrolyte for the electrode formulations.

In some designs, the use of one or more lithiating or reducing agents provide a more controlled lithiation and thus may be advantageous. Suitable examples of lithiating/reducing agents may include, but are not limited to, the following: lithium biphenyl and its derivatives, lithium naphthalene and its derivatives, alkyl and aryl lithium reagents and their derivatives, molten or gaseous lithium metal, and ammonia lithium solutions, including lithium solutions made in mono-, di-, and/or tri-substituted amines. Suitable chemical lithiation agents may include lithium 2-methylnaphthalen-1-ide, lithium anthracene, lithium phenanthrene, lithium 4,4′-di-tert-butylbiphenylide (LiDBB), lithium 2,2,6,6-tetramethylpiperidide (LiTMP), lithium bis(trimethylsilyl)amide (LiTMP), lithium 4,4′-bis(diethylamino)-2,2′-biphenylyl (LiDEAB), lithium 2,2′-dimethylbiphenyl (LiDMBP), lithium 2-tert-butyl-4,6-dimethylphenyl (LiTBDMPP), lithium 2,2′-diphenyl-4,4′-dimethyl-1,1′-biphenyl (LiDPDMBP), lithium 2,2′-diphenyl-4,4′-bis(trimethylsilyl) phenyl (LiDBTMSB), lithium 2-tert-butyl-4,6-dimethylphenyl-2′-(trimethylsilyl) biphenyl (LiTBDMPP-TMSB), lithium 2,2′-diphenyl-4,4′-dimethyl-1,1′-biphenyl-4′-yl (LiDPDMBP-4), lithium 2,2′-diphenyl-4,4′-dimethyl-1,1′-biphenyl-3,3′-diyl (LiDPDMBP-3,3′), lithium 2,2′-diphenyl-4,4′-dimethyl-1,1′-biphenyl-3-yl (LiDPDMBP-3), lithium 2-((tert-butoxycarbonyl)amino)-4,6-dimethylphenyl (LiBoc-DMPP), lithium 2-((tert-butyl)dimethylsilyl)phenyl (LiTBDMS-Ph), lithium 2-(4-tert-butylphenyl)-4,6-dimethylphenyl (LiTBPP-DMPP), lithium 1,8-diazabicyclo[5.4.0]undec-7-ene (LiDBU), lithium 1,2,3,4-tetrahydro-1-naphthalenyl (LiTHN), lithium 2,6-dimethyl-4-(trimethylsilyl) naphthalenide (LiDMTSN), lithium 1-(1-naphthyl) pyrrolidine (LiNPYR), lithium 1,4-dibenzyl-1,4-diazabicyclo[2.2.2]octane (LiDBBO), lithium 1,3-dimethyl-1,3-dihydro-2H-benzimidazole (LiDMBI), lithium 1-(2-pyridyl) piperidine (LiPyP), lithium 4,4′-di-tert-butyl-2,2′-bipyridine (LIDTBBP), lithium 1,2-diphenyl-1,2-ethanediamine (LiDPEA), lithium 2,2′-bipyridine (LiBPY), phenyllithium, p-toluenelithium, 4-bromophenyllithium, 4-trifluoromethylphenyllithium, 2-naphthyllithium, methyllithium, n-butyllithium, i-propyllithium, and t-butyllithium.

In some designs, these pre-lithiation reactions may be carried out in cyclic or linear ethereal solvents, saturated hydrocarbon solvents, and/or aromatic solvents. For example, tetrahydrofuran (THF) and diethyl ether may be utilized due to their ability to solubilize lithium reagents to form stable complexes with lithium ions. Other ether solvents that may be used include dimethoxyethane (DME), diethylene glycol dimethyl ether (DGM), 2-methyl tetrahydrofuran (2-MeTHF), ethylene glycol dimethyl ether (EGDME), ethylene glycol diethyl ether (EGDE), 1,3-dioxolane (DIOX), 1,2-dimethoxyethane (DME), ethylene glycol dibutyl ether (EGBE), 2-methyl-1,3-dioxolane (2MeDOX), propylene glycol dimethyl ether (PGDME), tetraglyme, diglyme, 1,2-dimethoxypropane (DMP), propylene glycol diethyl ether (PGDE), and/or ethylene glycol dimethyl ether acetate (EDMEA). Illustrative examples of saturated hydrocarbon solvents include, but are not limited to, hexane and heptane, which may also be used for lithiation reactions, and may be preferred when working with alkyl lithium reagents. Other examples include: cyclohexane, decane, octane, pentane, nonane, dodecane, mineral oil, isooctane, isopentane, and methylcyclohexane. In some designs, aromatic solvents, including toluene and xylene, may be used for lithiation reactions (e.g., in some designs, aromatic solvents may be preferred when working with bulky or sterically hindered lithium reagents). Additional examples include benzene, ethylbenzene, chlorobenzene, 1,2-dichlorobenzene, 1,3-dichlorobenzene, anisole, cumene, styrene, phenol, tetrahydronaphthalene, and biphenyl. In some designs, the choice (or pairing) of chemical lithiation reagent(s) and solvent(s) is non-trivial and may facilitate a high degree of control over the reaction conditions and lithiation of silicon-comprising anode materials.

Many lithiation/reducing agents are reactive to air and moisture and may need to be handled under a dry, inert atmosphere. For some designs, lithiating/reducing agents should ideally produce LiF and MFx without side reactions and with reaction byproducts that are easily removable. In some designs, byproducts may be removed by extraction with organic solvents or evaporation/sublimation at reduced pressures or elevated temperatures. Alkyllithium reagents produce short-chain hydrocarbon byproducts that may either be extracted with organic solvent or removed by evaporation under reduced pressure or elevated temperature in some designs. A drawback of alkyllithium reagents is that they may produce alkylate metal salts (e.g., producing M (alkyl) x), which is an undesired reaction for some applications. In some designs, the byproducts of organic radical anions (including ketyl radical anions or polycyclic aromatic hydrocarbon radical anions) may be uncharged organic small molecules that may be extracted with organic solvents or removed under reduced pressure or elevated temperature by evaporation or sublimation. The byproducts of alkyllithium magnesates, alkyl magnesium compounds and hydrocarbons may also be easily removable by extraction in organic solvents or be removed by evaporation (e.g., under reduced pressure or elevated temperatures). In some applications, lithium trialkylborohydrides produce hydrogen gas and trialkylboranes, which may be easily removed by evaporation, but trialkylboranes are pyrophoric such that this reagent may be less desirable for some applications where safety and ease of handling is desired.

In some designs, reactions with chemical reducing agents may be conducted in organic solvents, specifically including ethereal solvents such as tetrahydrofuran, dimethoxyethane, diethylether, or dioxolane or hydrocarbon solvents such as C5-C9 alkyl chains. In some designs, reactions may be conducted in an inert atmosphere to reduce or prevent oxidation by O₂ or oxidation or hydration by water. In some designs, the temperature of lithiation reactions may range from about −78° C. to about 600° C. (e.g., too low temperature restricts reaction kinetics too much, while too high temperature makes it less controllable). In some designs, a pressure of the reaction may range from about 0.05 atm. to about 50 atm. (e.g., near-atmospheric pressure may be suitable). In some designs, a concentration of the soluble reducing agents may range from about 0.001 M to about 10 M (or more, in some cases) in the reaction solvent. In some designs, molar ratios of lithium cations Li⁺ relative to metal cations Mⁿ⁺ may range from about 0.5n to about 100n. In some designs, the byproducts and solvents from reaction may be removed by filtration, centrifugation, evaporation, sublimation, carbonization, a combination thereof or other techniques.

In some designs, one or more of the described above lithiation techniques may be useful for lithiating other conversion-type electrode materials (e.g., S, Se, Si, Sn, etc.) or mixed intercalation/conversion materials or purely intercalation materials for use in rechargeable Li and Li ion batteries.

In some designs, in order to achieve a high energy cell (e.g., and often the lowest cost per unit energy in such cells and most favorable performance), when a battery is constructed with the cathode comprising mixed LiF and metal compositions (LiF-M or, more broadly, LiF-M-MFx-LiMFy) and exhibiting a high volumetric capacity (e.g., above about 700 mAh/cc on the electrode level, more preferably above about 800 mAh/cc, even more preferably above about 900 mAh/cc, even more preferably above about 1000 mAh/cc), in some designs it may be preferred for the battery anode to also exhibit comparably high (or higher) volumetric capacity (e.g., above about 800 mAh/cc, even more preferably above about 900 mAh/cc, in some designs-more preferably above about 1000 mAh/cc or even above about 1100 mAh/cc). In some designs, it may be preferable for such high capacity anodes to comprise Si. In some designs, such high capacity anodes may comprise about 30 at. % of Si or more. In some designs, such high capacity anodes may comprise about 5 at. % of C or more in order to achieve better stability and higher rates. In some designs, it may be preferable for such high capacity anodes to comprise Li in order to further enhance cell energy density. In some designs, such high capacity anodes may comprise about 3 at. % of Li or more. In some designs, Li metal or Li metal alloy anodes may be used in such high specific energy cells. In some designs, all (or essentially all) cyclable Li in the cell may be advantageously introduced into the cathode during the cell assembling so that Li is inserted (or alloyed or plated) within the anode during the first charge (e.g., after the cell assembling). In other words, in some designs it may be advantageous for the fluoride-cathode comprising cells to be assembled in a fully (or at least partially) discharged state. In some designs (e.g., when a solid electrolyte is used in contact with the Li metal anode), it may be advantageous for the Li to be deposited (plated) into the pre-existing open pores within the anode. In some designs, electrically interconnected porous carbon particles (e.g., surrounded by the solid electrolyte) may provide pore space for Li plating during charging. In some designs, the pores may comprise Li alloying element nanoparticles (e.g., Si nanoparticles or Si layers, among others) to provide a better dimensional control over Li insertion areas. Indeed, Li plating uniformity may be more difficult to control compared to Li alloying (e.g., to form Li—Si or Li—Sn alloys, etc.). In some designs, the use of a rigid solid electrolyte surrounding porous particles may help to reduce or prevent Li plating onto the outer surface of the particles (because it would require overcoming a significant energy barrier associated with the plastic and elastic deformation of the solid electrolyte) and force Li insertion (or plating) inside the pores. Instead of (or in addition to) porous carbon (or hollow carbon spheres), the anode may comprise porous metal or semimetal or metal oxide particles based on materials that are permeable to Li ions and react/alloy with Li. Examples of such materials may include, but are not limited to, Si, Sn, Sb, Al, their various alloys, oxides (incl. suboxides), nitrides and other suitable compositions. Like the above-described designs and architectures of the metal fluoride cathodes, the conversion (e.g., Si-based) or Li metal (or Li alloy) anodes may exhibit a core-shell morphology in some designs. In some designs, at least a portion of the shell may be deposited after the anode fabrication (casting onto the current collector) (e.g., by ALD or other suitable techniques).

In some designs, the cathode (or both anode and cathode) may comprise a distinguishable polymer binder, where individual (e.g., composite) electrode particles are bonded to each other (and to a current collector) using such a binder. Furthermore, in some designs, it may be advantageous for the bonding between a polymer binder and electrode particle surfaces to comprise strong primary (chemical) bonds. In some designs, such particles may be bonded to the polymer binder using secondary bonds (electrostatic or van der Waals forces or hydrogen bonding, etc.). While individual secondary bonds (e.g., hydrogen or van der Waals bonds) are significantly weaker (exhibit lower binding energy) than individual chemical bonds, secondary bonds offer a significant advantage (for some applications) of being able to repair and reform new secondary bonds (after being broken). In contrast, broken chemical bonds are often irreparable or difficult to repair in some applications. In some designs, sufficiently large contact areas (e.g., from around 0.1% to around 100%) between electrode particles and the polymer binder that involve hydrogen bonding and high density of secondary bonds may compensate for the lower strength of individual secondary bonds in some designs and, as a result, may form sufficiently strong overall bonding between neighboring particles.

In some designs, the polymer binder need not be particularly ionically conductive (e.g., exhibit Li⁺ conductivity below about 10⁻⁸ S/cm at room temperature) as its primary function is to bind electrode particles together to form mechanically robust electrodes (e.g., which may be particularly important when conversion-type and thus volume changing active materials are utilized in the electrodes, such as metal fluoride-based conversion-type cathode active materials). However, in some designs, it may also be advantageous for the polymer binder to additionally exhibit sufficiently high ionic conductivity (e.g., above about 10⁻⁶ S/cm at room temperature) in order not to block the ion flow between the electrolyte and the active electrode particles. Alternatively, in some designs, the polymer binder may coat only a fraction of the electrode particle surfaces' outer surface area in the electrode (e.g., from around 0.0001% to around 80.0%; in some designs from around 0.1% to around 25%) thereby leaving sufficient space for largely unobstructed ion transport.

In some designs, the suitable fraction of the polymer binder in the final electrode coating layer may range from around 0.0 wt. % to around 25 wt. % or from around 0.0 vol. % to around 35 vol. % (in some designs, from around 0.1 wt. % to around 10 wt. % or from around 0.1 vol. % to around 15.0 vol. %), depending on the volume changes in the electrode particles, shape and size of the electrode particles, surface chemistry of the electrode particles, electrode particle composition, ionic conductivity within a polymer binder in a fabricated cell, reactivity of the polymer binder with the electrolyte, miscibility of the polymer binder with the electrolyte, electrolyte composition, polymer binder composition, the electrode fabrication methodologies and/or other factors. In some designs, an insufficient mass or volume of the polymer binder may lead to mechanical failure of the electrode layer during cell fabrication or cell operation. In some designs, excessive mass or volume of the polymer binder may lead to reduced volumetric and gravimetric electrode capacities, reduced cell-level energy and power characteristics and/or reduced cycle stability of the electrodes or cells.

In some designs (e.g., for some chemistries of the binder, electrode particles and electrolyte), it may be advantageous for the binder to form chemical bonds with the electrode. In some designs, it may be advantageous for the binder to exhibit some limited reactivity with the electrolyte and form a binder/solid electrolyte interphase layer. In some designs, the thickness of such a layer may preferably not exceed around 20 nm. In some designs, it may be advantageous for the binder to form chemical bonds with the solid electrolyte.

In some designs, it may be advantageous for the binder distribution within the electrode not to be substantially uniform. In some designs, for example, it may be advantageous for the electrode to comprise a larger volume fraction of the binder near the current collector surface. In some designs, it may be advantageous for the binder to coat from around 0.1% to around 90% of the outer surface area of the electrode particles. The optimal binder coating on the electrode particles for particular applications may depend on the electrode, binder and electrolyte chemistry and/or electrode particle size. In some designs, too small areal coating may reduce mechanical strength and stability of the electrode. In some designs, too large area coating may reduce electrochemical stability of the cells and/or reduce its rate performance or provide other undesirable outcomes.

In some designs, at least a portion of the polymer binder may be in the form of polymer fibers (including porous fibers and (nano) fibers and other one dimensional (1D) elongated particles with an aspect ratio in the range from around 4 to around 1,000,000) or polymer flakes or platelets (including (nano) flakes and porous flakes and other two dimensional (2D) elongated particles with an aspect ratio in the range from around 4 to around 1,000,000) or polymer comprising composite fibers or polymer-comprising composite flakes. In some designs, the average smallest dimensions (thickness or diameter) of such fibers or flakes may advantageously range from around 2 nm to around 40 nm. In some designs, such polymer fibers (or flakes) may bond with the electrode particles to enhance mechanical properties or processability of the electrodes. In some designs, polymer fibers or flakes may form primary (chemical) bonds with electrode particles. In other designs, polymer fibers or flakes may form secondary bonds with the electrode particles in the electrode. In some designs, such a form of the polymer binder may help to enhance mechanical properties of the electrode(s) (polymer (nano) fibers and (nano) flakes may be particularly strong). The fiber-shape form of the polymer binder may also help to enhance ion transport within the electrode and through the electrode/electrolyte interface(s) or interphase(s).

In some designs, it may be advantageous for the individual polymer flakes or polymer fibers to exhibit tensile strength in the range from around 10 MPa to around 10 GPa. In some designs (e.g., when electrolyte is introduced at elevated temperatures into the electrode or when cells are exposed to relatively high temperatures during operation, etc.), it may be advantageous for the polymer flakes or fibers to exhibit thermal stability in the range of about 60° C. to about 400° C. (e.g., so as not to lose more than about 50% of its room temperature tensile strength while heating to such elevated temperatures).

In some designs, it may be advantageous for the individual polymer flakes or fibers to exhibit diameter (thickness) (e.g., an average diameter or thickness) in the range from around 1.0 nm to around 200 nm (e.g., depending on various factors, such as electrode particle size, electrode composition, binder mechanical and thermal properties, among others). In some designs, too thin fibers (or flakes) may not be sufficiently strong, while too thick fibers (or flakes) may reduce volumetric and gravimetric electrode capacities and, in some cases, may not provide sufficient contact area with the electrode particles to establish adequate mechanical properties.

In some designs, it may be advantageous for the standalone portion of the electrode (e.g., cathode or anode or both) layer (without the metal current collector) to exhibit a tensile strength (measured at room temperature in air) in the range from around 0.1 MPa to around 1,000 MPa (e.g., either when filled with the electrolyte or in the electrolyte-free state). In some designs, it may be advantageous for the electrode layer to exhibit a tensile strength in the range from around 0.1 MPa to around 1,000 MPa in the operating temperature range.

In some designs, it may be advantageous for the standalone portion of the electrode (cathode or anode or both) layer (without the metal current collector) to exhibit a compressive strength (in air, measured at room temperature) in the range from around 0.1 MPa to around 2,000 MPa in at least some state of charge or discharge (in one example, in the fully (or partially) lithiated/discharged state for the cathode or, in another example, in the fully (or partially) delithiated state for the anode; for example measured prior to cell operation). In some designs, it may be advantageous for the electrode layer(s) to exhibit a compressive strength in the range from around 0.1 MPa to around 2,000 MPa in the operating temperature range. In some designs, it may be advantageous for the electrode layer to exhibit a room-temperature compressive strength in the range from around 0.1 MPa to around 1,000 MPa when filled with the electrolyte.

In some designs (e.g., depending on a particular application, operational cell temperature range, electrode potentials during cell operation, synthesis method, desired electrode properties, chemical composition, volume changes of the electrode particles and/or other factors), a polymer binder in the electrode may comprise thermoset or thermoplastic polymers (either standalone or as a mixture or as a co-polymer component), including, but not limited to: various polysaccharides and mixture of polysaccharides with other polymers including but not limited to proteins (e.g., arabinoxylans, gum arabic, xantham gum, pectins, chitin and chitin derivatives, cellulose and cellulose derivatives including various modified natural polymers, such as cellulose acetate (CA), cellulose acetate butyrate (CBA), carboxymethylcellulose (CMC), cellulose nitrate (CN), ethyl cellulose (EC), among others cellulose derivatives, alginates including alginic acids and its salts, etc.); acrylonitrile-butadiene-styrene (ABS); allyl resin (Allyl); casein (CS); cresol-formaldehyde (CF); chlorinated polyethylene (CPE); chlorinated polyvinyl chloride (CPVC); various epoxies (polyepoxides) (including fluorinated epoxies); epichlorhydrin copolymers (ECO); ethylene-propylene-diene terpolymer (EPDM); ethylene-propylene copolymer (EPM); ethylene vinyl acetate copolymer (EVA); ethylene vinyl alcohol (E/VAL); various fluoropolymers (such as polytetrafluoroethylene (PTFE), polytetrafluoroethylene (PCTFE), perfluoroalkoxy polymer (PFA/MFA), fluorinated ethylene-propylene (FEP), tetrafluoroethylene, hexafluoropropylene, vinylidene fluoride and their co-polymers (e.g., THV), polyethylenetetrafluoroethylene (ETFE), polyethylenechlorotrifluoroethylene (ECTFE), various perfluorinated elastomers (FFPM/FFKM), various fluorocarbons including chlorotrifluoroethylenevinylidene fluoride (FPM/FKM), tetrafluoroethylene-propylene (FEPM), perfluoropolyether (PFPE), perfluorosulfonic acid (PFSA), perfluoropolyoxetane, polyvinylfluoride (PVF), polyvinylidene fluoride (PVDF), various fluorosilicone rubbers (vinyl, methyl, etc.), among others); various ionomer-thermoplastic polymers; isobutene-isoprene copolymer (IIR); various liquid crystal polymers (LCP); melamine formaldehyde (MF); natural rubber (NR); phenol-formaldehyde plastic (PF); polyoxymethylene (POM); polyacrylate (ACM); polyacrylic acid (PAA); polyacrylic amide, polyacrylonitrile (PAN); various polyamides (PA) (including various aromatic polyamides often called aramids or polyaramids); polyaryletherketone (PAEK); polybutadiene (PBD); polybutylene (PB); polybutylene teraphtalate (PBTP); polycarbonate (PC); polychloromethyloxirane (epichlorhydrin polymer) (CO); polychloroprene (CR); polydicyclopentadiene (PDCP); polyester (in the form of either thermoplastic or thermoset polycondensate); polyetheretherketone (PEEK); polyetherimide (PEI); various sulfones and their derivatives such as polyethersulfone (PES) and polyphenylsulfone (PPSU); polyethylene (PE); polyethylenechlorinates (PEC); polyethylene teraphtalate (PET); poly(3,4-ethylenedioxythiophene) polystyrene sulfonate (PEDOT:PSS); phenol-formaldehyde (PF); polyimide (PI) (as thermoplastic or thermoset polycondensate); various imides and their derivatives such as polyetherimide (PEI) and polyamide-imide (PAI), among others; polyisobutylene (PIB); polymethyl methacrylate (PMMA); polymethylpentene (PMP); polyoxymethylene (POM); polyketone (PK); polymethylpentene (PMP); polyethylene oxide (PEO); polyphenylene Oxide (PPO); polyphenylene sulfide (PPS); various polyamides and their derivatives, such as polyphthalamide (PTA), among others; polypropylene (PP); propylene oxide copolymer (GPO); polystyrene (PS); polysulfone (PSU); polyester urethane (AU); polyether urethane (PUR); polyvinylalcohol (PVA); polyvinylacetate (PVAc); polyvinyl butyral (PVB); polyvinylchloride (PVC); polyvinyl formal (PVF); polyvinylidene chloride (PVDC); styrene-acrylonitrile copolymer (SAN); styrene-butadiene copolymers (SBR and YSBR); various silicones (SI) (such as polydimethylsiloxanes, polymethylhydrosiloxane, hexamethyldisiloxane, SYLGARD®, various silicone elastomers ((phenyl, methyl) (PMQ), (phenyl, vinyl, methyl) (PMVQ), (vinyl, methyl) (VMQ), etc.); polyisoprene; urea-formaldehyde (UF), among others. In some designs, some of such polymers may be at least partially fluorinated.

In some designs, polymer(s) and/or a co-polymer composition of the electrode binder may comprise at least one of the following monomer constituents: acrylates and modified acrylates (methylacrylate, methylmethacrylate, etc.), diallylphthalates, dianhydrides, amines, alcohols, anhydrides, epoxies, dipodals, imides (polyimides), furans, melamines, parylenes, phenol-formaldehydes, polyesters, urea-formaldehydes, urethanes, acetals, amides, butylene terephthalates, carbonates, ether ketones, ethylenes, phenylene sulfides, propylenes, styrene, sulfones, vinyl, vinyl butyrals, vinyl chlorides, butylenes, chlorobutyls, fluorobutyls, bromobutyls, epichlorohydrins, fluorocarbons, isoprenes, neoprenes, nitriles, sulfides, silicones, among others.

In some designs, conversion-type metal-fluoride comprising electrodes may advantageously comprise one or more elongated conductive additives with aspect ratios in the range from around 5 to around 1000,000 and minimum dimensions (e.g., diameter or thickness) in the range from around 0.25 nm to around 100 nm. In an example, the optimum dimensions of the conductive additives for particular applications may depend on the electrode preparation conditions. Suitable examples of such elongated conductive additive particles may include, but are not limited to, various carbon nanotubes (such as, single-walled, double-walled, multiwalled and their various combinations), carbon nanofibers, metal nanofibers (or nanowires) (such as aluminum nanowires/nanofibers, nickel nanowires/nanofibers, iron nanowires/nanofibers, titanium nanowires/nanofibers, copper nanowires/nanofibers, among others, selected depending on the cell operating potential and electrolyte composition), carbon ribbons, conductive carbide nanofibers or nanowires or nanoribbons (e.g., made of conductive titanium carbide), conductive nitride nanofibers or nanowires or nanoribbons, electrically conductive oxide nanofibers or nanowires or nanoribbons, among others. In some designs, the one or more conductive additives may exhibit dendritic shape. In some designs, the one or more conductive additives may exhibit flake-like (platelet-like) shape. In some designs, the one or more conductive additives may comprise nanopores (e.g., from around 0.2 nm to around 100 nm in size). In some designs, the one or more conductive additives may comprise a thin (from around 0.2 nm to around 20 nm) surface layer (e.g., an oxide or nitride or carbide, etc.) deposited in order to enhance their electrochemical or mechanical stability or to enhance electrolyte wetting or to achieve other electrode-level or cell-level performance benefits. In some designs, the one or more conductive additives may be deposited onto or grown onto or chemically attached onto the surface of conversion-type fluoride cathode particles.

In some designs, one or more binders of similar composition, properties and shape to those described above as well as one or more conductive additives of similar composition, properties and shape to those described above and their various combinations may also be advantageously used for other conversion-type cathodes as well as for conversion-type (including alloying-type) anodes (such as Si-containing anodes, among others).

In some designs, binders of similar composition, properties and shape to those described above as well as conductive additives of similar composition, properties and shape to those described above and their various combinations may be advantageously used for intercalation-type cathodes and anodes, particularly those that incorporate solid electrolyte compositions, including those introduced by melt-infiltration method.

In some designs in the context of the present disclosure, it may be advantageous for the separator membrane between the anode and cathode to comprise ceramic (e.g., oxide) material in order to enhance mechanical (or thermal) properties of the cell during its construction or operation. In some designs, the fraction of ceramic material in the separator membrane may range from around 1 w. % to around 100 wt. % as a fraction of the membrane mass. In some designs, the separator membrane may be porous and impregnated with a suitable (e.g., liquid or solid) electrolyte. In some designs, such a porous separator may comprise fibers or nanofibers (e.g., about 1-100 wt. % relative to the all the solid material in the separator prior to electrolyte filling). In some designs, such fibers or nanofibers may be porous. In some designs, such fibers or nanofibers may be (or may comprise) ceramic fibers or nanofibers. In some designs, such fibers or nanofibers may be chemically bonded to at least some of their respective neighboring fibers or nanofibers. In some designs, a ceramic portion of the separator may comprise aluminum oxide or magnesium oxide or zirconium oxide or zinc oxide. In some designs, the separator may comprise oxide fibers or nanofibers. In some designs, a porous separator may exhibit a core-shell morphology. In some designs, such a porous separator may be coated with the surface (shell) layer via a vapor deposition technique (e.g., ALD or CVD) or a suitable solution-deposition technique (e.g., sole-gel, spay-drying, layer-by-layer deposition, electroless deposition, etc.). In some designs, such a coating may comprise a thin (e.g., an average thickness between about 1-100 nm) ceramic layer (e.g., an oxide comprising Al, Zn, Zr, Mg, Na, Li or another suitable metal). In some designs, the surface layer may enhance electrolyte wetting. In some designs, at least a portion of such a surface layer may exhibit the same composition as a porous surface layer in the anode or cathode or both. In some designs, the surface (shell) layer may form or be modified upon reaction with an electrolyte. In some designs, at least a portion of the separator may be deposited into an anode or cathode or both prior to cell assembling or prior to surface layer deposition.

In some designs in the context of the present disclosure, it may be advantageous for the (e.g., metal) current collector(s) for the cathode or anode or both to comprise pores. In some designs, the total pore volume may range from around 1 vol. % to around 50 vol. %. In some designs, at least a portion of such pores (e.g., around 25% or more) may be interconnected. Multiple favorable design considerations may be enabled by the presence of such pores in certain applications. For example, such pores may further reduce the weight of the current collectors (e.g., the weight of Cu in the anode) which is particularly substantial for lightweight conversion-type electrodes. In some designs, such pores may be infiltrated with a solid electrolyte during cell assembling and enhance mechanical robustness of the cell. In some designs, such pores may improve adhesion of the electrode to the current collector. In some designs, such pores may enable faster infiltration of the precursor molecules during the deposition of the surface layer onto the electrode(s). In some designs, such pores may relieve some stresses during cycling of conversion-type electrodes. In some designs, such pores may enable Li diffusion across the electrode/separator/electrode stacks (e.g., in order to provide active Li to the cell or to replenish lost Li in a cell). In some designs, it may be advantageous for the (e.g., metal) current collector(s) for the cathode or anode or both to comprise fibers or nanofibers. In some designs, such fibers may comprise polymer or carbon (e.g., such as carbon nanotubes). In some designs, such fibers may enhance mechanical properties of the current collector or improve adhesion of the electrode(s) to the current collector or provide other cell performance benefits.

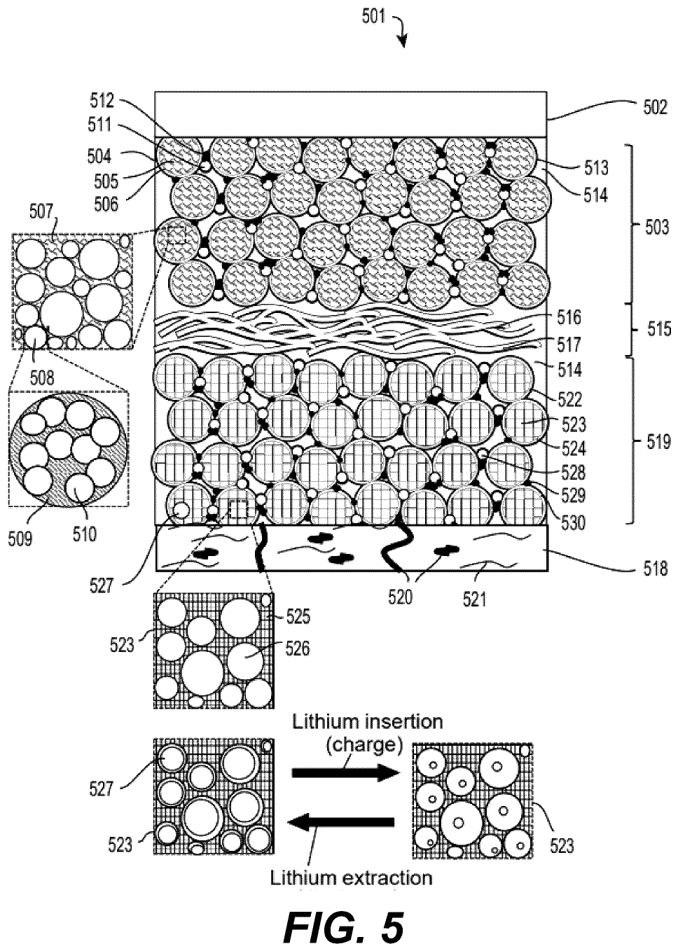

FIG. 5 illustrates examples of an architecture for an exemplary Li-ion or Li metal cell components and a cell that comprises conversion-type electrode(s) in accordance embodiments of the present disclosure. Here several described embodiments are combined in one cell design for illustrative purposes, although it will be appreciated that the particular combination of elements depicted in FIG. 5 need not be used in combination with each other in other embodiments. In particular, FIG. 5 illustrates a building block (e.g., an arrangement comprising cathode current collector/cathode/separator/anode/anode current collector) 501 that comprises a cathode current collector 502 coated (by a suitable technique) with an active cathode layer 503 of suitable composition. The cathode layer 503 may comprise, for example, suitable (for example, composite including core-shell) conversion-type composite cathode particles 504 of suitable size. Such particles may, for example, comprise a core 505 and a protective shell 506 of suitable compositions, morphologies and properties. The core 505 of such particles 504 may, for example, be a composite comprising conductive matrix material 507 and a suitable active material 508. The active material 508 may, for example, be also a composite comprising, for example, LiF 509 and suitable metal clusters 510. In other designs, the active material 508 may comprise, for example, Li₂S. The cathode layer 503 may also comprise a suitable binder 511 and suitable conductive additives 512. The current collector 502 and the cathode layer 503 may be coated with another functional surface layer 513, which may, for example, improve the interface (or interphase) with a suitable electrolyte 514 filling (in some designs, impregnated into) pores of the cathode layer 503 by a suitable technique. In some designs, the electrolyte 514 may comprise a solid electrolyte exhibiting suitable composition and properties. The building block 501 also comprises a suitable separator layer 515, which may comprise a suitable porous separator membrane 516 impregnated by the same electrolyte 514. The separator membrane 516 may comprise fibers or nanofibers 517 of suitable composition, morphology and properties. The building block 501 also comprises a suitable anode current collector 518 coated (by a suitable technique) with an anode layer 519 of suitable composition. The anode current collector 518 may, for example, comprise pores 520 and/or embedded fibers 521 of suitable composition. The anode layer 519 may comprise suitable active material particles 522 of suitable composition, morphology and architecture. The anode active material particles 522 may, for example, comprise a core 523 and a protective shell 524. The core 523 of the anode active material particles 522 may, for example, be a composite comprising conductive matrix material 525 and a suitable active material 526. In some designs, the active material 526 may, for example, comprise Li metal or Li alloy (for example, a Li—Si alloy). In some designs, the building block 501 may be assembled in such a way that all or substantially all of the cyclable Li in a cell is initially comprised in the cathode particles 504. In this case, Li may be deposited or inserted into the anode active material particles 522 during the first charge. In this case, the anode active material particles 522 may initially comprise pores 527 to provide space for Li insertion during charge. Some (e.g., preferably very small) portion or fraction of the pores 527 may remain after Li insertion. The anode layer 519 may also comprise a suitable binder 528 and suitable conductive additives 529. The anode current collector 518 and the anode layer 519 may be coated with another functional surface layer 530 by a suitable technique, which may, for example, improve the interface (or interphase) with a suitable electrolyte 514 impregnated into the pores of the anode layer 519 by a suitable technique. In some designs, the electrolyte 514 in the anode layer 519 may be the same as the electrolyte 514 impregnated into the cathode layer 503 and the separator layer 515. In some designs, the electrolyte 514 in the cathode layer 503, the separator layer 515 and/or the anode layer 519 may be a solid electrolyte exhibiting suitable composition and properties. In some designs, the areal capacity loading on the anode layer 519 may, for example, range from around 2 mAh/cm² to around 12 mAh/cm². In some designs, the areal capacity loading on the cathode layer 503 may, for example, range from around 2 mAh/cm² to around 12 mAh/cm². In some designs, the average thickness of the anode current collector 518 and the cathode current collector 502 may range, for example, from around 5 μm to around 15 μm. In some designs, the average thickness of the separator layer 515 may range, for example, from around 1 μm to around 15 μm. In some designs, the average thickness of the cathode layer 503 may range, for example, from around 20 to around 200 μm. In some designs, the average thickness of the anode layer 519 may range, for example, from around 20 to around 200 μm. In some designs, the volume fraction of the electrolyte 514 within the cathode layer 503 may range, for example, from around 8 to around 40 vol. % (as a fraction of the total volume of the cathode layer 503). In some designs, the volume fraction of the electrolyte 514 within the anode layer 519 may range, for example, from around 8 to around 40 vol. % (as a fraction of the total volume of the layer 519).

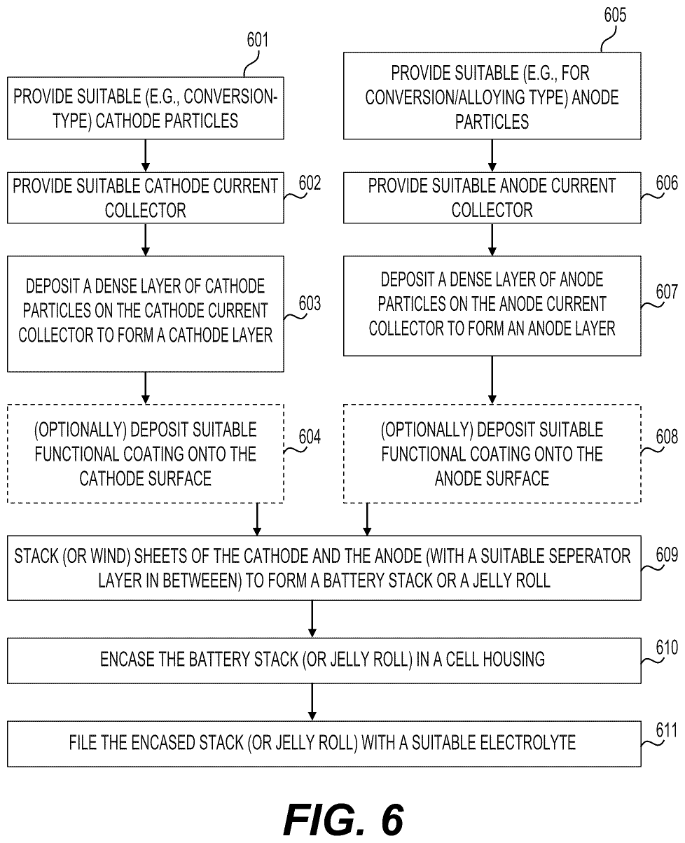

FIG. 6 illustrates an example of a process that may be involved in constructing a cell comprising conversion-type electrodes, such as composite cathode particles comprising mixed metal (M) and LiF materials, in accordance embodiments of the present disclosure. Suitable (e.g., composite) cathode particles are provided (601), a suitable cathode current collector is provided (602) and the suitable cathode particles are then deposited onto the cathode current collector (603) by a suitable technique to form a densely packed cathode layer (in some designs, the deposited layer can be further densified/calendared). In some designs, binder and conductive additives may be added into the cathode layer to form a well-adhered and sufficiently conductive cathode layer. A surface of the produced cathode may then be optionally coated (e.g., at least partially) with a functional coating to form a functional layer (604) by a suitable technique (e.g., ALD). In some designs, a porous separator layer or a portion of the porous separator layer may be deposited onto the surface of the cathode before or after the functional layer formation. Before, during or after 601-604, (e.g., composite) anode particles are provided (605), a suitable anode current collector is provided (606) and the suitable anode particles are then deposited onto the anode current collector (607) by a suitable technique to form a densely packed anode layer (in some designs, the deposited layer can be further densified/calendared). In some designs, binder and conductive additives may be added into the anode layer to form a well-adhered and sufficiently conductive anode layer. A surface of the produced anode may then be optionally (e.g., at least partially) coated with a functional coating to form a functional layer (608) by a suitable technique (e.g., ALD). Then, the sheets of the cathode and the anode (with a suitable separator layer in between) are stacked or wounded to form a battery stack or a jelly roll (609), encased in a cell housing (610), filled with a suitable electrolyte by a suitable technique (611), and eventually sealed to form a battery cell.

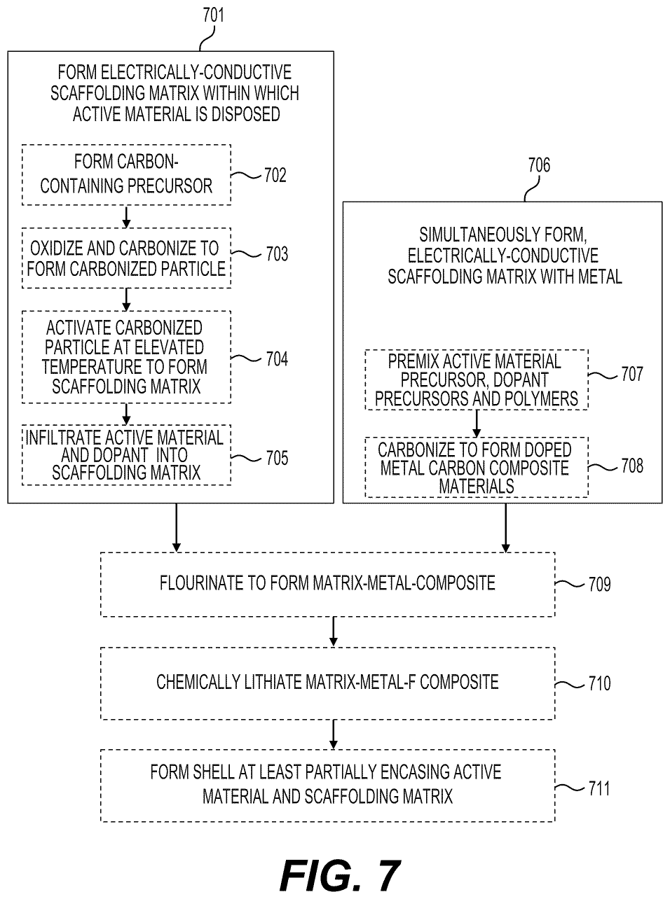

FIG. 7 is a flowchart illustrating an example method of fabricating cation doped conversion cathode materials according to various example embodiments. In this example, an active material is provided to store and release ions during battery operation. As discussed above, the storing and releasing of the ions may cause a substantial change in volume of the active material. Accordingly, a porous, electrically-conductive skeleton (scaffolding) matrix is provided within which the active material may be disposed. As also discussed above, the scaffolding matrix structurally supports the active material, electrically interconnects the active material, and accommodates the changes in volume of the active material.

The scaffolding matrix may be formed in a variety of ways. In one example illustrated here (process 701), the scaffolding matrix may be formed by forming a carbon-containing precursor (optional block 702), oxidizing (e.g., to increase carbonization yield) and carbonizing the carbon-containing precursor to form a carbonized particle (optional block 703), and activating the carbonized particle at elevated temperature to form the scaffolding matrix (optional block 704). Forming the scaffolding matrix may further comprise infiltration of the active material into the scaffolding matrix (optional block 705), which may be performed by (i) chemical vapor deposition, (ii) solution infiltration followed by solvent evaporation, (iii) solution infiltration followed by solvent evaporation and annealing, (iv) solution infiltration followed by precipitation during nonsolvent addition, (v) sol-gel, (vi) vapor infiltration, (vii) atomic layer deposition, (viii) electroplating, (ix) melt infiltration, or other techniques described herein. As an alternative process (process 706), metal salts, dopant salts, and a polymer can be premixed (optional block 707). The resulting mixture can then undergo carbothermal reduction to produce a composite material comprising cation doped metal and carbon matrix (optional block 708). After generating matrix-M composite materials through either process 701 or 706, the intermediate material can undergo fluorination (block 709), followed by chemical lithiation (block 710), and ultimately sealed (block 711). In some embodiments, the matrix-M-F composite materials can be chemically lithiated after the sealing at block 711.

### Example 1: Synthesis of Composite Materials Comprising Metal Oxide Sealed and Cation Doped Matrix-M-LiF (or, More Broadly, Metal Oxide-Sealed and Cation Doped LiF-M-MFx-LiMFy)

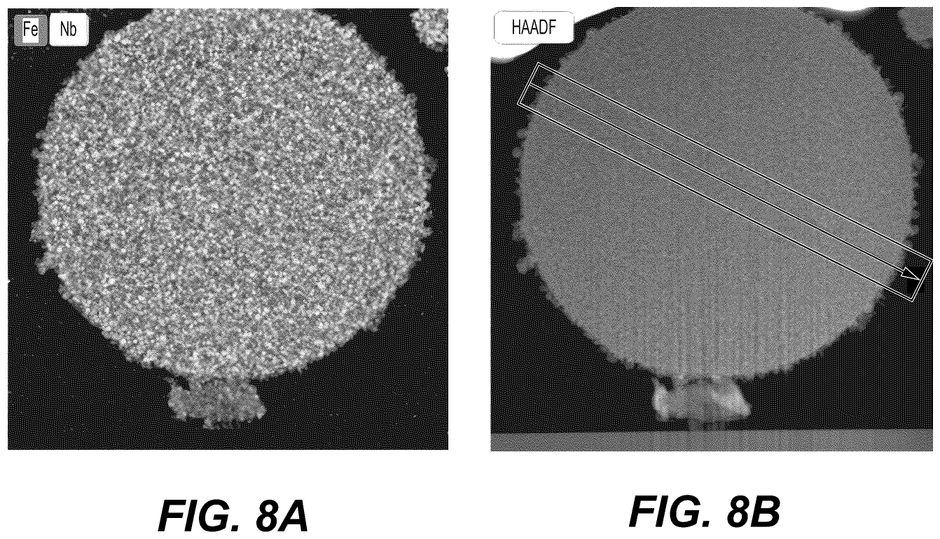

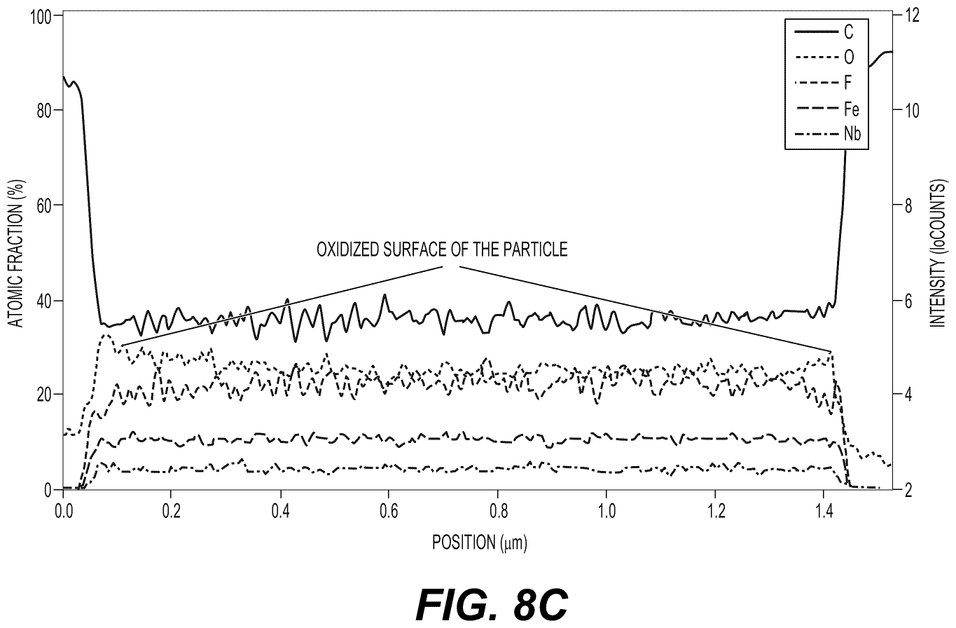

Utilizing a vapor phase synthesis approach, composite materials containing cation-doped metal fluorides were synthesized. A Fe precursor was deposited into porous carbon scaffolds using a metal organic chemical vapor deposition (MOCVD) process. The introduction of a dopant precursor may occur in a simultaneous or sequential manner, resulting in doped Fe-carbon composite materials. The reaction temperature for the MOCVD deposition step varied depending on the selected metal and dopant precursors, but typically remained below about 300° C. Subsequently, the resultant composite material was subjected to fluorination using NF₃ at a temperature of about 280° C., yielding cation-doped matrix-M-F materials, where the metal M is fully or at least partially fluorinated and the scaffolding matrix may also be partially fluorinated. Note that both matrix and the metal fluoride may comprise a small amount of oxygen (e.g., about 0-5 wt. %), in some designs. The final sealing step entailed MOCVD deposition of a metal oxide using a suitable precursor to uniformly enclose the composite particles in a protective shell. Note that the deposition of the protective metal oxide shell may induce (e.g., additional) incorporation of small amounts of oxygen atoms (e.g., about 0-5 wt. %) into the composite core. The produced material may be further lithiated to produce the metal oxide-sealed and cation doped LiF-M-LiMFx (nano) composite cathode. FIGS. 8A through 15 show characterizations of certain embodiments of the present invention.

FIG. 8A illustrates an example cross sectional energy-dispersive X-ray spectroscopy-scanning transmission electron microscopy (EDS-STEM) of Nb-doped FeF₃ carbon (nano) composite material. In some designs, it may be advantageous that the doping is uniformly (evenly) distributed across the bulk of the composite cathode particles. FIG. 8B shows a high-angle annular dark-field scanning transmission electron microscopy (HAADF-STEM) image of the produced example composite. FIG. 8C shows a STEM-EDS line scan across the example composite materials. The five different lines show the distribution of each element along the line traversing a spherical particle. The cross sectional analysis shows FeF₃ is evenly doped with Nb throughout a nanocomposite. A porous carbon scaffold may facilitate intimate contact between Nb—Fe, LiF, LiFeNbyFx and the conductive in the composite particles, which may enhance the kinetics of the conversion reaction. Further, the unoccupied nanopores within the carbon scaffold may accommodate the metal composite's volume changes during subsequent lithiation or charge and discharge cycles during battery operation.

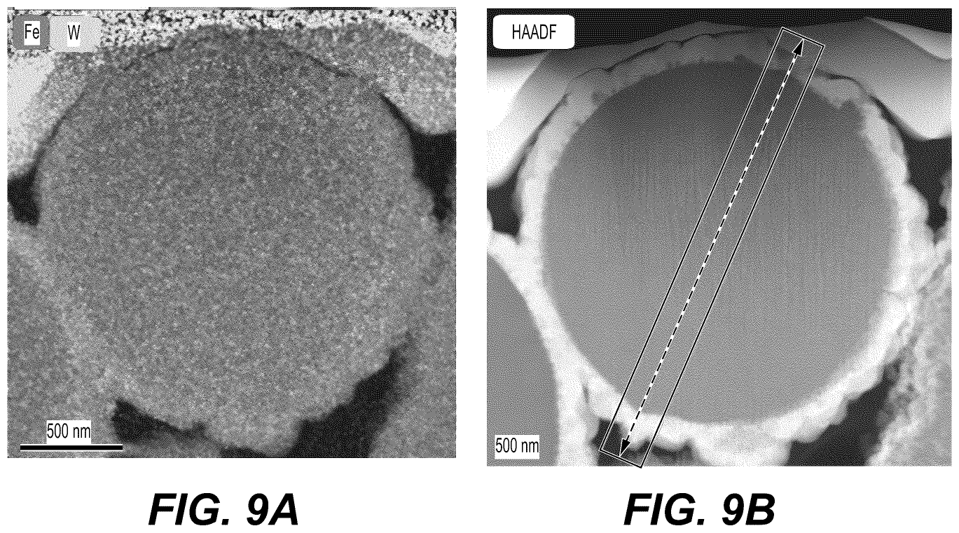

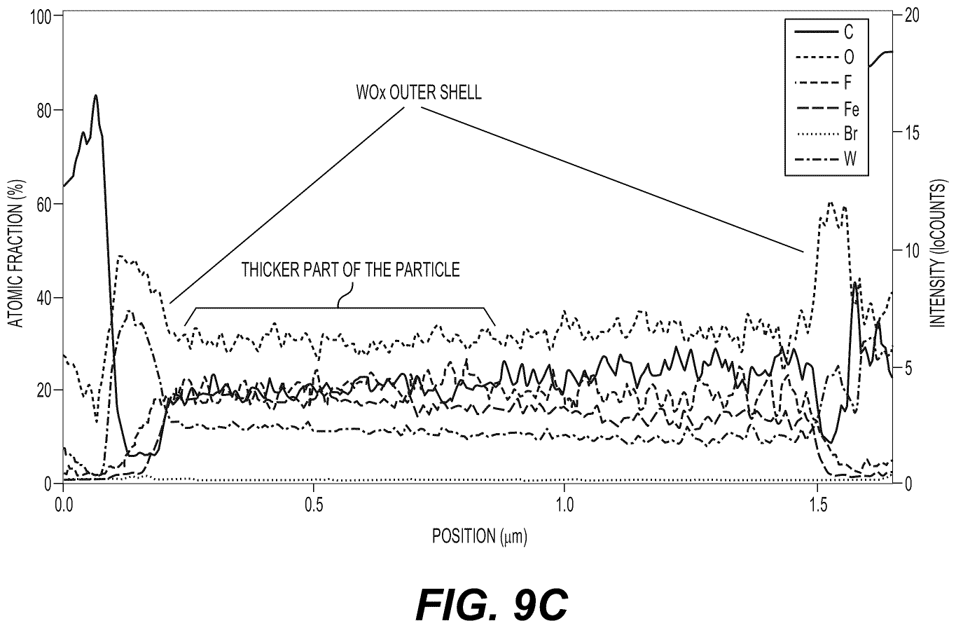

FIG. 9A illustrates an example cross sectional EDS-STEM of the sealed nanocomposite particle produced according to this disclosure; an inner circle designates the Fe-comprising cores, while the outer shell indicates the presence of the WO₃ sealing shell layer. FIG. 9B shows an image captured through HAADF-STEM, which reveals the conformal sealing of the active material. In FIG. 9C, a STEM-EDS line scan is presented, illustrating the elemental distribution across the (nano) composite materials. The five distinct lines depict the presence of each element along the line spanning a spherical particle as depicted in FIG. 9B.

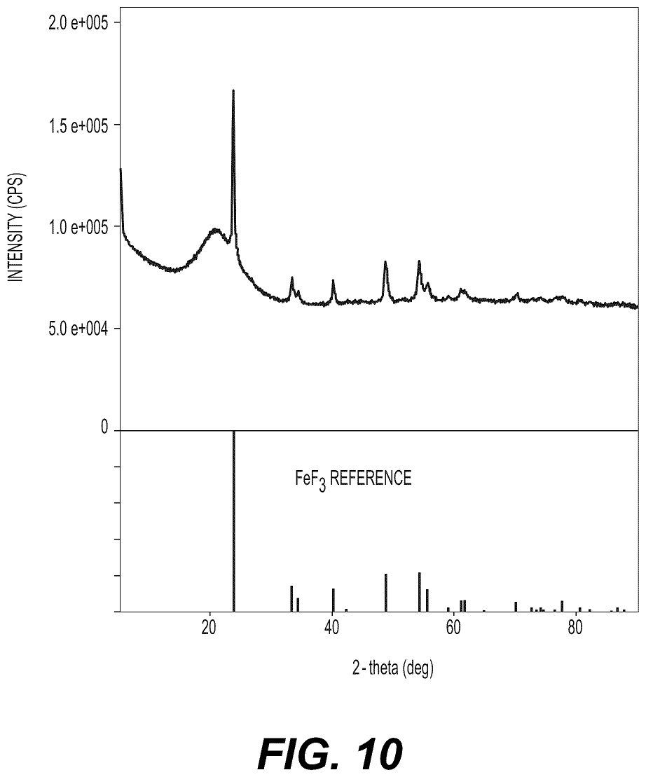

FIG. 10 illustrates x-ray diffraction (XRD) patterns of the example Zr-doped FeF₃ carbon matrix nanocomposite materials.

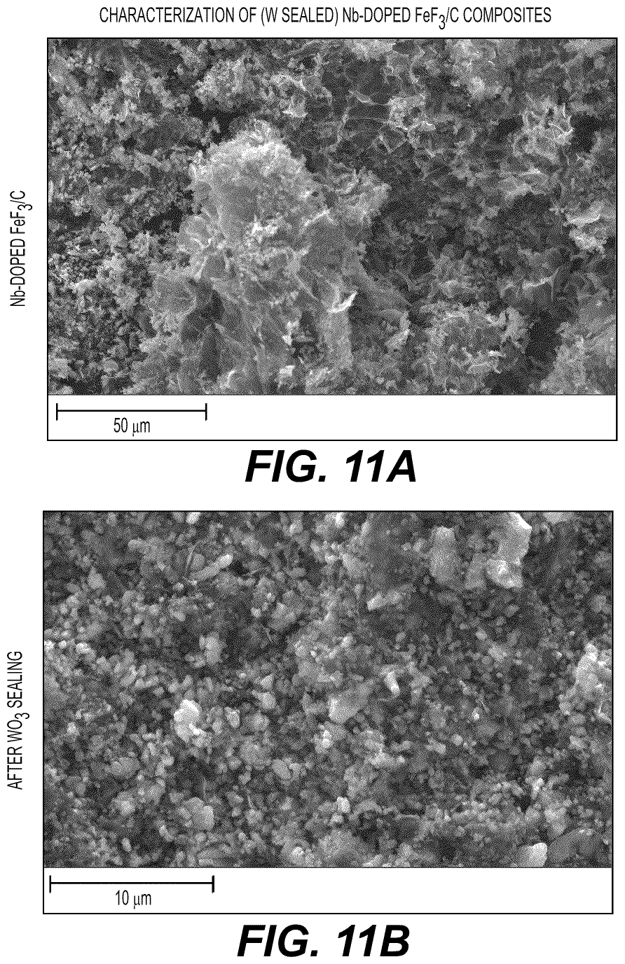

FIGS. 11A and 11B illustrate SEM images of example Nb-doped FeF₃ carbon composite materials before and after WO₃ sealing, which may be utilized in some example embodiments of this invention.

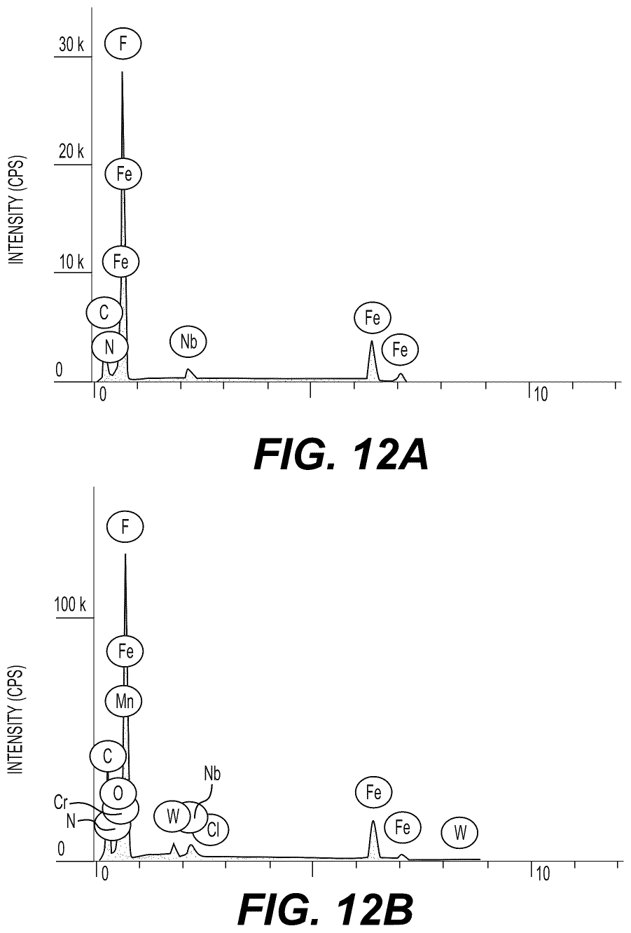

FIG. 12A illustrates the EDS of the example Nb-doped FeF₃ carbon matrix nanocomposite materials and FIG. 12B illustrates the EDS of WO₃ sealed Nb-doped FeF₃
carbon matrix nanocomposite materials.

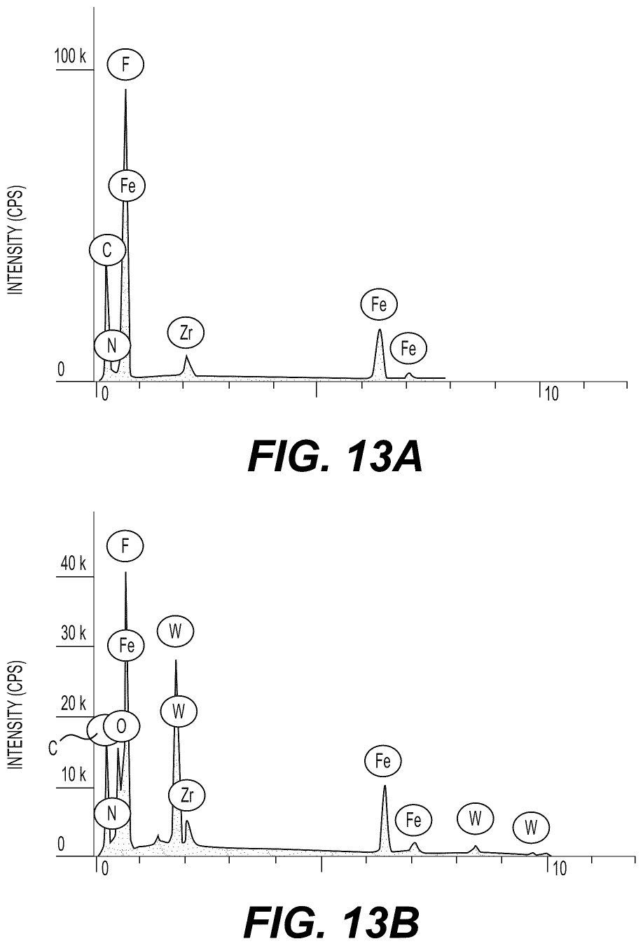

FIG. 13A illustrates the EDS of the example Zr-doped FeF₃ carbon matrix nanocomposite materials and FIG. 13B illustrates the EDS of the example WO₃-sealed Zr-doped FeF₃ carbon matrix nanocomposite materials.

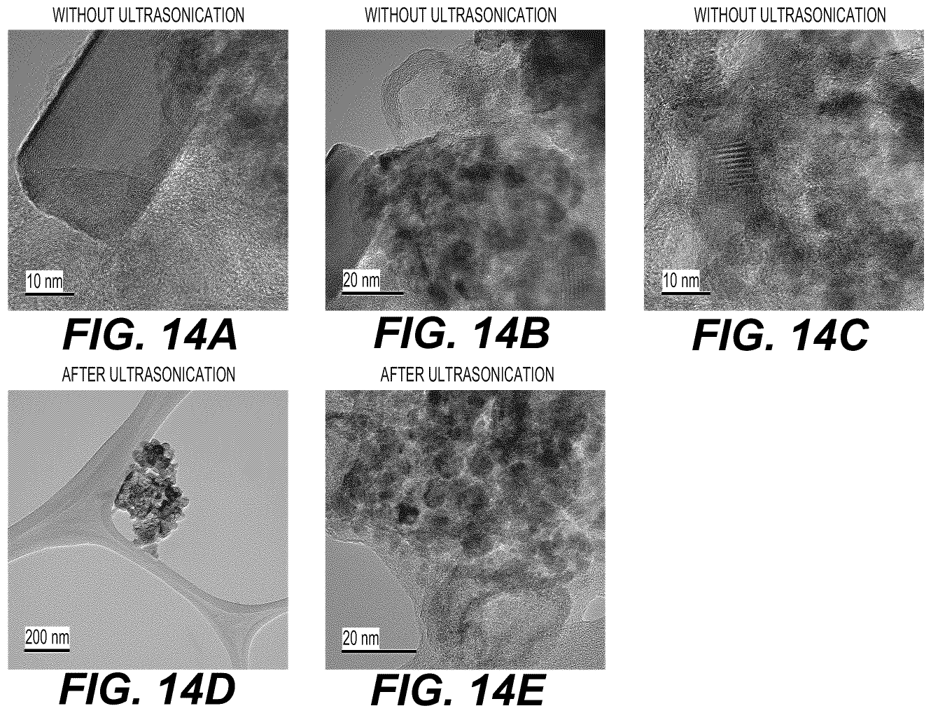

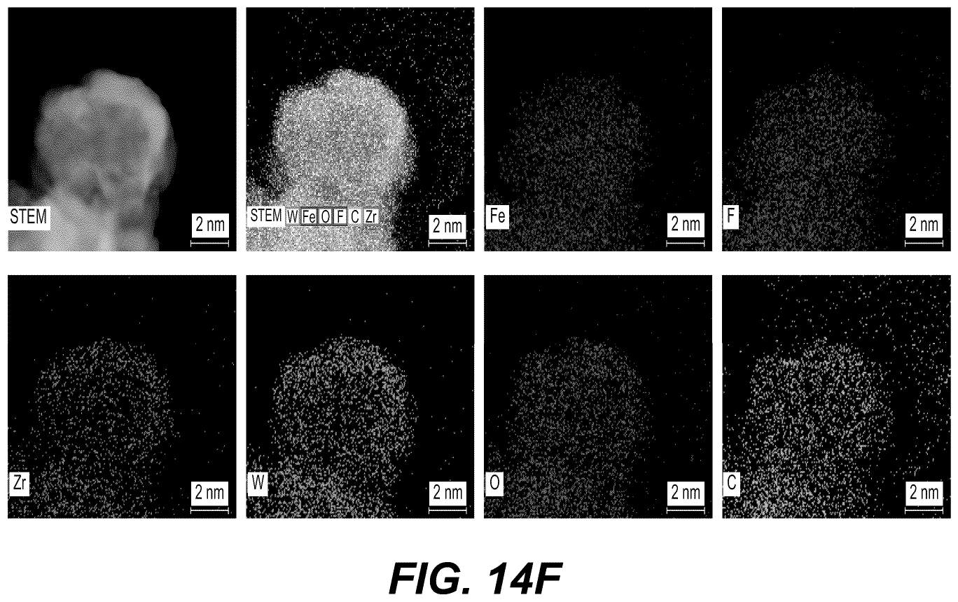

In some designs, it may be advantageous for the distribution of elements within the nanocomposite cathode particles to be rather uniform at the 100-1000 nm scale, as revealed by EDS. Both uniform doping and uniform sealing may be highly advantageous for superior stability in some battery applications. FIGS. 14A-14F provide transmission electron microscopy (TEM) images of the example Zr-doped carbon matrix-containing nanocomposite iron fluoride-based cathode material after WO₃ sealing at different magnification. FIGS. 14A through 14C reveal agglomeration of the particles. After ultrasonication (FIGS. 14D and 14E), the sample was better dispersed and smaller clusters and crystalline domains were revealed (5-10 nm). STEM-EDS mapping of a single nanocomposite particle (size of approximately 400 nm) illustrates a very homogeneous (uniform) distribution of Fe, F, Zr, W, O and C within the nanocomposite particle (FIG. 14F).

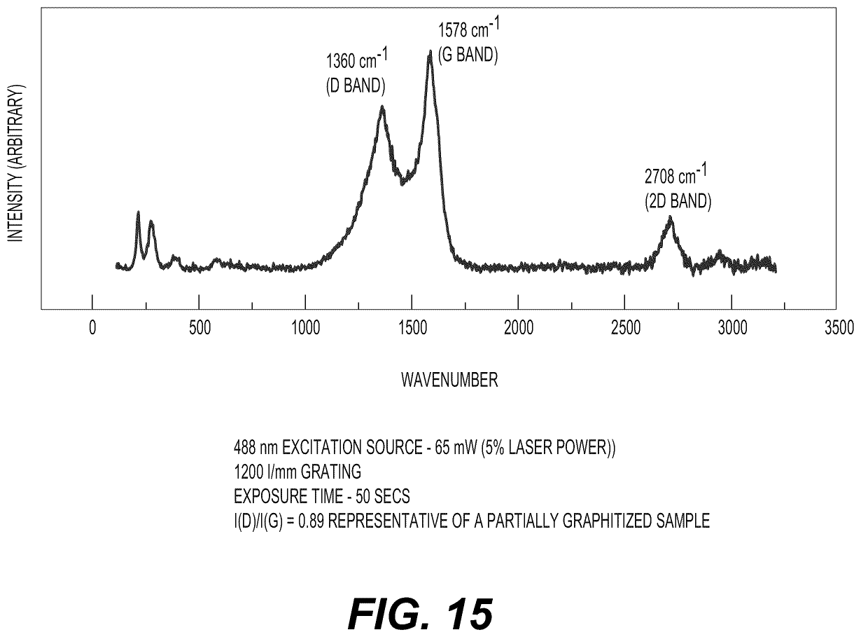

FIG. 15 shows the Raman spectrum (recorded using 488 nm wavelength) of the illustrative WO₃-sealed Zr-doped iron fluoride-carbon matrix-containing nanocomposite. D band of carbon (1360 cm⁻¹), G band of carbon (1578 cm⁻¹), 2D band of carbon (2708 cm⁻¹) and D+G band of carbon (2950 cm-1) bands are clearly visible, evidencing the partial graphitization of the sample (I_{D}/I_{G}=0.89). In some designs, it may be advantageous for the carbon in the composite to exhibit certain microstructure for optimal performance. Such a micro-structure may be revealed by the ratio of various carbon peak heights, full width at half maximum (FWHM) of the carbon peaks as well as the position of the peaks. For example, it may be preferable for the I_{D}/I_{G} to range from about 0.5 to about 2.1 (in some designs, from about 0.5 to about 0.8; in other designs, from about 0.8 to about 1.2; in other designs, from about 1.2 to about 2.1).

Note that Raman peaks at 215 cm-1, 278 cm-1, 389 cm-1 and 587 cm-1 are related to Raman modes of α-Fe₂O₃ nanoparticles, indicating their presence in this particular sample example.

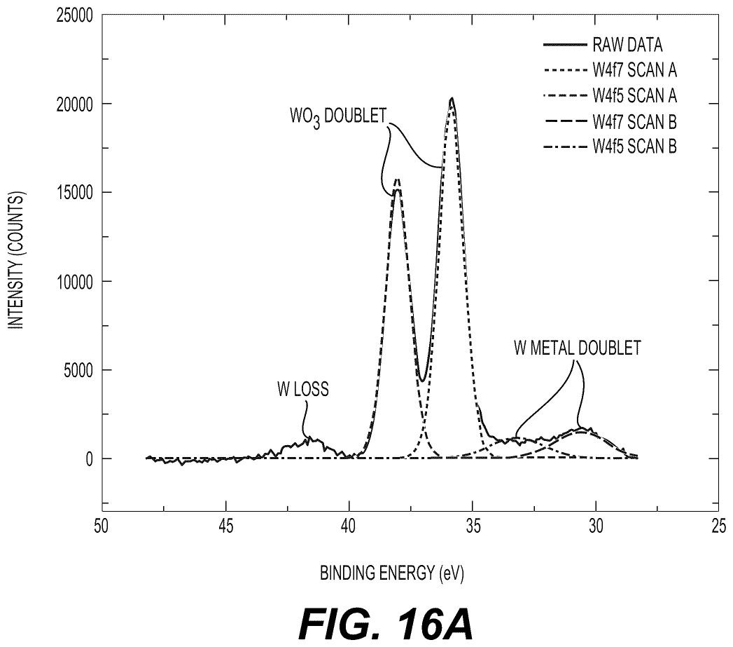

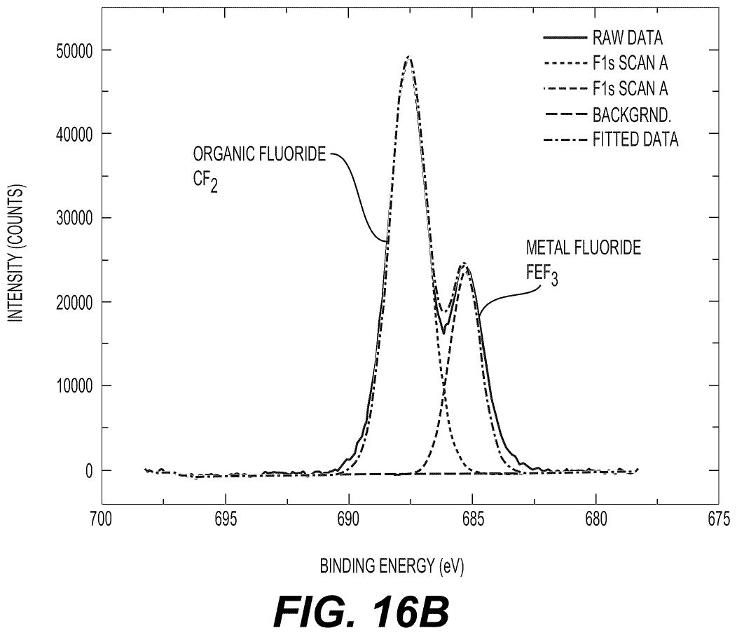

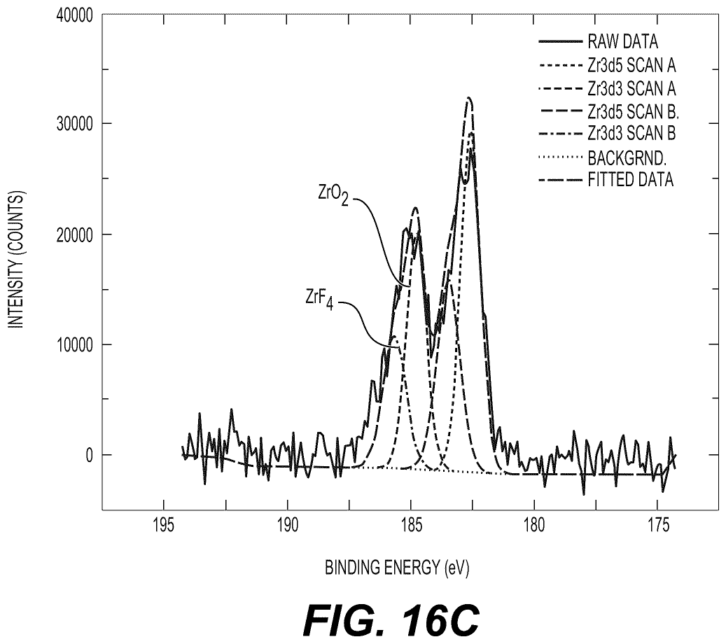

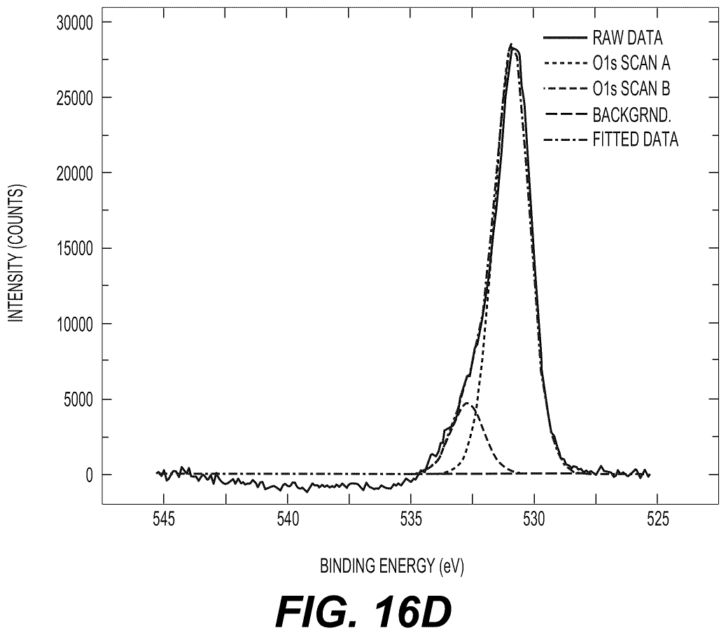

FIGS. 16A-16D illustrate X-ray photoelectron spectroscopy (XPS) data for the surface of the example WO₃-sealed Zr-doped iron fluoride-based, carbon matrix-containing nanocomposite cathode particles for W 4f, F 1s, Zr 3d and O 1s regions. WO₃, together with a small fraction of metallic W, are revealed (FIG. 16A) in the W 4f region. The F 1s region (FIG. 16B) is deconvoluted with two main components related to the organic fluorinated binder and to FeF₃. ZrF₄ and ZrO₂ are present at the surface of the composite (FIG. 16C). The O 1s region presents two components related to adsorbed O/contamination and to metal oxides (FIG. 16D).

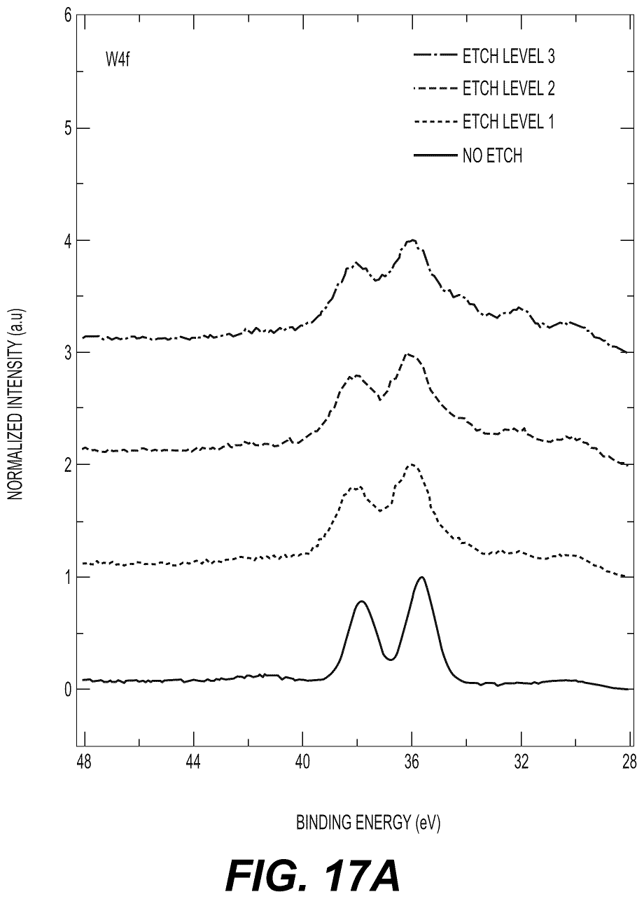

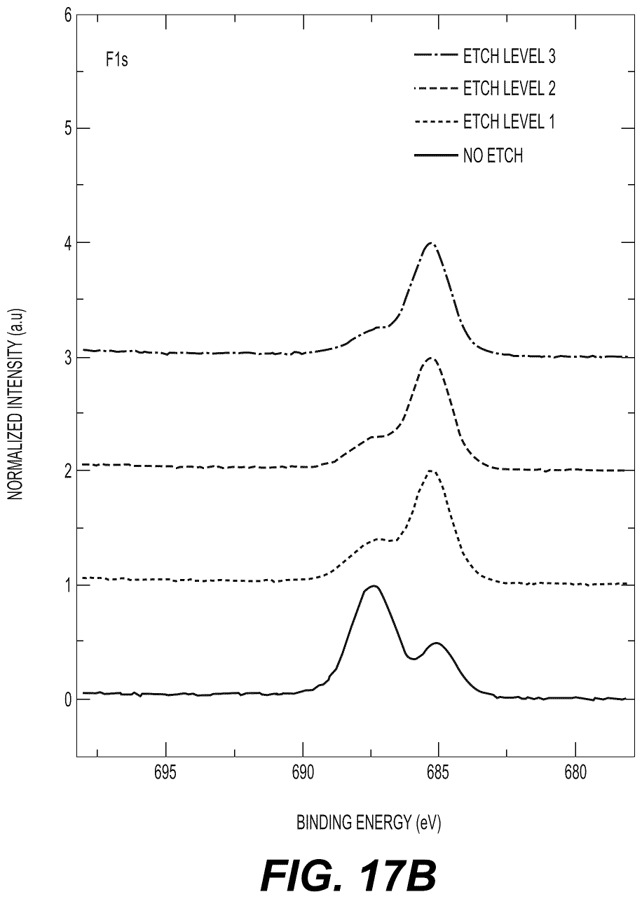

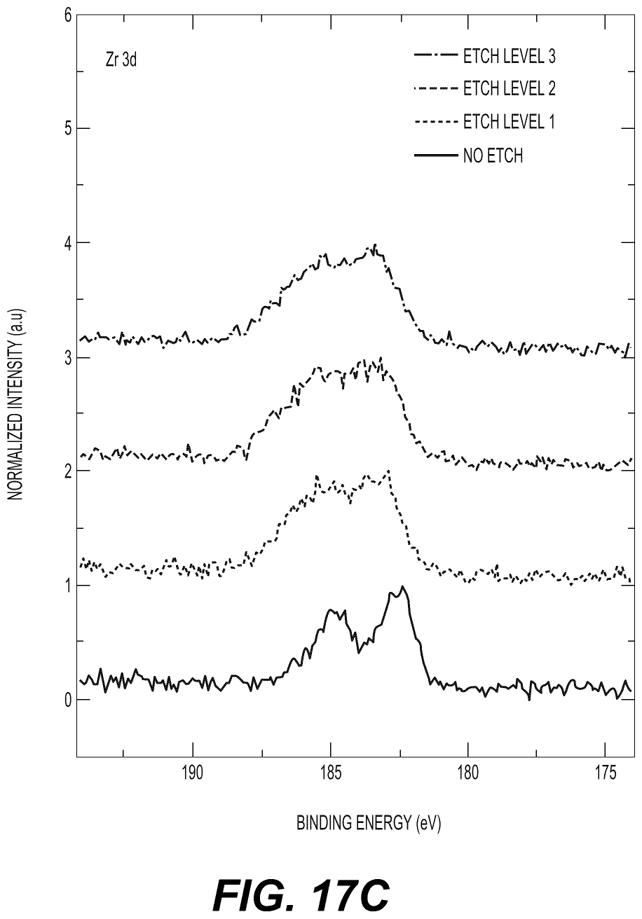

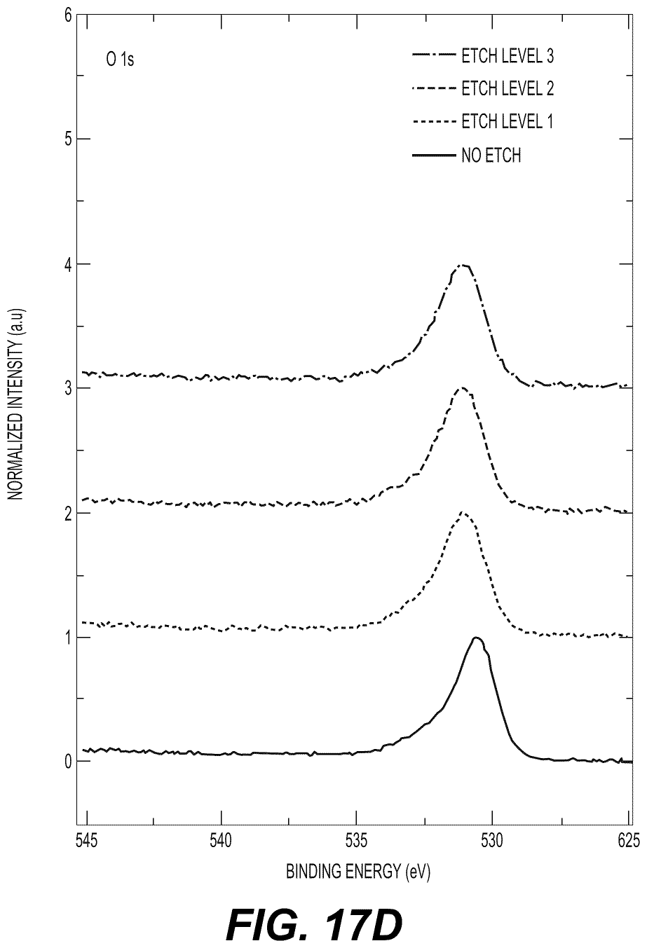

FIGS. 17-17D show XPS depth profile analysis for the example WO₃-sealed Zr-doped iron fluoride-based, carbon-containing nanocomposite cathode for W 4f, F 1s, Zr 3d and O 1s regions. The stack plots represent different surface etching time (bottom: before etching-top: increasing etching time) for all regions. WO₃ is presented at the surface of the sample as well in the subsurface/bulk region (FIG. 17A), illustrating the sealing penetration into the bulk of the porous nanocomposite for superior stability and overall performance. The Ar sputtering procedure partially reduced WO₃ as evidenced by the increase in the reduced W components. The F 1s component for the fluorinated binder significantly decreases with etching time while the fraction of FeF₃ increases towards the bulk region (FIG. 17B). The analysis of the Zr 3d region revealed that ZrO₂ is located at the surface region of the material (FIG. 17C). Sputtering clearly evidenced the presence of ZrF₄ in the subsurface/bulk region. Ar sputtering removes the O 1s components related to surface contamination of the composite material (FIG. 17D). The shift of the maximum of the peak is related to the change in W 4f region.

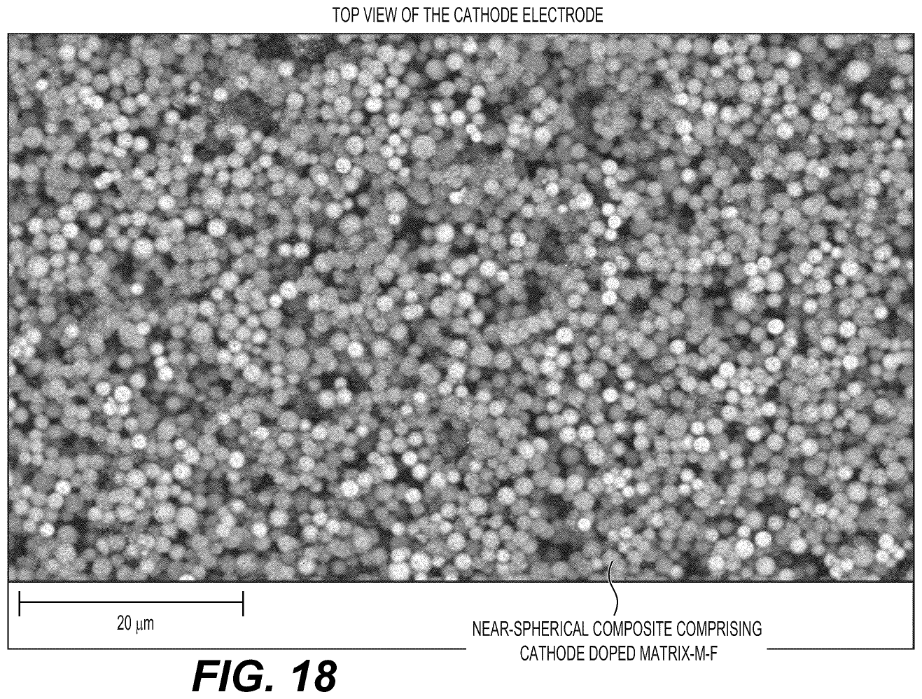

FIG. 18 provides a top view SEM image of the example nanocomposite iron-fluoride-based cathode electrode. This electrode was fabricated using Nb-doped FeF₃ carbon matrix-comprising composite materials sealed with WO₃, a process detailed in FIG. 7 under the process 701. Specifically, the cathode electrodes were fabricated through the formulation of a cathode slurry comprising 94% by weight of cathode active material, 3% of PVDF binder, and 3% of conductive additives. The PVDF binder was dissolved in N-methylpyrrolidone (NMP), after which the active material and conductive additives were dispersed within the polymer solution utilizing a planetary mixer. Subsequently, the resulting slurry was applied onto an aluminum foil using a Doctor blade technique, followed by drying in a 60° C. oven overnight. Upon completion of the drying process, the cathode electrode underwent calendering at a pressure of 6 tons/cm² before being assembled into the battery.

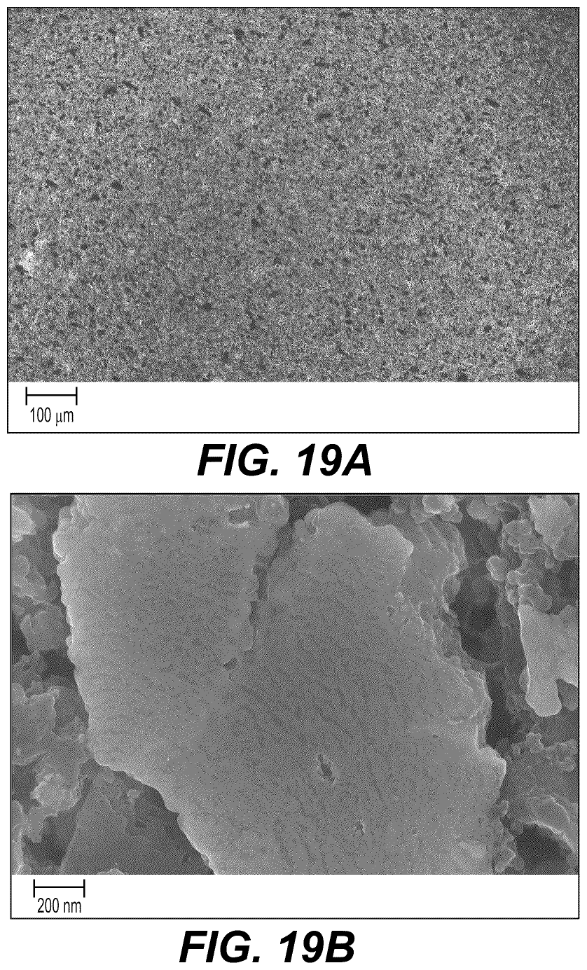

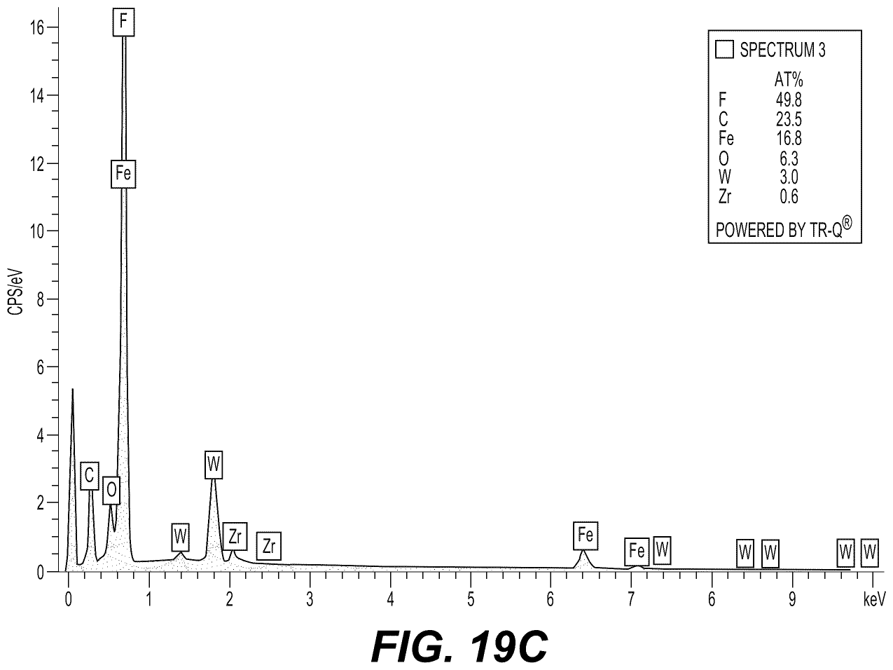

FIG. 19A provides a low resolution SEM image of the example coated electrode and FIG. 19B provides a cross sectional high resolution SEM image of WO₃ sealed Zr doped FeF₃ composite materials prepared by process 706 described in FIG. 7. FIG. 19C provides EDS of the active material particle, the elemental composition of the active material. In this specific instance, FeF₃ is doped with 3.5 at. % of Zr.

### Example 2. Chemical Lithiation of the Metal Fluoride-Based Nanocomposite Cathode Materials

Lithiated matrix-M-F composites were prepared via treatment of nanocomposite {matrix-M-F} materials (with and without metal oxide sealing layer) with reducing organo-lithium species in ethereal solvent. The reducing organo-lithium reagent was produced in-situ prior to, or after combining with the {matrix-M-F} composites or coatings. Reactions were carried out under inert conditions at room temperature using a molar excess of lithiation reagent (>3:1 molar Li reagent/Fe). The extent of lithiation was controlled by selecting organo-lithium reagents with the appropriate standard reduction potential. After the reaction reached completion, the solids or coatings were collected via filtration and washed several times with degassed, anhydrous ethereal solvents to remove residual reagent or reagent products. Lithiated matrix-M-F materials and coatings were then dried under vacuum for up to 24 hours.

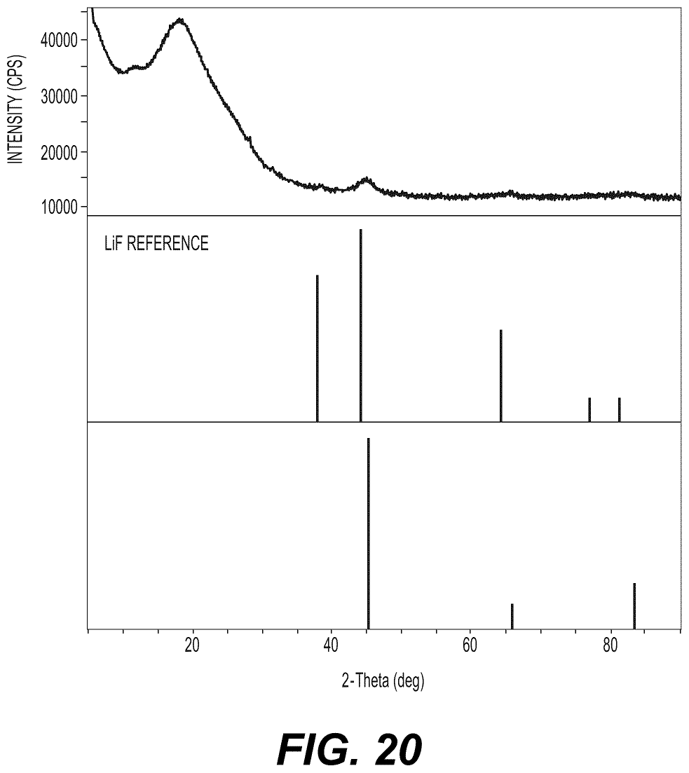

FIG. 20 provides a powder XRD pattern of a {matrix-M-F} composite material that was chemically lithiated with an excess of lithium naphthalenide.

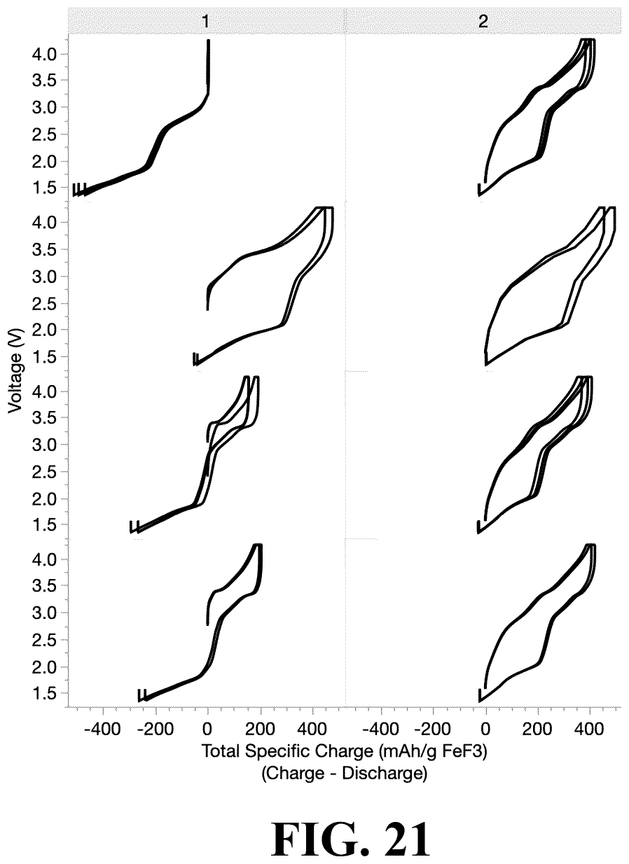

FIG. 21 illustrates the first and second cycles of chemically lithiated matrix-M-F composite coatings in coin cells vs. Li/Li⁺. The chemical lithiation reagent used for each row of data in descending order from top to bottom is as follows: no chemical lithiation (control), lithium benzophenone ketyl, 3,3′-bis(trifluoromethyl)benzophenone ketyl, and 3,3′5,5′-tetrakis(trifluoromethyl)benzophenone ketyl.

### Example 3: Electrochemical Tests of Cells with Metal Oxide Sealed, Cation Doped, Matrix-Metal Fluoride-Based Nanocomposite Cathode Materials

Each battery cell was assembled inside an argon filled glove box. Either lithium foil or silicon materials were used as anode. Glass fiber was employed as a separator and a 1M solution of lithium hexafluorophosphate (LiPF₆) was utilized as the electrolyte. For electrochemical tests, the cells were subjected to either a constant current C/10 or C/3 charge and discharge rates within the voltage range of 1.35V to 4.25V. The thorough examination of these cells under these varying conditions allowed for a comprehensive understanding of their electrochemical performance.

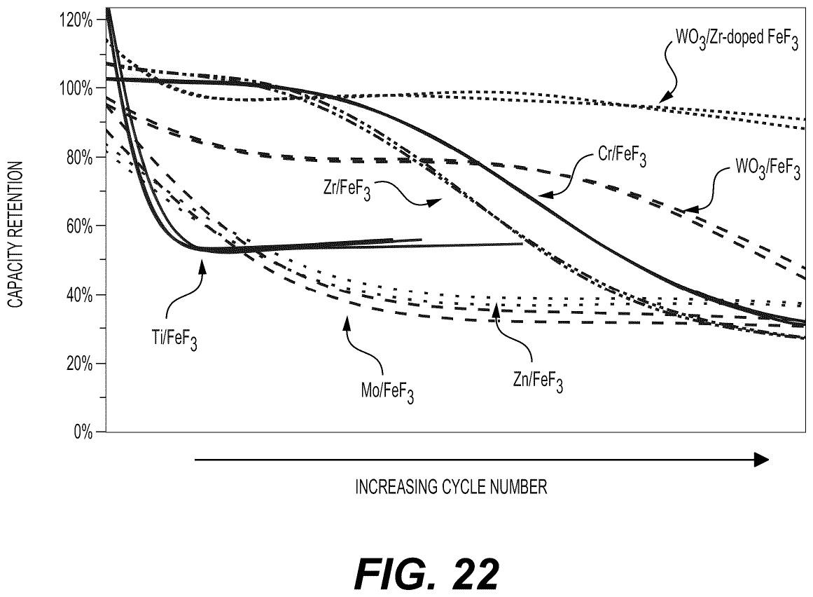

FIG. 22 shows comparative example electrochemical performance data of various electrodes produced with different cation doped metal fluoride-based {matrix-M-F} nanocomposite materials.

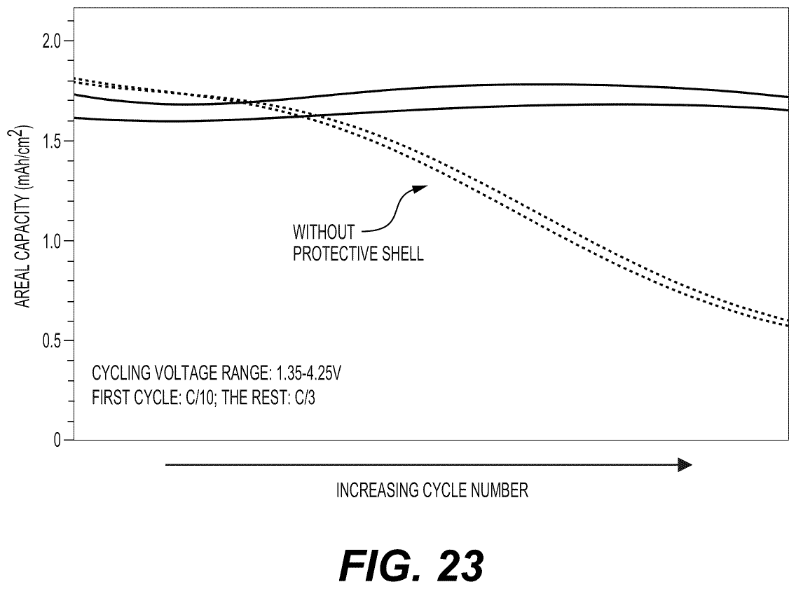

FIG. 23 shows example electrochemical performance data of an electrode produced according to an example embodiment as compared to performance of an unsealed composite material. For this example, cathode particles composed of WO₃-sealed Zr-doped FeF₃ carbon matrix-containing nanocomposite were dispersed in a PVDF solution, casted on an aluminum foil, and dried. After drying, a portion of the electrode was used as a cathode for the formation of a cell with a lithium foil anode (99.9% purity). The test cells were assembled inside an argon filled glove box (less than 1 ppm of H₂O). The electrolyte was composed of a LiPF₆ salt dissolved in a mixture of carbonate solvents as electrolyte. 0.2 M FEC was added to the electrolyte as a solid electrolyte interphase (SEI)-forming electrolyte additive. The charge-discharge tests were conducted at 25° C., between 1.35 to 4.25 V vs. Li/Li⁺ in a galvanostatic mode. As shown, cells built with unsealed active materials, and another set of cells were prepared after the active materials were sealed with a layer of WO₃ by using MOCVD technique. The cells were assembled with the WO₃ sealed active materials in exactly the same way for the unsealed materials. More stable cycling is clearly achieved after the uniform WO₃ protective coating step was implemented, indicating a significant positive impact of the protective layer in the metal fluoride-based nanocomposites.

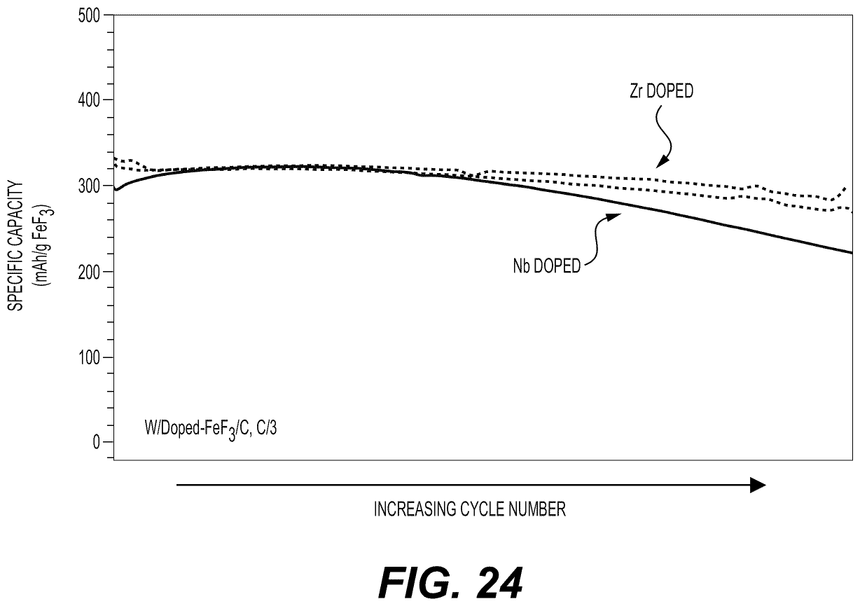

FIG. 24 shows example electrochemical performance data of an example electrode produced with WO₃ sealed Zr-doped FeF₃, carbon matrix containing nanocomposite particles as compared to the performance of a similar an WO₃ sealed nanocomposite material where Nb doping was used instead. The cells yielded more stable cycling when Zr doping was used.

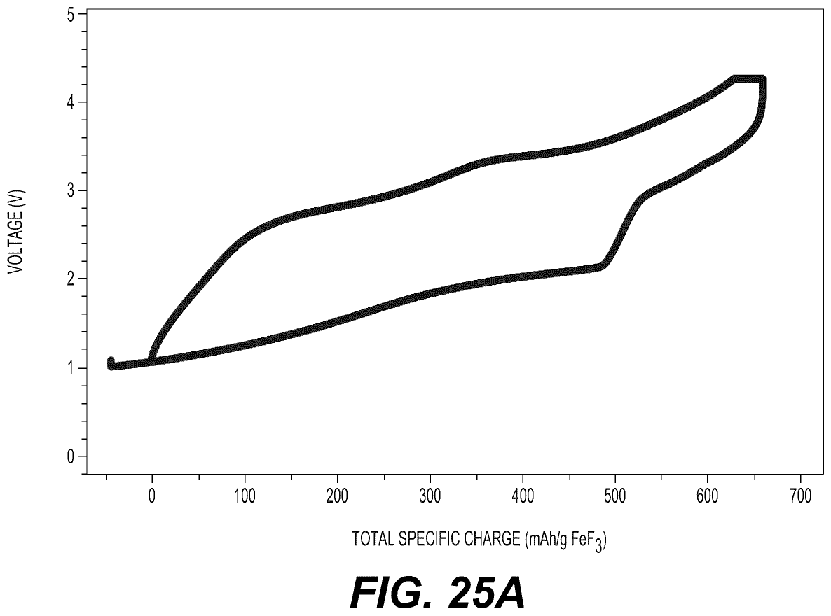

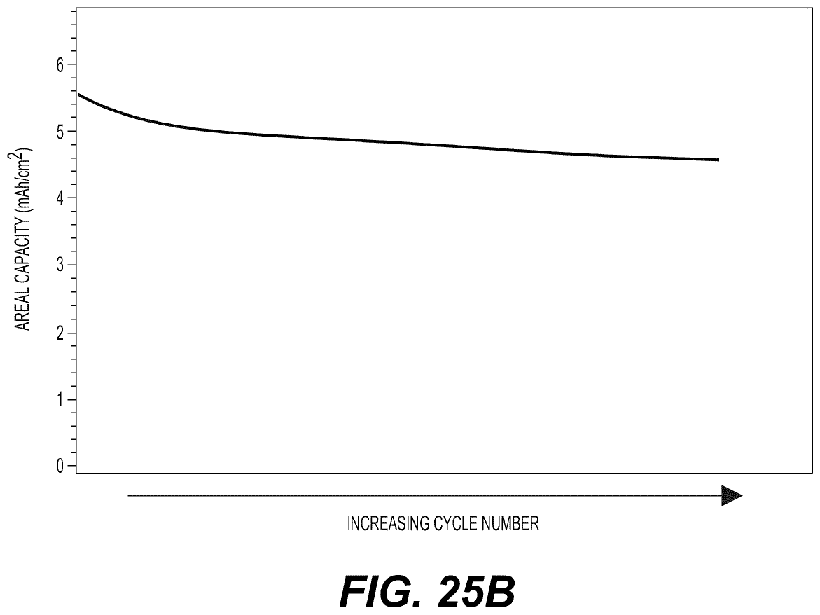

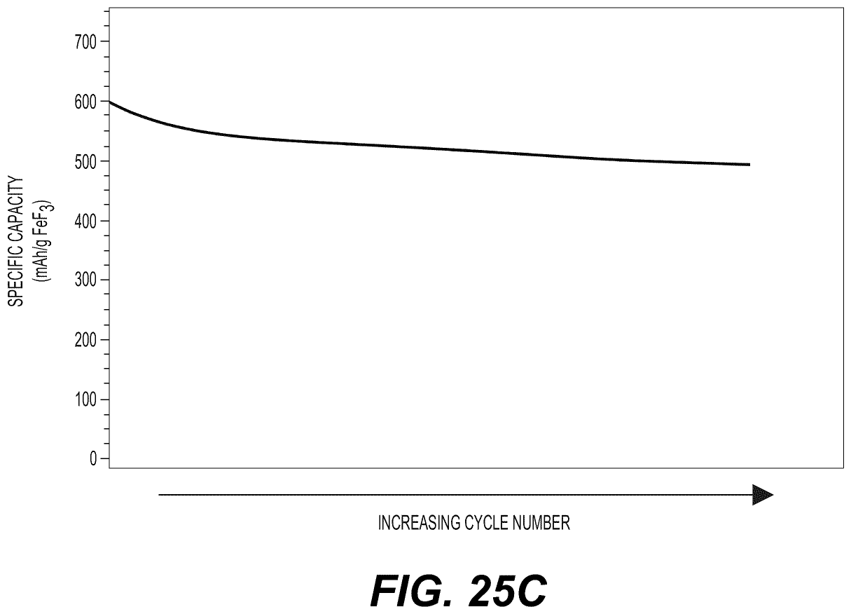

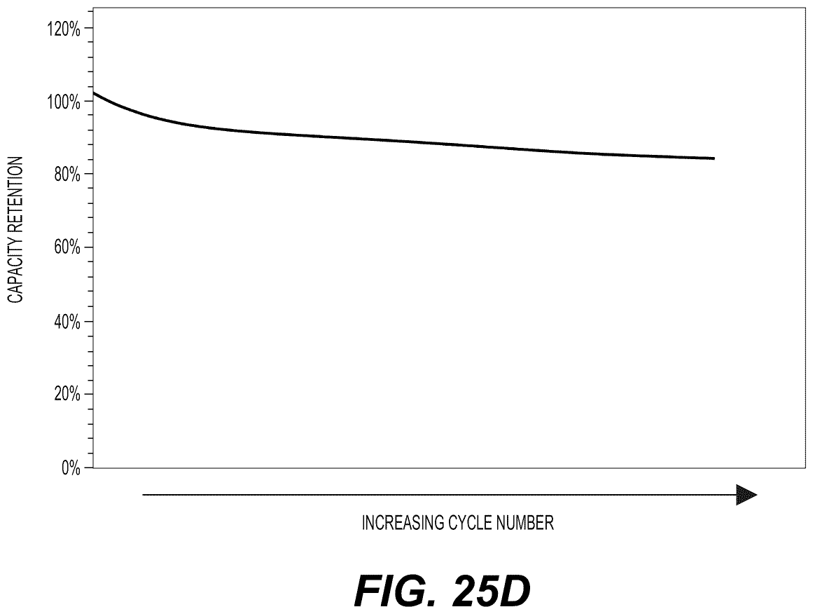

FIGS. 25A through 25D show illustrative examples of selected performance characteristics of WO₃ sealed Zr-doped FeF₃ composite materials. The cells were cycled in the potential range from 1.0 to 4.25V. FIG. 25A shows typical charge-discharge curves for the formation cycle. FIG. 25B demonstrates electrochemical stability of the example cell, showing an areal capacity of 5.5 mAh/cm². FIG. 25C presents a FeF₃ specific capacity of 600 mAh/cm², and FIG. 25D shows the capacity retention.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A Li metal or Li-ion battery cell, comprising: a cathode capable of storing and releasing Li ions during battery cell operation; a conversion-type or Li metal-type anode capable of storing and releasing the Li-ions during the battery cell operation; and an electrolyte capable of conducting the Li-ions during the battery cell operation; wherein: the cathode comprises composite core-shell particles comprising a conversion-type metal fluoride and at least one cation dopant; the at least one cation dopant is present in a range from around 0.1 at. % to around 30 at. % of all metals in the core-shell particles; and the cathode has an areal capacity loading that ranges from around 2 mAh/cm² to around 12 mAh/cm².

Clause 2. The Li metal or Li-ion battery cell of clause 1, comprising: a separator membrane ionically coupling and electronically insulating the cathode and the anode.

Clause 3. The Li metal or Li-ion battery cell of any of clauses 1 to 2, wherein composite core-shell particle is a nanocomposite that comprises: (i) LiF, (ii) metal nanoparticles comprising one, two or more metals selected from: Cu, Fe, and Bi or their alloys, (iii) at least one, two or more of the following cation dopants selected from: Mo, W, Zr, Y, Nb, Ti, Zn, Cr, Ni, Co, Bi, Pb, Sb, Sn, Cd, Mo, Hf, Ta, Si, La, and/or Ce, (iv) a scaffolding matrix material composition, and (v) a metal oxide or metal oxyfluoride protective layer comprising one, two or more of the following metals or semi-metals selected from: W, Y, Nb, La, Al and/or Si, wherein the scaffolding matrix material composition is configured to confine the LiF and the metal nanoparticles during the battery cell operation and to reduce volume changes in the composite core-shell active material-comprising particle during the battery cell operation.

Clause 4. The Li metal or Li-ion battery cell of clause 3, wherein the metal oxide or metal oxyfluoride protective layer protects a cathode active material from interactions with the electrolyte during the battery cell operation.

Clause 5. The Li metal or Li-ion battery cell of any of clauses 3 to 4, wherein the one, two or more metals or semimetals of the metal oxide or metal oxyfluoride protective layer includes the W.

Clause 6. The Li metal or Li-ion battery cell of any of clauses 3 to 5, wherein the metal of the metal oxide or metal oxyfluoride protective layer is distributed uniformly within a bulk of the composite core-shell particles to the interior of the metal oxide or metal oxyfluoride protective layer, as measured using energy dispersive spectroscopy (EDS).

Clause 7. The Li metal or Li-ion battery cell of any of clauses 3 to 6, wherein the scaffolding matrix material composition is electrically conductive.

Clause 8. The Li metal or Li-ion battery cell of any of clauses 3 to 7, wherein the scaffolding matrix material composition comprises about 70-100 at. % carbon.

Clause 9. The Li metal or Li-ion battery cell of any of clauses 1 to 8, wherein the composite core-shell particles show D and G bands in the Raman spectra, as recorded using a wavelength of 488 nm, wherein a ratio of an intensity of the D band (ID) to an intensity of the G band (IG) ranges from about 0.5 to about 1.2.

Clause 10. The Li metal or Li-ion battery cell of any of clauses 1 to 9, wherein at least one of the composite core-shell particles comprises at least about 10 at. % Fe.

Clause 11. The Li metal or Li-ion battery cell of any of clauses 1 to 10, wherein the at least one cation dopant is distributed uniformly within the composite core-shell particles, as measured using energy dispersive spectroscopy (EDS).

Clause 12. The Li metal or Li-ion battery cell of any of clauses 1 to 11, wherein the at least one cation dopant comprises zirconium (Zr).

Clause 13. The Li metal or Li-ion battery cell of any of clauses 1 to 12, wherein the anode comprises silicon (Si) or carbon (C) or both.

Additional implementation examples are described in the following numbered Additional Clauses:

Additional Clause 1. A Li metal or Li-ion battery cell, comprising: a cathode capable of storing and releasing Li ions during battery cell operation; a conversion-type or Li metal-type anode capable of storing and releasing the Li-ions during the battery cell operation; and an electrolyte capable of conducting the Li-ions during the battery cell operation; wherein: the cathode comprises a composite core-shell particle comprising a conversion-type metal fluoride and at least one cation dopant; the at least one cation dopant is present in a range from around 0.1 at. % to around 30 at. % of all metals in the composite core-shell particle; and the cathode has an areal capacity loading that ranges around 2 mAh/cm² to around 12 mAh/cm².

Additional Clause 2. The Li metal or Li-ion battery cell of Additional Clause 1, comprising: a separator membrane ionically coupling and electronically insulating the cathode and the anode.

Additional Clause 3. The Li metal or Li-ion battery cell of any of Additional Clauses 1 to 2, wherein the composite core-shell particle is a nanocomposite that comprises: (i) LiF, (ii) metal nanoparticles comprising one, two or more metals selected from: Cu, Fe, and Bi or their alloys, (iii) at least one, two or more of the following cation dopants selected from: Mo, W, Zr, Y, Nb, Ti, Zn, Cr, Ni, Co, Bi, Pb, Sb, Sn, Cd, Mo, Hf, Ta, Si, La, and/or Ce, (iv) a scaffolding matrix material composition, and (v) a metal oxide or metal oxyfluoride protective layer comprising one, two or more of the following metals or semi-metals selected from: W, Y, Nb, La, Al and/or Si, wherein the scaffolding matrix material composition is configured to confine the LiF and the metal nanoparticles during the battery cell operation and to reduce volume changes in the composite core-shell particle during the battery cell operation.

Additional Clause 4. The Li metal or Li-ion battery cell of Additional Clause 3, wherein the metal oxide or metal oxyfluoride protective layer protects a cathode active material from interactions with the electrolyte during the battery cell operation.

Additional Clause 5. The Li metal or Li-ion battery cell of any of Additional Clauses 3 to 4, wherein the one, two or more metals or semimetals of the metal oxide or metal oxyfluoride protective layer includes the W.

Additional Clause 6. The Li metal or Li-ion battery cell of any of Additional Clauses 3 to 5, wherein the composite core-shell particle is one of a plurality of composite core-shell particles in the cathode, and wherein the metal of the metal oxide or metal oxyfluoride protective layer is distributed uniformly within a bulk of the plurality of composite core-shell particles to an interior of the metal oxide or metal oxyfluoride protective layer, as measured using energy dispersive spectroscopy (EDS).

Additional Clause 7. The Li metal or Li-ion battery cell of any of Additional Clauses 3 to 6, wherein the scaffolding matrix material composition is electrically conductive.

Additional Clause 8. The Li metal or Li-ion battery cell of any of Additional Clauses 3 to 7, wherein the scaffolding matrix material composition comprises about 70-100 at. % carbon.

Additional Clause 9. The Li metal or Li-ion battery cell of any of Additional Clauses 1 to 8, wherein the composite core-shell particles show D and G bands in the Raman spectra, as recorded using a wavelength of 488 nm, wherein a ratio of an intensity of the D band (ID) to an intensity of the G band (IG) ranges from about 0.5 to about 1.2.

Additional Clause 10. The Li metal or Li-ion battery cell of any of Additional Clauses 1 to 9, wherein the composite core-shell particle comprises at least about 10 at. % Fe.

Additional Clause 11. The Li metal or Li-ion battery cell of any of Additional Clauses 1 to 10, wherein the composite core-shell particle is one of a plurality of composite core-shell particles in the cathode, and wherein the at least one cation dopant is distributed uniformly within the plurality of composite core-shell particles, as measured using energy dispersive spectroscopy (EDS).

Additional Clause 12. The Li metal or Li-ion battery cell of any of Additional Clauses 1 to 11, wherein the at least one cation dopant comprises zirconium (Zr).

Additional Clause 13. The Li metal or Li-ion battery cell of any of Additional Clauses 1 to 12, wherein the anode comprises silicon (Si) or carbon (C) or both.

The description is provided to enable any person skilled in the art to make or use embodiments of the present invention. It will be appreciated, however, that the present invention is not limited to the particular formulations, process stages, and materials disclosed herein, as various modifications to these embodiments will be readily apparent to those skilled in the art. That is, the generic principles defined herein may be applied to other embodiments without departing from the spirit or scope of the invention.

1. A Li metal or Li-ion battery cell, comprising:
a cathode capable of storing and releasing Li ions during battery cell operation;
a conversion-type or Li metal-type anode capable of storing and releasing the Li-ions during the battery cell operation; and
an electrolyte capable of conducting the Li-ions during the battery cell operation;
wherein:
the cathode comprises a composite core-shell particle comprising a conversion-type metal fluoride and at least one cation dopant;
the at least one cation dopant is present in a range from around 0.1 at. % to around 30 at. % of all metals in the composite core-shell particle; and
the cathode has an areal capacity loading that ranges from around 2 mAh/cm² to around 12 mAh/cm².

2. The Li metal or Li-ion battery cell of claim 1, comprising:
a separator membrane ionically coupling and electronically insulating the cathode and the anode.

3. The Li metal or Li-ion battery cell of claim 1,
wherein the composite core-shell particle is a nanocomposite that comprises: (i) LiF, (ii) metal nanoparticles comprising one, two or more metals selected from: Cu, Fe, and Bi or their alloys, (iii) at least one, two or more of the following cation dopants selected from: Mo, W, Zr, Y, Nb, Ti, Zn, Cr, Ni, Co, Bi, Pb, Sb, Sn, Cd, Mo, Hf, Ta, Si, La, and/or Ce, (iv) a scaffolding matrix material composition, and (v) a metal oxide or metal oxyfluoride protective layer comprising one, two or more of the following metals or semi-metals selected from: W, Y, Nb, La, Al and/or Si,
wherein the scaffolding matrix material composition is configured to confine the LiF and the metal nanoparticles during the battery cell operation and to reduce volume changes in the composite core-shell particle during the battery cell operation.

4. The Li metal or Li-ion battery cell of claim 3, wherein the metal oxide or metal oxyfluoride protective layer protects a cathode active material from interactions with the electrolyte during the battery cell operation.

5. The Li metal or Li-ion battery cell of claim 3, wherein the one, two or more metals or semimetals of the metal oxide or metal oxyfluoride protective layer includes the W.

6. The Li metal or Li-ion battery cell of claim 3,
wherein the composite core-shell particle is one of a plurality of composite core-shell particles in the cathode, and
wherein the metal of the metal oxide or metal oxyfluoride protective layer is distributed uniformly within a bulk of the plurality of composite core-shell particles to an interior of the metal oxide or metal oxyfluoride protective layer, as measured using energy dispersive spectroscopy (EDS).

7. The Li metal or Li-ion battery cell of claim 3, wherein the scaffolding matrix material composition is electrically conductive.

8. The Li metal or Li-ion battery cell of claim 3, wherein the scaffolding matrix material composition comprises about 70-100 at. % carbon.

9. The Li metal or Li-ion battery cell of claim 1,
wherein the composite core-shell particles show D and G bands in the Raman spectra, as recorded using a wavelength of 488 nm,
wherein a ratio of an intensity of the D band (ID) to an intensity of the G band (IG) ranges from about 0.5 to about 1.2.

10. The Li metal or Li-ion battery cell of claim 1, wherein the composite core-shell particle comprises at least about 10 at. % Fe.

11. The Li metal or Li-ion battery cell of claim 1,
wherein the composite core-shell particle is one of a plurality of composite core-shell particles in the cathode, and
wherein the at least one cation dopant is distributed uniformly within the plurality of composite core-shell particles, as measured using energy dispersive spectroscopy (EDS).

12. The Li metal or Li-ion battery cell of claim 1, wherein the at least one cation dopant comprises zirconium (Zr).

13. The Li metal or Li-ion battery cell of claim 1, wherein the anode comprises silicon (Si) or carbon (C) or both.
